(19) United States
(12) Patent Application Publication
(10) Pub. No.: US 2026/0316247 A1
(43) Pub. Date: Oct. 15, 2026

(54) Power Tool Mode Select Switch Assembly

(71) Applicant: Black & Decker Inc., New Britain, CT (US)

(72) Inventors: Joseph Malcolm Palmer, Columbia, MD (US); Joseph Arthur Steele, Baltimore, MD (US); Earnest N. Copeland, JR., White Marsh, MD (US); Robert J. Cirincione, Cockeysville, MD (US); Sepehr Keshavarz Motamedi, Gaithersburg, MD (US); Ross Keith Brown, Denver, NC (US); Floyd Eugene Moreland, IV, York, PA (US); Michael P. Sikora, Baltimore, MD (US); Marcell E. Coates, White Marsh, MD (US); Brian Stewart, Vincennes, IN (US)

(21) Appl. No.: 19/711,637

(22) Filed: Jun. 17, 2026

Related U.S. Application Data
(63) Continuation of application No. PCT/US24/60792, filed on Dec. 18, 2024.
(60) Provisional application No. 63/611,566, filed on Dec. 18, 2023.
(60) Provisional application No. 63/657,558, filed on Jun. 7, 2024.

(51) Int. Cl. B25F 5/00; B25F 5/02

(52) U.S. Cl. CPC B25F 5/001; B25F 5/02

(57) ABSTRACT

A family of power tools provided, the power tools including a common back-end assembly comprising a tool housing, a motor disposed within the tool housing, a peripheral switch, and other features that are substantially the same on the common back-end assembly; and distinct front-end assemblies securely mounted to the back-end assembly. The family of power tools provide significantly high power-to-weight and power-to-volume ratios.

### CROSS-REFERENCE TO RELATED APPLICATIONS

The present application is a bypass continuation of International Application No. PCT/US2024/060792, filed on Dec. 18, 2024, which designates the United States, and claims the benefit of priority to U.S. Provisional Application Ser. No. 63/611,566, entitled “ROTATIONAL TOOL,” filed Dec. 18, 2023, and U.S. Provisional Application Ser. No. 63/657,558, entitled “POWER TOOL,” filed Jun. 7, 2024, the disclosures of which are each hereby incorporated by reference in their entireties.

### BACKGROUND OF THE INVENTION

### Field of the Invention

The present disclosure relates to power tools, and more particularly to a novel power tool platform that integrates advanced features for enhanced performance, thermal management, and component standardization across various tool types.

### Description of Related Art

In recent years, the demand for compact and high-performance power tools has significantly increased. Professionals and DIY enthusiasts alike seek tools that offer superior power output while maintaining a manageable size and weight. However, existing power tools often face limitations in achieving high power density without compromising on size or thermal efficiency. Traditional designs typically involve larger housings to accommodate more powerful motors and cooling mechanisms, which can lead to increased tool weight and reduced maneuverability.

Moreover, the lack of standardization across different tool types often results in increased manufacturing costs and complexity. Each tool type typically requires unique components and assemblies, leading to inefficiencies in production and inventory management.

What is needed is a streamlined tool design that minimizes the tool's dimensions while allowing for improved thermal and power management of the tool. Further, what is needed is an improved approach that simplifies the manufacturing process and reduces costs.

### SUMMARY OF THE INVENTION

According to an embodiment, a power tool includes a tool housing including a substantially cylindrical body and a foot portion defining a battery receptacle for receiving a battery pack, with the tool housing defining a peripheral switch opening at or proximate the foot portion, a motor at least partially received within the tool housing, and a peripheral switch at least partially received within the peripheral switch opening. The peripheral switch including a curved display surface including a curvature that substantially matches a curvature of the tool housing along at least one edge of the peripheral switch opening, and a printed circuit board (PCB). The PCB includes a switch and a plurality of indicator lights positioned on a planer body portion of the PCB.

In an embodiment, the plurality of indicator lights each include a light emitting diode (LED).

In an embodiment, the peripheral switch further includes a barrier member positioned between the curved display surface and the PCB, with the barrier member including a plurality of walls positioned between each of the plurality of indicator lights. In an embodiment, the plurality of walls has variable heights in an ascending order towards a middle portion of the PCB.

In an embodiment, the curved display surface is defined by a flexible display member supported by the barrier member.

In an embodiment, one of the plurality of walls is positioned between the switch and one of the plurality of indicator lights.

In an embodiment, the barrier member includes a first curved wall and a second curved wall spaced from the first curved wall, with each of the plurality of walls extending from the first curved wall to the second curved wall.

In an embodiment, the peripheral switch includes a connection interface extending from the planer body portion, with the connection interface engaged with the tool housing to secure the peripheral switch to the tool housing. In an embodiment, the connection interface of the peripheral switch includes a rib received within a channel defined by the tool housing.

In an embodiment, the switch includes a mode select switch configured to change an operation of the motor.

In an embodiment, the peripheral switch includes a computer readable memory and a connection port.

In an embodiment, the tool housing defines a central axis extending through a mid-point of a grip portion of the tool housing, with the peripheral switch extending radially inward from the peripheral switch opening to a position between the peripheral switch opening and the central axis.

In an embodiment, the curvature of the curved display includes a curvature center point defining a radius of approximately 58 mm to 66 mm.

According to an embodiment, a system of tools includes a first power tool including a first tool housing having a first end and a second end positioned opposite the first end, a first motor at least partially received within the first tool housing, a first front-end tool assembly, and a first peripheral switch including a display surface with first indicia, a printed circuit board (PCB), a switch, and a plurality of indicator lights. The system of tools further includes a second power tool including a second tool housing having a first end and a second end positioned opposite the first end, with the first tool housing identical in size and shape to the second tool housing, a second motor at least partially received within the second tool housing, a second front-end tool assembly, with the first front-end tool assembly different than the second front-end tool assembly, and a second peripheral switch including a display surface with second indicia, a printed circuit board (PCB), a switch, and a plurality of indicator lights. The display surface and the PCB of the first peripheral switch are identical in size and shape to the display surface and the PCB of the second peripheral switch, with the first indicia of the first peripheral switch different than the second indicia of the second peripheral switch.

In an embodiment, the first tool housing defines a first peripheral switch opening and the second tool housing defines a second peripheral switch opening, with the first peripheral switch received by the first peripheral switch opening and the second peripheral switch received by the second peripheral switch opening. In an embodiment, the first indicia of the first peripheral switch includes an operating speed indicator. In an embodiment, the second indicia of the second peripheral switch includes a rotation direction indicator. In an embodiment, the first power tool includes a peripheral switch controller configured to output a signal associated with execution of a first type of operation designated for the first front-end tool assembly when the switch of the first peripheral switch is actuated. In an embodiment, the second power tool includes a peripheral switch controller configured to output the signal associated with execution of a second type of operation designated for the second front-end tool assembly when the switch of the second peripheral switch is actuated, with the second type of operation different than the first type of operation. In an embodiment, the first type of operation is a speed select operation, and the second mode selection operation is a rotation direction operation.

In an embodiment, the first peripheral switch and the second peripheral switch each include a connection interface engaged with the respective first tool housing or second tool housing to secure the respective first peripheral switch and second peripheral switch to the respective first tool housing and second tool housing, with the connection interface of the first peripheral switch identical in size and shape to the connection interface of the second peripheral switch.

According to an embodiment, a power tool includes a tool housing having a first end and a second end positioned opposite the first end, a motor at least partially received within the tool housing, and a peripheral switch including a display surface and a printed circuit board (PCB). The PCB includes a switch, a plurality of indicator lights, a peripheral switch controller, and a wireless communication device.

In an embodiment, the power tool further includes a motor controller in electronic communication with the peripheral switch controller, with the wireless communication device configured to send data from the motor controller to a remote device.

In an embodiment, the power tool further includes a secondary power source configured to provide backup power to the motor controller and the peripheral switch controller.

In an embodiment, the secondary power source includes a cell housing secured to the tool housing via a cell connection interface, with the cell housing spaced from the peripheral switch, and with the peripheral switch positioned closer to the first end of the tool housing than the cell housing. In an embodiment, the cell connection interface includes a rib received by a channel defined by the tool housing. In an embodiment, the secondary power source is connected to the peripheral switch via wiring.

In an embodiment, the secondary power source includes a coin cell received within the cell housing.

In an embodiment, the wireless communication device is formed integrally with the peripheral switch controller.

In an embodiment, the peripheral switch further includes a GPS unit configured to provide a location of the power tool.

In an embodiment, the peripheral switch further includes a cellular modem configured to wirelessly communicate with a remote device via a cellular network.

In an embodiment, the peripheral switch further includes an inertial measurement unit configured to detect rotation and/or movement of the power tool.

In an embodiment, the plurality of indicator lights each include a light emitting diode (LED).

In an embodiment, the peripheral switch includes a connection interface engaged with the tool housing to secure the peripheral switch to the tool housing.

In an embodiment, the connection interface of the peripheral switch includes a rib received within a channel defined by the tool housing.

In an embodiment, the switch includes a mode select switch configured to change an operation of the motor.

In an embodiment, the peripheral switch includes a computer readable memory and a connection port.

In an embodiment, the tool housing includes a foot portion and a grip portion extending from the foot portion, with the secondary power source including a cell housing received within a pocket defined by the foot portion of the tool housing. In an embodiment, the cell housing is configured to be removed from an exterior of the tool housing. In an embodiment, the secondary power source includes a coin cell, the pocket is spaced from the peripheral switch, and the pocket includes an electrical contact engaged with the coin cell when the cell housing is positioned within the pocket, with wiring extending between the electrical contact and the peripheral switch. In an embodiment, the electrical contact includes a printed circuit board (PCB) having a first L-shaped contact engaged with a first conductor of the coin cell and a second contact engaged with a second conductor of the coin cell. In an embodiment, the cell housing includes a biasing member engaged with a protrusion positioned within the pocket, with the biasing member biasing the coin cell toward the second contact.

### BRIEF DESCRIPTION OF THE DRAWINGS

FIG. 1A depicts a perspective view of a tool, according to an example of the disclosure.

FIG. 1B depicts a perspective view of a tool in a partially disassembled state, according to an example of the disclosure.

FIG. 1C depicts a perspective view of a tool in a partially disassembled state, according to an example of the disclosure.

FIG. 1D depicts a cross section A-A of the tool from FIG. 1A, according to an example of the disclosure.

FIG. 2A depicts a side view of a partially disassembled tool, according to an example of the disclosure.

FIG. 2B depicts a detail of a cross section A-A of the tool from FIG. 1A, according to an example of the disclosure.

FIG. 2C depicts a further detail of the cross-sectional view depicted in FIG. 2B, with the tool with the collar in a partially loosened state with separation between the motor housing and gear housing, according to an example of the disclosure.

FIG. 2D depicts a further detail of the cross-sectional view depicted in FIG. 2B, with the tool with the collar in a tightened state with the clamping face of the motor housing in contact with the shoulder of the gear housing, according to an example of the disclosure.

FIG. 2E depicts a perspective view of a tool with a gear housing in a first orientation, according to an example of the disclosure.

FIG. 2F depicts a perspective view of a tool with a gear housing in a second orientation, according to an example of the disclosure.

FIG. 2G depicts a detail of a cross section of an example clocking feature along B-B from FIG. 2B, according to an example of the disclosure.

FIG. 2H depicts a perspective view of a threaded bearing retainer, according to an example of the disclosure.

FIG. 2I depicts a perspective view of a threaded bearing retainer, according to an example of the disclosure.

FIG. 3A depicts a perspective view of a gear housing, according to an example of the disclosure.

FIG. 3B depicts a partially exploded view of a gear housing, according to an example of the disclosure.

FIG. 3C depicts a partially exploded view of a gear housing, according to an example of the disclosure.

FIG. 3D depicts an exploded view of a gear housing, according to an example of the disclosure.

FIG. 3E depicts a detail of cross-sectional view C-C from FIG. 3A of an unengaged retractable spindle lock, according to an example of the disclosure.

FIG. 3F depicts a detail of cross-sectional view C-C from FIG. 3A of an engaged retractable spindle lock, according to an example of the disclosure.

FIG. 3G depicts a bottom view of a spindle lock gear, according to an example of the disclosure.

FIG. 3H depicts a side view of a spindle lock gear, according to an example of the disclosure.

FIG. 3I depicts a perspective view of a spindle lock gear, according to an example of the disclosure.

FIG. 3J depicts a detail of cross-sectional view D-D from FIG. 3A of an engaged retractable spindle lock, according to an example of the disclosure.

FIG. 4A depicts a top view of a tool with a handle attached, according to an example of the disclosure.

FIG. 4B depicts a top view of a tool with a handle attached, according to an example of the disclosure.

FIG. 4C depicts a right view of a tool with a handle attached, according to an example of the disclosure.

FIG. 4D depicts a front view of a tool with a handle attached, according to an example of the disclosure.

FIG. 4E depicts a left view of a tool with a handle attached, according to an example of the disclosure.

FIG. 4F depicts a block view of FIG. 4C, according to an example of the disclosure.

FIG. 4G depicts a top view of a tool with a handle attached, according to an example of the disclosure.

FIG. 4H depicts a perspective view of a tool with a handle attached with a cross-section removed, according to an example of the disclosure.

FIG. 4I depicts a perspective view of a tool with a handle attached with a cross-section removed, according to an example of the disclosure.

FIG. 4J depicts a side view of a tool, according to an example of the disclosure.

FIG. 5A depicts a perspective view of a tool, according to an example of the disclosure.

FIG. 5B depicts a perspective view of a tool with a portion of the housing and a battery pack removed, according to an example of the disclosure.

FIG. 5C depicts a top plan view of a tool, according to an example of the disclosure.

FIG. 5D depicts a right view of a tool with a housing removed, according to an example of the disclosure.

FIG. 5E depicts a detail of the cross-section E-E of a tool depicted in FIG. 5C with battery pack removed, according to an example of the disclosure.

FIG. 5F depicts a right front partially exploded right perspective view of a tool with the motor housing exposed, according to an example of the disclosure.

FIG. 5G depicts a right rear partially exploded perspective view of a tool with the motor housing exposed, according to an example of the disclosure.

FIG. 5H depicts a right partially exploded cross-sectional view of a tool with the motor housing exposed along the section line E-E depicted in FIG. 5C, according to an example of the disclosure.

FIG. 5I depicts a right perspective exploded view of a motor assembly, according to an example of the disclosure.

FIG. 5J depicts a right perspective cross-sectional exploded view of the motor assembly, according to an example of the disclosure.

FIG. 5K depicts an exploded diagram of a gear assembly, according to an example of the disclosure.

FIG. 5L depicts an inner gear housing, according to an example of the disclosure.

FIG. 5M depicts a DET A as detailed in FIG. 5E, according to an example of the disclosure.

FIG. 5N depicts an inside view of a gear housing portion, according to an example of the disclosure.

FIG. 5O depicts a right plan view of an outer gear housing, according to an example of the disclosure.

FIG. 5P depicts a cross-section F-F depicted in FIG. 5O of an outer gear housing, according to an example of the disclosure.

FIG. 6A is an exploded perspective view of a system of power tools according to an example of the disclosure.

FIG. 6B is a perspective view a motor fan and motor shaft according to an example of the disclosure.

FIG. 6C is a perspective view a motor fan according to an example of the disclosure.

FIG. 7 is a partial exploded perspective view of a system of power tools according to an example of the disclosure.

FIG. 8 is a partial exploded perspective view of a system of power tools according to an example of the disclosure.

FIG. 9 is a partial exploded perspective view of a system of power tools according to an example of the disclosure.

FIG. 10A is a top view of a power tool according to an example of the disclosure.

FIG. 10B is a front view of the power tool of FIG. 10A.

FIG. 10C is a cross-sectional view of the power tool of FIG. 10A.

FIG. 10D is a cross-sectional view of the power tool of FIG. 10A.

FIG. 10E is an exploded perspective view of the power tool of FIG. 10A, showing a trigger switch detached from the power tool.

FIG. 10F is a side view of the power tool of FIG. 10E.

FIG. 10G is a cross-sectional view of the power tool of FIG. 10E.

FIG. 11A is a partial perspective view of a power tool according to an example of the disclosure, showing an audit chip pocket.

FIG. 11B is a perspective view of an audit chip according to an example of the disclosure.

FIG. 11C is an exploded perspective view of the audit chip of FIG. 11B.

FIG. 12A is a partial cross-sectional view of a power tool according to an example of the disclosure, showing a peripheral switch.

FIG. 12B is a partial cutaway view of the power tool of FIG. 12A.

FIG. 12C is a perspective view of the peripheral switch of FIG. 12A.

FIG. 12D is an exploded perspective view of the peripheral switch of FIG. 12A.

FIG. 12E is a bottom view of the peripheral switch of FIG. 12A.

FIG. 12F is a perspective view of the peripheral switch of FIG. 12A, without showing a display surface.

FIG. 12G is a top view of the peripheral switch of FIG. 12A.

FIG. 12H is a cross-sectional view along line 12H-12H shown in FIG. 12G.

FIG. 12I is a top view of a printed circuit board of the peripheral switch of FIG. 12A.

FIG. 12J is a bottom view of a printed circuit board of the peripheral switch of FIG. 12A.

FIG. 13 is a top view of a plurality of displays for a system of power tools according to an example of the disclosure.

FIG. 14 is a partial perspective view of a wiring arrangement for a power tool according to an example of the disclosure.

FIG. 15 is a circuit block diagram of a power tool including a motor control circuit according to an example of the disclosure.

FIG. 16A is a partial cutaway view of a power tool according to an example of the disclosure, showing a peripheral switch and wireless communication module.

FIG. 16B is a partial exploded cutaway view of the power tool of FIG. 16A.

FIG. 16C is an enlarged view of the area indicated in FIG. 16B.

FIG. 16D is a partial cross-sectional view of the power tool of FIG. 16A.

FIG. 16E is a perspective view of a peripheral switch and wireless communication module of the power tool of FIG. 16A.

FIG. 17A is a partial exploded perspective view of a power tool according to an example of the disclosure, showing a peripheral switch and wireless communication module.

FIG. 17B is a partial cross-sectional view of the power tool of FIG. 17A, showing insertion of a secondary power source.

FIG. 17C is a partial cross-sectional view of the power tool of FIG. 17A, showing an installation position of a secondary power source installed.

FIG. 17D is an exploded perspective view of a secondary power source of the power tool of FIG. 17A.

FIG. 17E is a perspective view of an electrical contact for a secondary power source of the power tool of FIG. 17A.

FIG. 17F is an exploded perspective view of an electrical contact for a secondary power source of the power tool of FIG. 17A.

FIG. 17G is an exploded perspective view of an electrical contact for a secondary power source of the power tool of FIG. 17A.

FIG. 17H is a partial cutaway view of the power tool of FIG. 17A.

FIG. 17I is a partial cutaway view of the power tool of FIG. 17A.

FIG. 18A is a partial exploded perspective view of a power tool according to an example of the disclosure, showing assembly of a tool housing.

FIG. 18B is a partial perspective view of the power tool of FIG. 18A.

FIG. 18C is a perspective view of a motor of the power tool of FIG. 18A.

FIG. 18D is a partial cross-sectional view of the motor of FIG. 18C.

FIG. 18E is a partial cutaway view of the power tool of FIG. 18A.

FIG. 18F is a partial cross-sectional view of the power tool of FIG. 18A.

FIG. 18G is a perspective view of a fan baffle of the power tool of FIG. 18A.

FIG. 18H is a side view of a fan baffle of the power tool of FIG. 18A.

FIG. 18I is a perspective view of a fan baffle of the power tool of FIG. 18A.

FIG. 19A is a partial cutaway view of a power tool according to an example of the disclosure, showing a first compliant member.

FIG. 19B is a partial cross-sectional view of the power tool of FIG. 19A.

FIG. 19C is a partial cross-sectional view of the power tool of FIG. 19A, showing multiple airflow paths.

FIG. 19D is a computer simulation model of the power tool of FIG. 19A, showing pressure within the power tool with multiple airflow paths.

FIG. 19E is a perspective view of a motor housing of the power tool of FIG. 19A.

FIG. 19F is a partial cross-sectional view of the power tool of FIG. 19A.

FIG. 19G is a partial perspective view of a motor housing of the power tool of FIG. 19A, showing airflow through exhaust ports.

FIG. 19H is a partial perspective view of a power tool according to an example of the disclosure, showing a second compliant member separated from a tool housing.

FIG. 19I is a perspective view of a compliant member of the power tool of FIG. 19H.

FIG. 19J is a partial cross-sectional view of a power tool according to an example of the disclosure, showing a recessed portion of a tool housing.

FIG. 19K is a front view of a power tool according to an example of the disclosure.

FIG. 19L is a cross-sectional view taken along line 19L-19L in FIG. 19K.

FIG. 19M is a cross-sectional view taken along line 19M-19M in FIG. 19K.

FIG. 19N is a partial side view of the power tool of FIG. 19B.

FIG. 19O is a cross-sectional view taken along line 19O-19O shown in FIG. 19N.

FIG. 19P is a cross-sectional view taken along line 19P-19P shown in FIG. 19N.

FIG. 20A is an exploded partial cutaway view of a power tool according to an example of the disclosure, showing a diffuser.

FIG. 20B is a partial cutaway view of the power tool of FIG. 20A.

FIG. 20C is a front perspective view of a diffuser of the power tool of FIG. 20A.

FIG. 20D is a rear perspective view of a diffuser of the power tool of FIG. 20A.

FIG. 20E is a cross-sectional view of a diffuser of the power tool of FIG. 20A.

FIG. 20F is a rear perspective view of a diffuser of the power tool of FIG. 20A.

FIG. 20G is a partial cutaway view of the power tool of FIG. 20A.

FIG. 20H is an exploded front perspective of a diffuser of the power tool of FIG. 20A.

FIG. 20I is an exploded front perspective of a diffuser of the power tool of FIG. 20A.

FIG. 21A is a computer simulation of a power tool according to an example of the disclosure, showing airflow through the power tool.

FIG. 21B is a computer simulation of a power tool according to an example of the disclosure, showing airflow through the power tool.

FIG. 22A is a perspective view of a power tool, in this example a 4.5-inch small angle grinder, according to an example of the disclosure.

FIG. 22B is a top view of the power tool of FIG. 22A.

FIG. 22C is a side view of the power tool of FIG. 22A.

FIG. 22D is a partial cross-sectional view of the power tool of FIG. 22A.

FIG. 22E is a partial exploded view of the power tool of FIG. 22A.

FIG. 23A is a perspective view of a power tool, in this example a 4-inch small angle grinder, according to an example of the disclosure.

FIG. 23B is a top view of the power tool of FIG. 23A.

FIG. 23C is a side view of the power tool of FIG. 23A.

FIG. 23D is a partial cross-sectional view of the power tool of FIG. 23A.

FIG. 23E is a partial exploded view of the power tool of FIG. 23A.

FIG. 24A is a perspective view of a power tool, in this example a right angle die grinder, according to an example of the disclosure.

FIG. 24B is a top view of the power tool of FIG. 24A.

FIG. 24C is a side view of the power tool of FIG. 24A.

FIG. 24D is a partial cutaway view of the power tool of FIG. 24A.

FIG. 24E is a partial cross-sectional view of the power tool of FIG. 24A.

FIG. 24F is a side view of the power tool of FIG. 24A.

FIG. 24G is a cross-sectional view taken along line 24G-24G shown in FIG. 24F.

FIG. 24H is a partial exploded view of the power tool of FIG. 24A.

FIG. 24I is a partial exploded view of the power tool of FIG. 24A.

FIG. 25A is a perspective view of a power tool, in this example an extended right angle cut-off tool, according to an example of the disclosure.

FIG. 25B is a top view of the power tool of FIG. 25A.

FIG. 25C is a side view of the power tool of FIG. 25A.

FIG. 25D is a partial cross-sectional view of the power tool of FIG. 56A.

FIG. 25E is a partial cross-sectional view of the power tool of FIG. 25A, showing a connection between an extension shaft housing and collar.

FIG. 25F is a partial cross-sectional view of the power tool of FIG. 25A, showing a connection between an extension shaft housing and gear housing.

FIG. 25G is a partial exploded view of the power tool of FIG. 25A.

### DETAILED DESCRIPTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, equivalents, variations, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary embodiments of the invention. Hence, specific dimensions and other physical characteristics related to the embodiments disclosed herein are not to be considered as limiting.

It should be understood that any numerical range recited herein is intended to include all values and sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value equal to or less than 10.

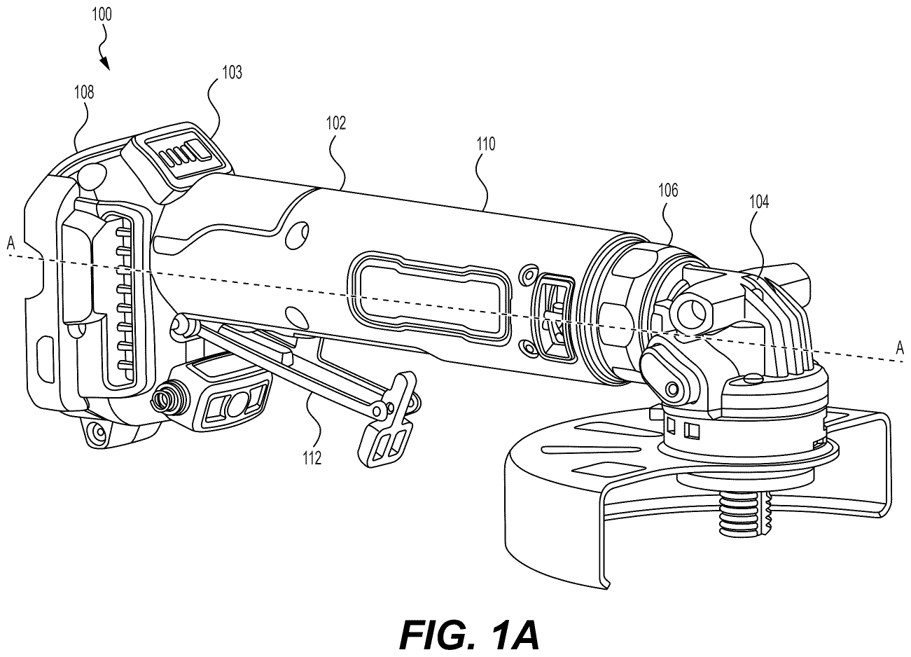

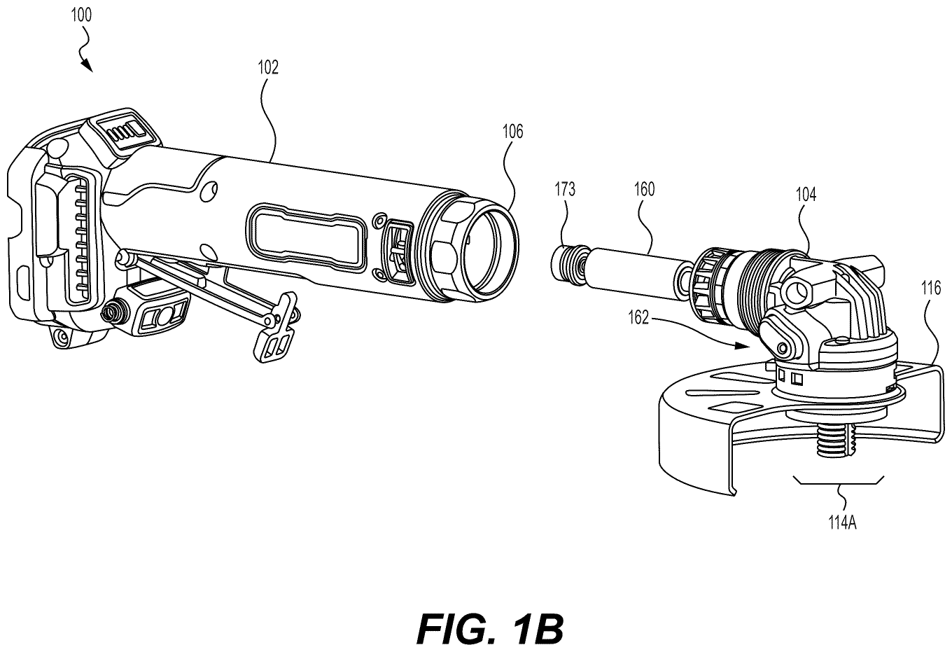

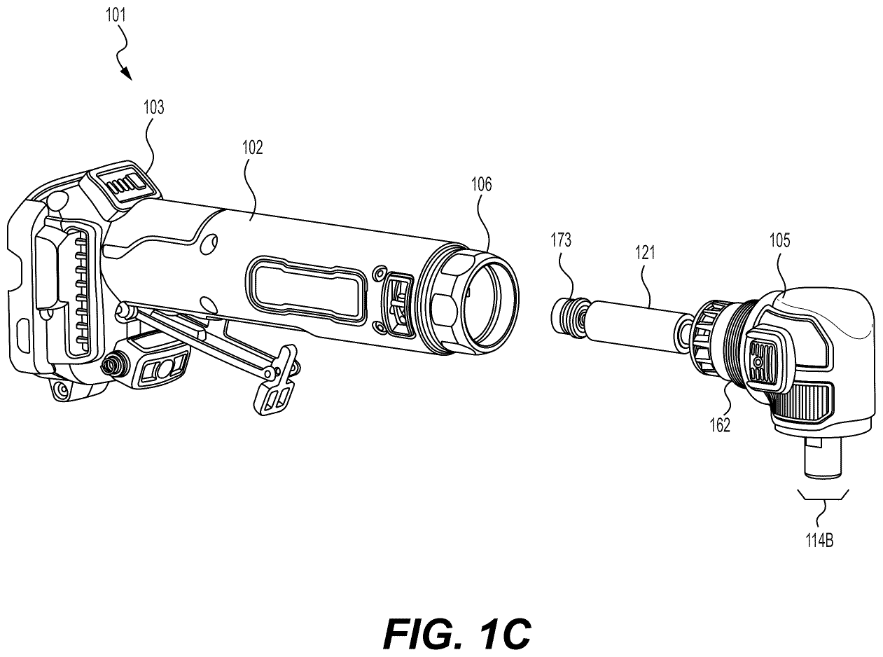

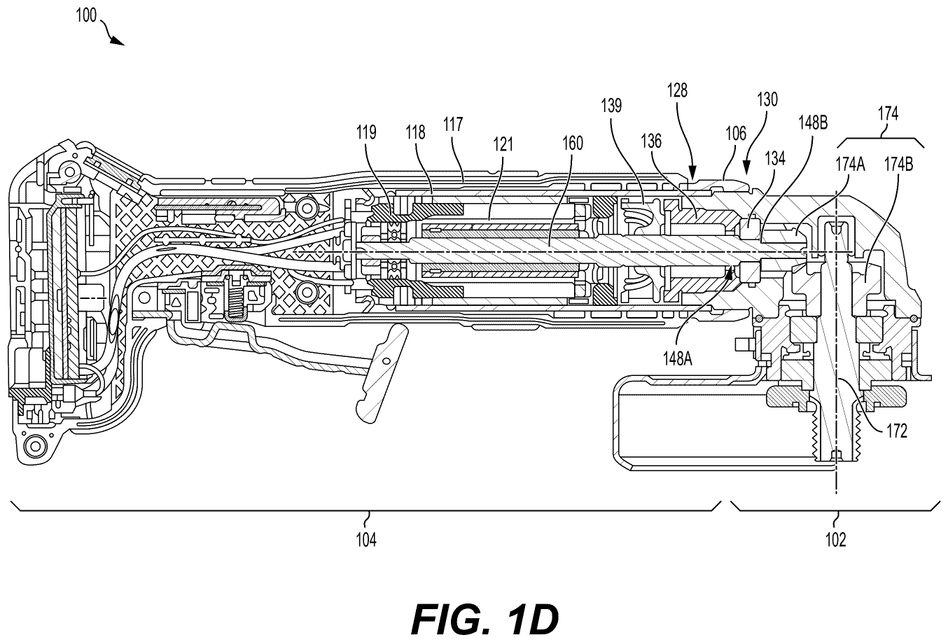

FIG. 1A depicts a perspective view of a tool 100, according to an example of the disclosure. FIG. 1B depicts a perspective view of the tool 100 in a partially disassembled configuration, FIG. 1C depicts a perspective view of a tool 101 in a partially disassembled configuration, and FIG. 1D depicts the cross-section A-A of the tool 100 depicted in FIG. 1A.

The tool 100 includes a tool housing 102 and a gear housing 104, and the tool 101 includes a tool housing 102 and a gear housing 105. In examples, the tool housing 102 and the gear housing 104, 105 may be coupled together via a collar 106, as will be further described below. The tool 100, 101 may include any type of tool with a rotational or fixed head. For example, the tool 100, 101 may include a grinding tool, a die tool, a router, a saw, a drill, an impact tool, a hammer tool, or any other tool driven by a rotating motor shaft. In examples, the tool 100, 101 may include a single motor shaft, or a motor shaft and an output spindle coupled together via a transmission such as a bevel gearset, for example. For example, the tool 100 may include an angle grinder, as depicted in the example tool of FIGS. 1A and 1B. In other examples, the tool 101 may include an angle die grinder, as depicted in FIG. 1C.

The tool housing 102 at least partially receives an electric motor to rotate a motor shaft, and control electronics to control a rotational operation of the electric motor. In examples, the tool housing 102 may include a battery pack receptacle 108. In examples, the tool housing 102 may include a body 110 and a trigger switch 112, with at least a portion of the body 110 being cylindrical. An entirety or greater than 50% of a length of the body 110 may be cylindrical.

In examples, the tool housing 102 may include an interface and display panel 103. In examples, interface and display panel 103 may include one or more controls such as a light control, a speed selector, a mode selector, etc.

In examples, the tool housing 102 may be a common back end for multiple tools, each tool associated with a different gear housing. For example, FIG. 1B depicts the gear housing 104 portion of an angle grinder. FIG. 1C depicts the gear housing 105 and an angle die grinder.

The gear housing 104 at least partially receives an output spindle coupled to the motor shaft on one end and coupled to a tool head on another end. In examples, the gear housing 104 may include a keyed backing flange and lock nut to attach different blades, wheels, bits, or other rotatable tool accessories to the output spindle.

Referring to FIG. 1B, the tool head 114A is an angle grinder attachment. In examples, the tool head 114A may include interchangeable wheels or blades (not depicted) for different grinding, cutting, sanding, surfacing, and/or polishing applications. A wheel guard 116 may be additionally fixedly mounted on the gear housing 104 to protect the user from the grinding, cutting, sanding, surfacing, and/or polishing operations. The wheel guard 116 may be adjustable by the user to incrementally rotate and secure the guard orientation to suit the orientation of the application and to direct debris away from the user.

In the example of FIG. 1C, the tool head 114B is a portion of an angle die grinder attachment (not shown). The tool head 114B may include an interchangeable die grinder bit or accessory.

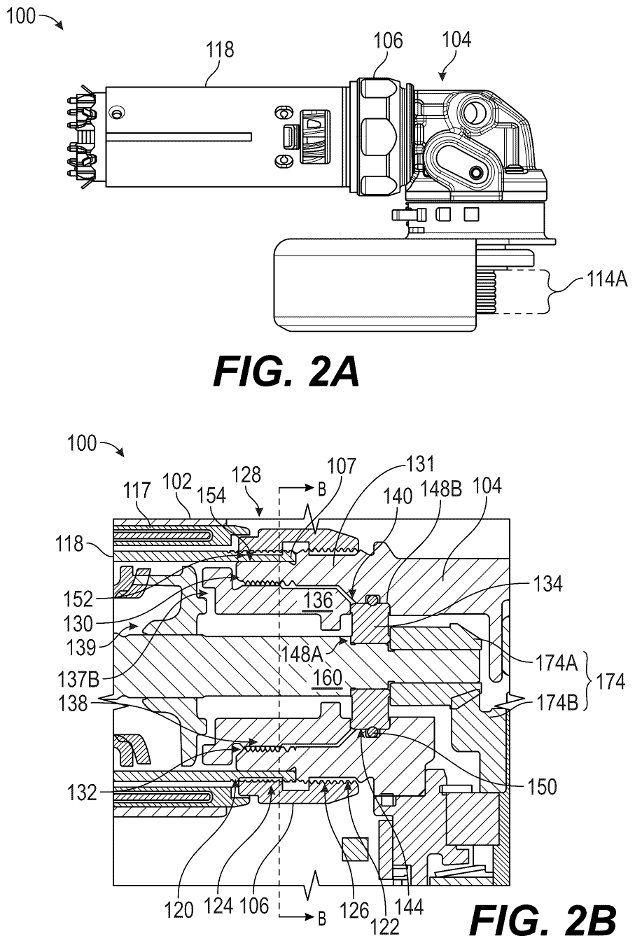

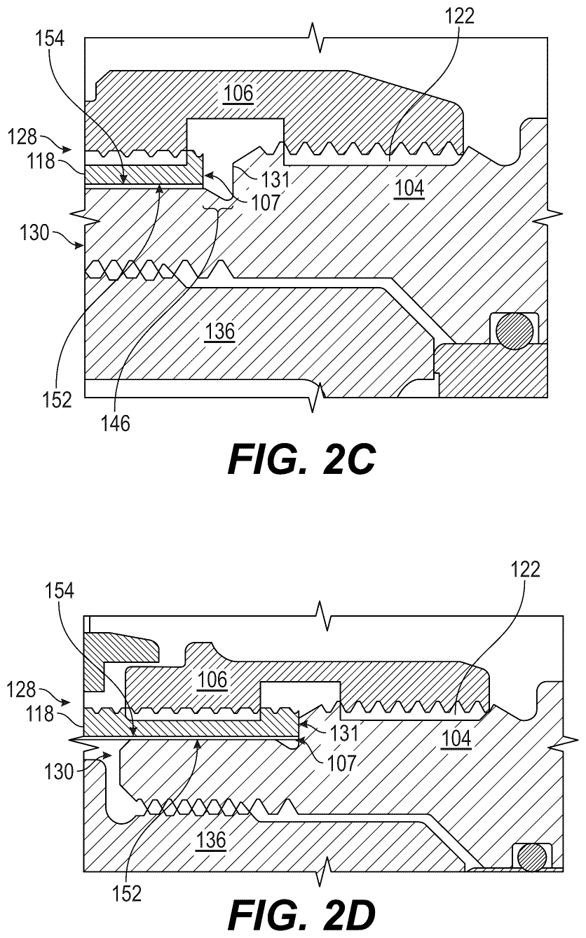

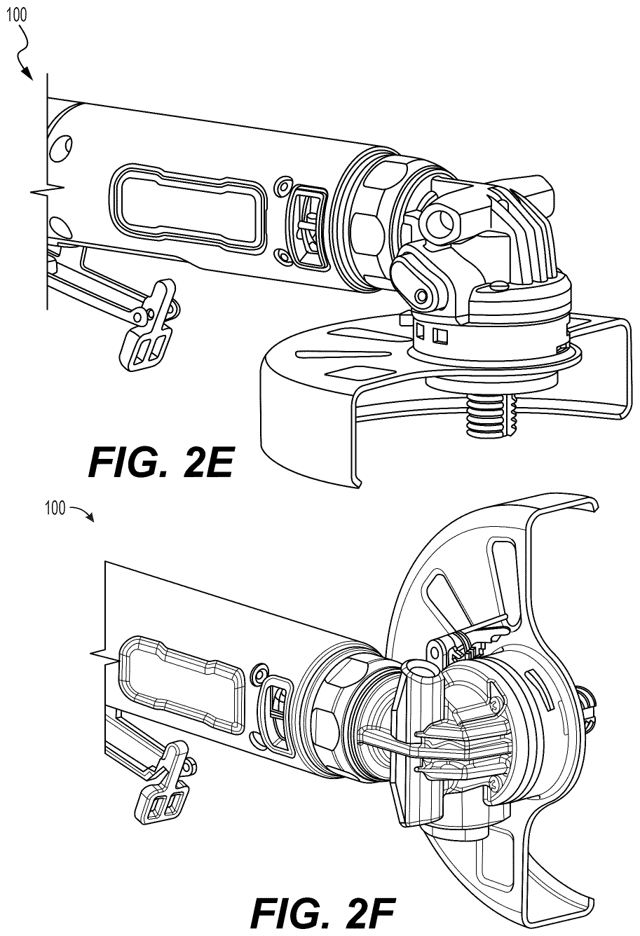

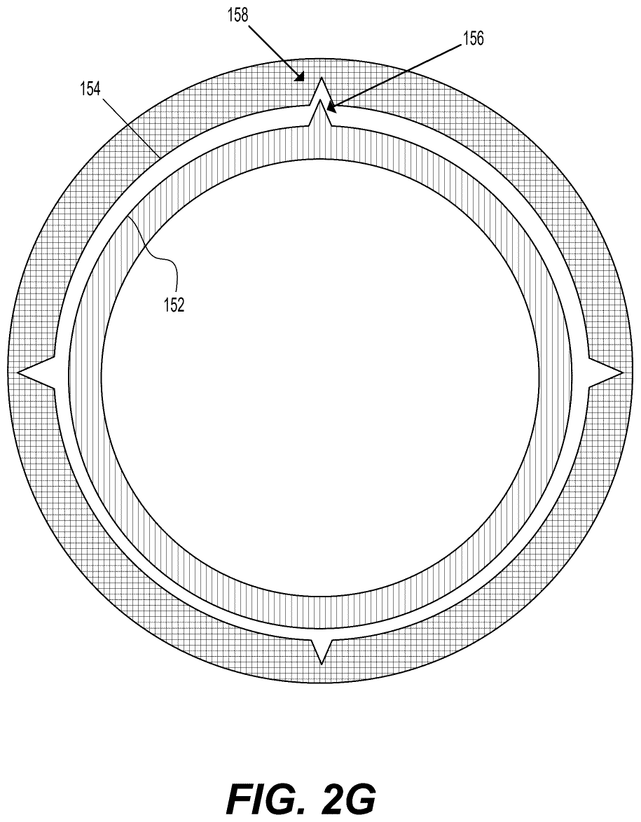

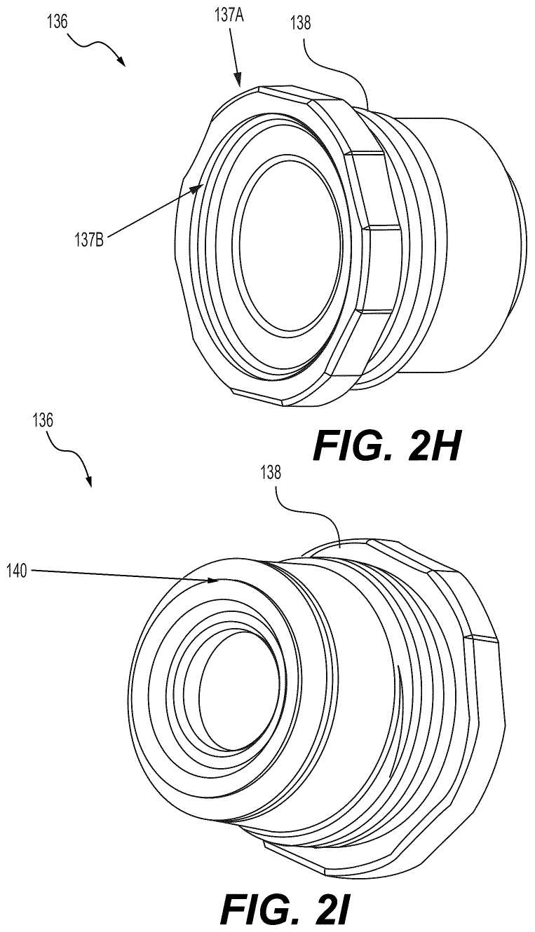

In examples, a motor housing 118 may be coupled to the gear housing 104 using a collar 106. The connection between the collar 106, the motor housing 118, and the gear housing 104 is shown more clearly in FIGS. 2A-2F.

FIG. 2A depicts a side view of the tool 100 with an outer tool housing 117 removed, revealing the motor housing 118, according to examples. FIG. 2B depicts a detail of a cross-section A-A from FIG. 1A. FIG. 2C depicts a further detail of the cross-sectional view depicted in FIG. 2B and the gear housing 104 in a partially mounted position to motor housing 118 with the collar 106 in its loosened state. FIG. 2D depicts a further detail of the cross-sectional view depicted in FIG. 2B with the gear housing 104 in a fully mounted position to the motor housing 118 with the collar 106 in its tightened state. FIG. 2E depicts a perspective view of the tool 100 with the gear housing 104 in a first orientation with respect to tool housing 102. FIG. 2F depicts a perspective view of the tool 100 with the gear housing 104 in a second orientation with respect to the tool housing 102. FIG. 2G depicts an example clocking feature, as would be seen from cross section B-B of FIG. 2B, configured to orient the gear housing 104 rotation relative to the motor housing 118 and the tool housing 102 in predetermined positions, which is discussed in more detail below.

In examples, the tool housing 102 may include the outer tool housing 117 external to the motor housing 118. For example, in the cross-sectional view of FIG. 1D, it may be seen that the motor housing 118 (also referred to as a motor can) is secured within the outer tool housing 117 which provides a cover for the motor housing 118. In FIG. 2A, the outer tool housing 117 is removed from the tool housing 102 to reveal the surface of the motor housing 118. In examples, the outer tool housing 117 may be clamshell formed around the motor housing 118 and configured to hold all the back-end electronic components, paddle, and motor together.

Referring to FIG. 1D, the motor housing 118 may include a stator 119 securely mounted therein with electronic components. The stator 119 may be configured to engage a rotor 121 surrounding motor shaft 160 to turn a motor shaft 160. The rotor 121 may be mounted to the gear housing 104 when the motor shaft 160 is assembled therein.

At a connection end 128, the motor housing 118 may extend axially beyond a front end of outer tool housing 117. The connection end 128 of motor housing 118 includes threads that facilitate coupling to the gear housing 104 via the collar 106.

Turning to the detail of FIG. 2B, the motor housing 118 may include an exterior motor housing thread 120 adjacent to the connection end 128 of the motor housing 118. In examples, the exterior motor housing thread 120 may be threaded in a first direction.

In examples, as may be seen in FIG. 2B, the exterior motor housing thread 120 may be positioned on an exterior surface of the motor housing 118. In examples, the outer tool housing 117 may be formed from one or more plastic, composite, and/or rubber materials, and configured to provide a gripping surface along the body of the tool 100 and to allow a user to hold and operate the tool 100 without sensing excess heat and/or vibration generated by the motor housed within the tool housing 102.

In examples, the gear housing 104 may include an exterior gear housing thread 122 at a connection end 130 of the gear housing 104. In examples, the exterior gear housing thread 122 may be threaded in a second direction opposite the first direction, as previously described for the exterior motor housing thread 120.

The tool 100 may include the collar 106 positioned exterior to the exterior motor housing thread 120 and the exterior gear housing thread 122. The collar 106 may include internal threads that may be used to couple the motor housing 118 to the gear housing 104.

In examples, the collar 106 may include a motor collar thread 124 and a gear collar thread 126 internal to the collar 106. The motor collar thread 124 may be configured to engage the exterior motor housing thread 120 and the gear collar thread 126 may be configured to engage the exterior gear housing thread 122.

Referring to FIGS. 2C and 2D, in examples, the gear housing 104 may include an exterior cylindrical surface 152 and adjacent a gear housing exterior shoulder 131 at the connection end 130 of the gear housing 104. The gear housing exterior shoulder 131 is an annular rim projecting radially from the exterior cylindrical surface 152 at connection end 130 of gear housing 104. In examples, the connection end 130 may include the exterior gear housing thread 122 that is radially aligned with the exterior motor housing thread 120 of motor housing 118 when the motor housing 118 is coupled to the gear housing 104.

Referring to FIG. 2B, the motor housing 118 may include an interior cylindrical surface 154 at the connection end 128 and the gear housing connection end 130 may include an exterior cylindrical surface 152. In examples, the exterior cylindrical surface 152 may be sized to be closely received into the motor housing 118 along the interior cylindrical surface 154, thereby providing alignment and concentricity between the motor housing 118 and the gear housing 104 so that they may be coupled and decoupled with the collar 106 without straining or damaging threads, and, when assembled, provide alignment, concentricity control, and rigid coupling of critical motor and transmission features relative to one another.

In examples, the connection end 128 of the motor housing 118 may be configured to come into contact with the gear housing exterior shoulder 131 when the gear housing connection end 130 is fully inserted into the connection end 128 of the motor housing 118. The gear housing exterior shoulder 131 may include an annular groove oriented at the base of the shoulder to ensure full face contact between a frontal annular face 107 of the motor housing 118 without interference of corner fillets and/or debris that could become captured between parts.

In the detail of FIG. 2C, the tool 100 is depicted in a partially closed position with the motor housing 118 and the gear housing 104 partially coupled together, but not fully tightened together, because a gap 146 is positioned between the motor housing 118 and the gear housing 104. In the detail of FIG. 2D, however, the tool 100 is in a fully assembled state because the tool housing 102 and gear housing 104 have been fully tightened together using the collar 106.

In examples, at least one of the exterior motor housing threads 120, the exterior gear housing thread 122, the motor collar thread 124, or the gear collar thread 126 may include a thread tightening resistance material, such as, for example, an adhesive substance. By applying a thread tightening resistance material, the coupling between tool housing 102 and gear housing 104 is configured to be more robust. In examples, a friction force between an annular portion of the connection end 128 or the motor housing 118 and the connection end 130 may increase the breakaway torque between the tool housing 102 and the gear housing 104. The thread tightening resistance material is configured to provide an additional safety measure to ensure that collar 106 is retained and prevent unintentional rotation of gear housing 104 after extended periods of vibration or if exposed to impact from drop, and so forth.

The motor shaft 160 is coupled to the gear housing 104 via a front motor bearing 134. In examples, the gear housing 104 may include an interior gear housing thread 132 internal to the connection end 130 of the gear housing 104 to facilitate a coupling between the front motor bearing 134 and the gear housing 104 via a bearing retainer 136. The front motor bearing 134 includes an inner race that may be mounted on the motor shaft 160 and an outer race that may be securely coupled to the gear housing 104. In examples, the front motor bearing 134 may be a ball bearing.

In examples, the bearing retainer 136 may be used to couple the front motor bearing 134 to the gear housing 104. As shown in FIGS. 2H and 2I, the bearing retainer 136 may include an exterior bearing retainer thread 138 configured to engage the interior gear housing thread 132. The bearing retainer 136 may further includes a frontal annular face 140, which may be configured to come into contact with an outer race of the front motor bearing 134 and provide axial clamping force to secure the front motor bearing 134 within the gear housing 104 when the bearing retainer 136 is tightened into the gear housing 104 (as may be seen in FIG. 2B).

In examples, the bearing retainer 136 may include a bearing retainer head at an end of the bearing retainer 136 opposite the frontal annular face 140. The bearing retainer head may include any combination of an exterior gripping surface 137A and an interior annular notch 137B. Exterior gripping surface 137A may include any opposing flats, angular, and/or textured surfaces for gripping with a tool 100, for the purposes of applying torque to turn the bearing retainer 136 into or out of the gear housing 104 and tighten or loosen threads, respectively. The interior annular notch 137B (best seen in FIG. 2B) may be contoured as an offset of opposing fan 139 surfaces with close clearance to the fan 139, designed to create a labyrinth airflow path preventing excess airflow from the discharge of the fan 139 from traveling into and recirculating within the empty space in front of the fan 139.

Although the tool 100 utilizes the bearing retainer 136, in further examples, the front motor bearing 134 may be coupled within gear housing 104 via any other suitable arrangement.

The bearing retainer 136 may also include the frontal annular face 140. The frontal annular face 140 may include an annular surface, perpendicular to the axis of bearing retainer thread 138, configured to retain the front motor bearing 134 by providing axial clamping force of the outer race of the front motor bearing 134 against a gear housing interior shoulder 148B.

In examples, the exterior bearing retainer thread 138 may be positioned to be aligned radially inward from the exterior motor housing thread 120 when the bearing retainer 136 is tightened into the gear housing 104, which may provide for a compact coupling between the front motor bearing 134 and the gear housing 104, and/or the gear housing 104 and the tool housing 102, providing more room for the fan 139 within the tool 100.

In examples, the motor housing 118 includes the interior cylindrical surface 154 at the connection end 128 of the motor housing 118, and the gear housing 104 includes the interior cylindrical surface 152 and the gear housing exterior shoulder 131 at the gear housing connection end 130. These mating features of the motor housing 118 and the gear housing 104 may function to provide the primary control and concentricity control between one or more other features of each respective component. The exterior gear housing thread 122 may be positioned adjacent to the gear housing exterior shoulder 131, and the exterior motor housing thread 120 positioned directly adjacent to the frontal annular face 107 of the motor housing 118. This may allow for the motor collar thread 124 and the gear collar thread 126 to be axially aligned to the exterior gear housing thread 122 and the exterior motor housing thread 120, respectively, while the gear housing exterior cylindrical surface 152 and the motor housing interior cylindrical surface 154 allows for concentric alignment of the threads. Similarly, the gear housing interior shoulder 148B may be positioned relative to the gear housing exterior shoulder 131, which allows for axial alignment of the front motor bearing 134, and subsequently other components mounted to the motor shaft 160, with respect to the motor housing 118. A gear housing interior bearing bore 144 may be positioned radially inward from the exterior cylindrical surface 152, which allows for concentric alignment of the front motor bearing 134, and subsequently other components mounted to motor shaft 160, with respect to motor housing 118.

In examples, the assembly of a front motor bearing 134, the bearing retainer 136, and the gear housing 104 may further include an O-ring 150. The O-ring 150 may be compressed between the front motor bearing 134 outer race and the gear housing 104 to provide friction between the components and mitigate undesired rotation of the front motor bearing 134 outer race during operation while the motor shaft 160 is rotating.

The front motor bearing 134 may be coupled within the gear housing 104 by first slidingly placing the front motor bearing 134 around a coupling end of the motor shaft 160. The coupling end of the motor shaft 160 may then be coupled via interference fit to a pinion bevel gear 174A, which may be pressed tight against the front motor bearing 134, securing the front motor bearing 134 against a motor shaft shoulder 148A with the front motor bearing 134 positioned between the motor shaft shoulder 148A and the pinion bevel gear 174A. The front motor bearing 134 may then be secured to the gear housing 104 by slidingly placing the front motor bearing 134 into the gear housing interior bearing bore 144, then turning the bearing retainer 136 into the gear housing 104 so that the interior gear housing thread 132 and the exterior bearing retainer thread 138 engage and the frontal annular face 140 comes into contact with the outer race of the front motor bearing 134 and the outer race of front motor bearing 134 comes into contact with the gear housing interior shoulder 148B. The bearing retainer 136 may be tightened to a specific torque value in order to provide sufficient axial clamping force to retain the front motor bearing 134 firmly in place and to generate sufficient thread friction to prevent threads from loosening during operation.

The motor housing 118 and the gear housing 104 may then be coupled together by inserting the exterior cylindrical surface 152 of the gear housing 104 into the motor housing 118 so that the interior cylindrical surface 154 and the exterior cylindrical surface 152 come into contact. The cylindrical surfaces maintain the concentricity of the connection end 128 of motor housing 118 and the connection end 130 of gear housing 104 with respect to one another so that the exterior gear housing thread 122 and the gear collar thread 126 may be easily joined without causing damage to any of the threads.

In examples, the collar 106 may be loosened or tightened to couple or decouple the motor housing 118 and the gear housing 104. The combination of the collar 106, the exterior cylindrical surface 152, and the interior cylindrical surface 154 may also be used to allow for the quick and efficient rotation of the gear housing 104 with respect to the motor housing 118 and the tool housing 102. For example, FIGS. 2E and 2F depict the tool 100 with the gear housing 104 in a first orientation and a second orientation, respectively, with respect to the tool housing 102.

To change the rotation of the gear housing 104 with respect to the motor housing 118 and the tool housing 102, the collar 106 may be loosened by rotating relative to the gear housing 104, thereby pushing the motor housing 118 away from the gear housing 104. As illustrated by FIGS. 2C and 2D, as the exterior gear housing thread 122 and the exterior motor housing thread 120 are oppositely threaded, rotating the collar 106 in one direction increases the size of gap 146, while rotating the collar 106 in the other direction decreases the size of gap 146. Between when the gap 146 first appears and when the gap 146 becomes long enough to disengage the contact between the exterior cylindrical surface 152 and the interior cylindrical surface 154, the gear housing 104 may be rotated freely with respect to the motor housing 118 and the tool housing 102. Once a desired rotation is achieved, the collar 106 may be tightened again, fixing the rotation of the gear housing 104 with respect to the motor housing 118 and the tool housing 102. Because the exterior cylindrical surface 152 and the interior cylindrical surface 154 allow for the motor housing 118 and the gear housing 104 to maintain concentricity when the collar 106 is loose, reorienting the rotation of the tool 100 without disassembly or removal of any components and/or fasteners can be readily achieved.

FIG. 2G depicts an example of a clocking mechanism that may be found between the surfaces of the exterior cylindrical surface 152 of the gear housing 104 and the interior cylindrical surface 154 of the motor housing 118. The clocking feature may create predetermined orientations of the gear housing 104 with respect to the motor housing 118 and the tool housing 102. A first of the exterior cylindrical surface 152 or the interior cylindrical surface 154 may include a protrusion 156 and a second of the exterior cylindrical surface 152 or the interior cylindrical surface 154 may include a recess 158. In some examples, and as shown in FIG. 2G, the protrusion 156 is a V-shaped protrusion and the recess 158 is a groove that substantially matches the V-shape of the protrusion 156. In examples, however, the protrusion 156 and the recess 158 may take any other suitable shape or format that allows protrusion 156 to seat into recess 158.

In examples, one or more recesses 158 are provided. For example, in FIG. 2G, four recesses 158 offset at 90 degrees from one another are provided on the interior cylindrical surface 154. One or more recesses 158 may allow the gear housing 104 to be positioned at a predetermined rotational orientation with respect to the gear housing 104. In examples, one or more protrusions 156 are provided.

In the example, the protrusion 156 is positioned on the interior cylindrical surface 154 and the recess 158 is positioned on the exterior cylindrical surface 152. In further examples, however, the protrusion 156 may be positioned on the exterior cylindrical surface 152 and the recess 158 may be positioned on the interior cylindrical surface 154.

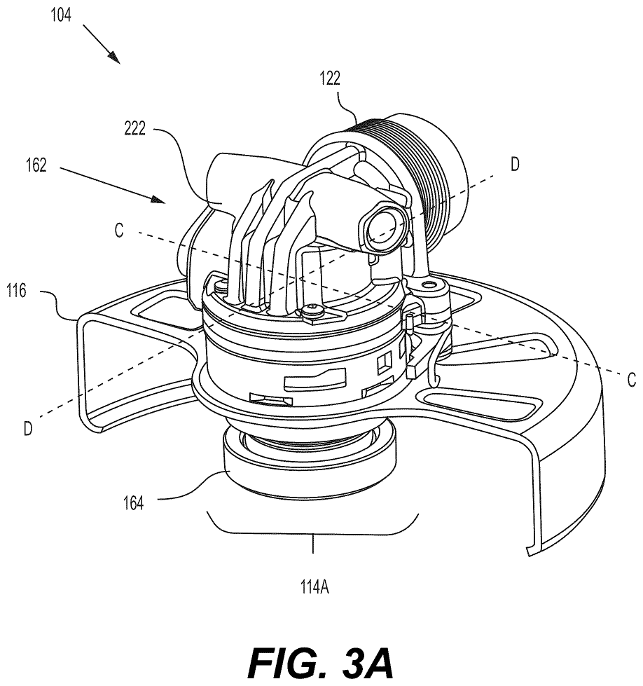

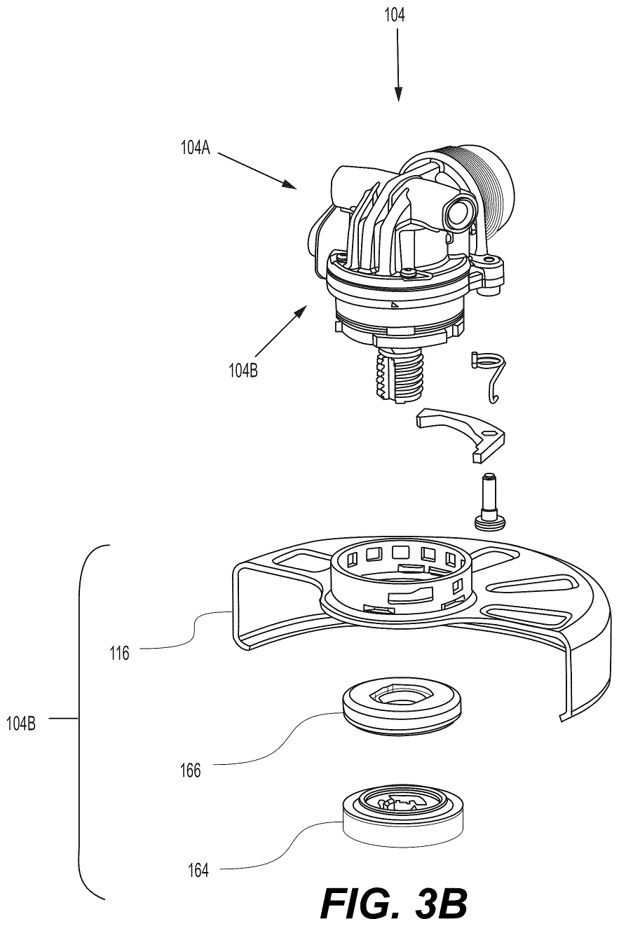

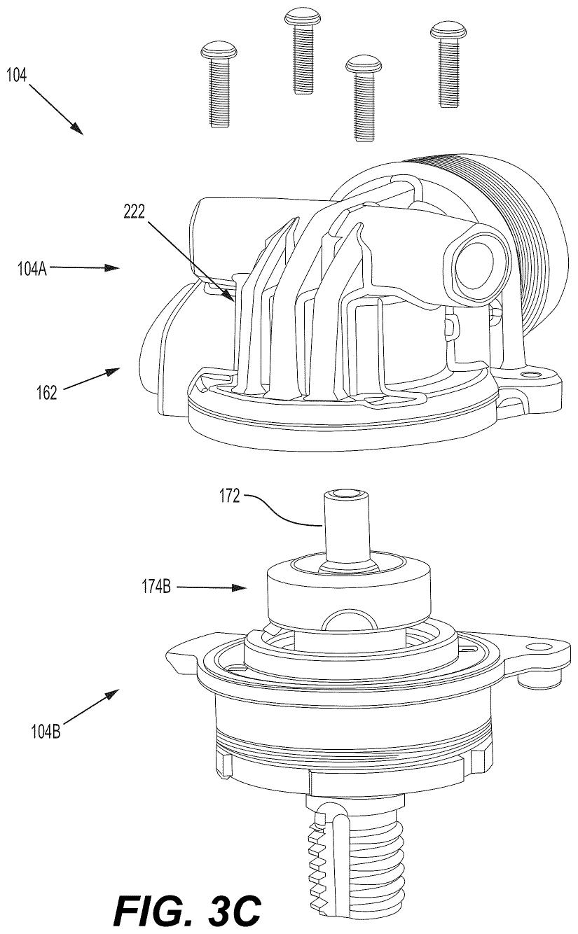

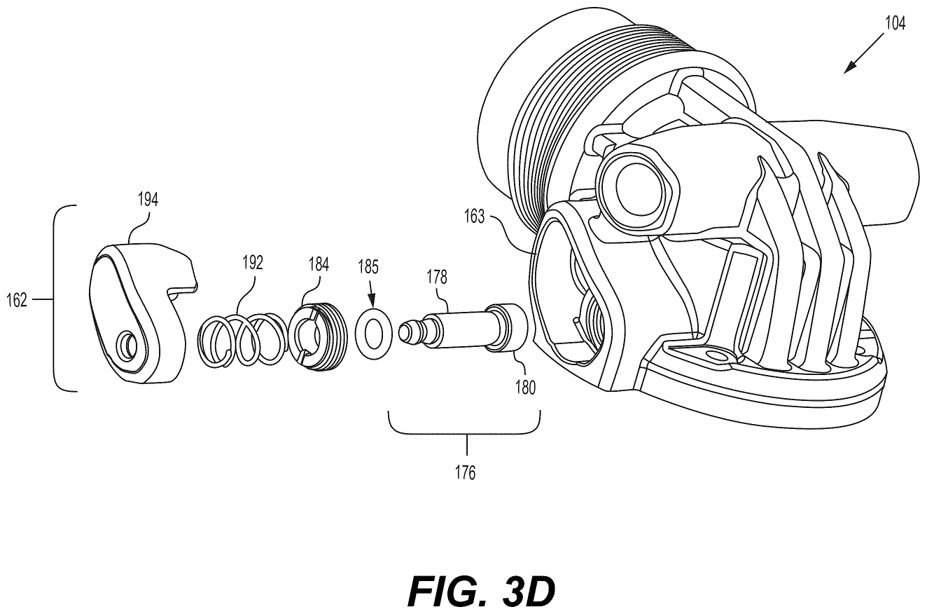

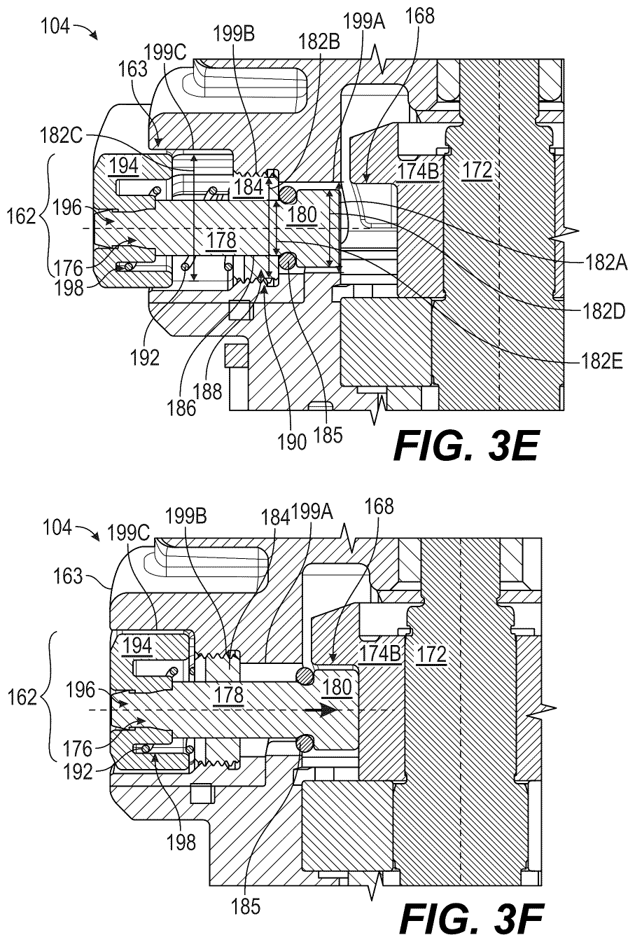

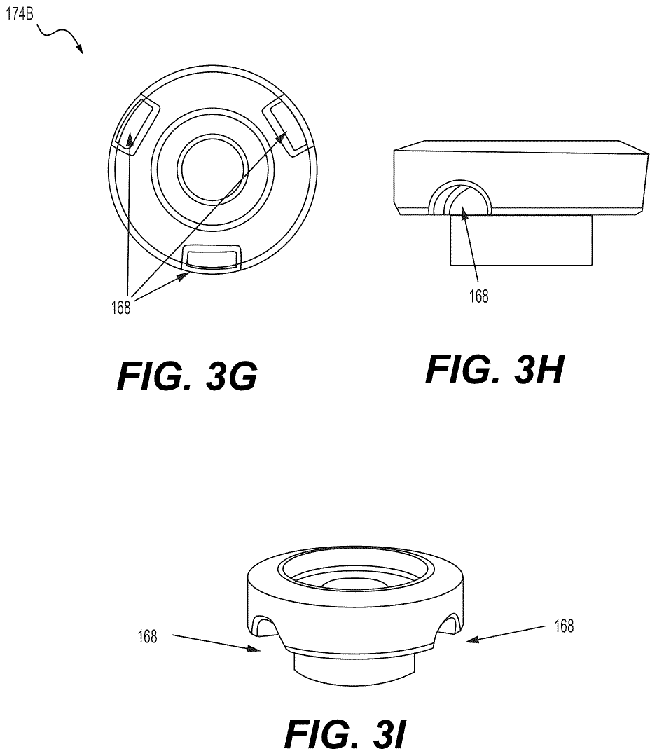

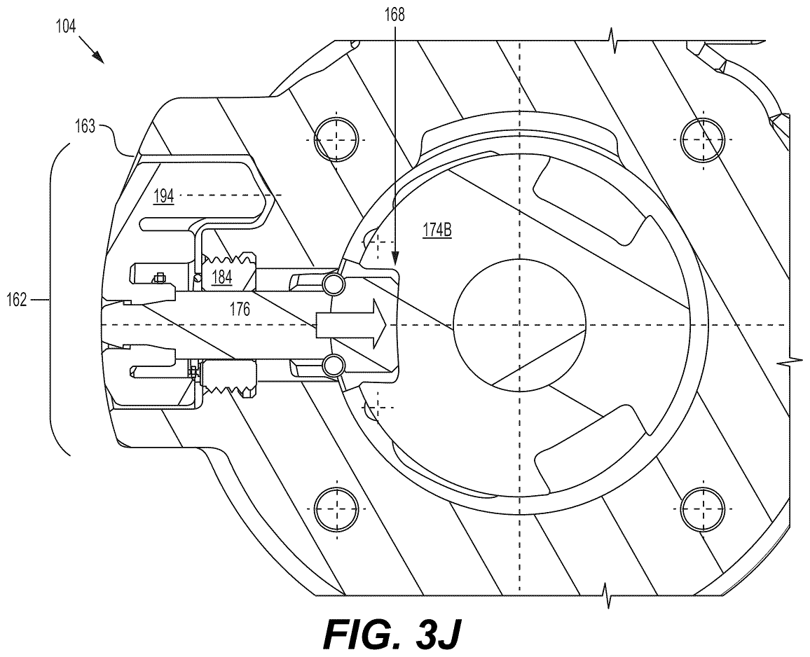

FIG. 3A depicts a perspective view of gear housing 104, according to an example of the present disclosure. FIGS. 3B, 3C, and 3D all depict exploded views of a gear housing 104. FIGS. 3E and 3F depict details of cross-sectional view C-C from FIG. 3A of a retractable spindle lock. FIGS. 3G, 3H, and 3I depict bottom, side, and perspective views of a spindle lock gear. FIG. 3J depicts a detail of cross-sectional view D-D from FIG. 3A of a retractable spindle lock.

Referring to FIG. 3C, the gear housing 104 may include an upper gearcase 104A and a lower gearcase 104B. In examples, the upper gearcase 104A may at least partially receive the motor shaft 160, the front motor bearing 134, the pinion bevel gear 174A, and a retractable spindle lock 162. In examples, the lower gearcase 104B may house an output spindle 172, a spindle-mounted gear (i.e., output bevel gear 174B), the tool head 114A, and, in examples, the wheel guard 116. When the gear housing 104 is fully assembled with the upper gearcase 104A and the lower gearcase 104B, the motor shaft 160 is coupled to the output spindle 172 via a bevel gearset 174, which may also be referred to as the transmission.

In examples, the tool 100 may include the retractable spindle lock 162 positioned in the gear housing 104. In examples, the retractable spindle lock 162 may be positioned inside an opening 163 in the gear housing 104, for example, in the upper gearcase 104A.

The retractable spindle lock 162 may be used to lock the output spindle 172 so that a lock nut 164 may be tightened or loosened, typically with a wrench or a spanner, to install, remove, or change different rotating tool accessories, for example, wheels, blades, bits, die grinder pieces, etc. The rotating tool accessory may be secured within the wheel guard 116 between a backing flange 166 and the lock nut 164.

Although the retractable spindle lock 162 is shown in connection with an angular tool, the retractable spindle lock 162 may be used with an angular or straight tool device. In examples, the motor shaft 160 (more clearly shown in FIGS. 1B and 2B) may be coupled at a first end 173 (see FIG. 1B) to a motor, and at an opposite end to a transmission, for example the bevel gearset 174 (see FIGS. 1B and 2B). The tool 100 may further include the output spindle 172 (see FIGS. 1D and 3C) oriented perpendicular to the motor shaft 160. The motor shaft 160 and the output spindle 172 may be coupled via the bevel gearset 174 (see FIGS. 1D and 2B), with the pinion bevel gear 174A fixed to the motor shaft 160 and the output bevel gear 174B fixed to the output spindle 172.

The output spindle 172 may include a spindle lock recess 168. In some examples, as shown in FIGS. 3G, 3H, and 3I, the spindle lock recess 168 is integral to the output bevel gear 174B (see FIGS. 3G, 3H, and 3I) coupled to the output spindle 172. The spindle lock recess 168 may be configured to engage the spindle lock 162 in a radial direction. The spindle lock recess 168 has a cross-sectional semi-circular shape, although other suitable shapes may be utilized.

In examples, the output bevel gear 174B includes three spindle lock recesses 168 equilaterally positioned around a perimeter of the output bevel gear 174B, although one or more spindle lock recess 168 may be provided.

In examples, the output bevel gear 174B includes a central borehole that is interference fit and pressed onto the output spindle 172. In examples, the output bevel gear 174B may be coupled to the output spindle 172 via other suitable arrangements, such as adhesives, fasteners, welding, or forming integrally. In examples, the spindle lock recess 168 may be integral to the output spindle 172, or may be integral to another component, other than a gear, and fixed to the output spindle 172. In an example, the output bevel gear 174B engages with the pinion bevel gear 174A fixed to the end of the motor shaft 160 to transfer the rotational movement and energy of the motor shaft 160 to the output spindle 172.

The retractable spindle lock 162 may be coupled to gear housing 104 via the opening 163 in gear housing 104. The opening 163 is formed by a wall that projects from one side of the gear housing 104 shaped to receive the spindle lock 162 therein. As shown in FIGS. 3D, 3E, 3F, and 3J, the retractable spindle lock 162 may be configured to engage the spindle lock recess 168 in a radial direction with respect to the output spindle 172. FIG. 3E depicts the retractable spindle lock 162 in a disengaged position and FIGS. 3F and 3J depict the retractable spindle lock 162 in an engaged position (as indicated by the arrows).

In examples, the retractable spindle lock 162 includes a pin 176 with a pin shaft 178 and a pin head 180 having a pin head diameter 182D. The pin 176 may be retractable and operable to engage the spindle lock recess 168. In examples, the pin head 180 is cylindrical and is operable to engage the semi-circular spindle lock recess 168. In examples, any combination of shapes of the pin head 180 and the spindle lock recess 168 may be utilized.

In examples, as shown in FIG. 3F, the pin shaft 178 may include an O-ring 185. In examples, the O-ring 185 may help maintain alignment of the pin shaft 178 within the opening 163. In examples, the O-ring 185 may also provide a compliant surface between a threaded insert 184 and the pin head 180 that prevents the threaded insert 184 and the pin head 180 from coming into contact, and compression of such compliant member may provide a seal to prevent grease within the gear housing 104 from migrating around the pin shaft 178 to the outside of the gear housing 104.

In examples, the threaded insert 184 may be used to retain the pin 176 within the gear housing 104. The threaded insert 184 may be primarily annular in shape, including a threaded insert borehole 186 and an external insert thread 188. In examples, the threaded insert borehole 186 may be configured to be slidingly positioned on the pin shaft 178 and the external insert thread 188 may be configured to match an internal housing thread 190 within the gear housing 104.

The pin shaft 178 may be placed inside the gear housing 104 via the opening 163 before the threaded insert 184 is threaded into the gear housing 104. The pin head diameter 182D may be larger than an internal insert borehole diameter 182E, thereby retaining the pin 176 within the gear housing 104 when the threaded insert 184 is tightened into the gear housing 104.

In examples, the retractable spindle lock 162 may further include a spring 192 configured to bias the pin 176 away from the spindle lock recess 168 when the retractable spindle lock 162 is not being engaged by a user.

In examples, the retractable spindle lock 162 may further include a button member 194 coupled to a button end 196 of the pin shaft 178 opposite the pin head 180. In examples, the button member 194 may have a kidney-like shape or be otherwise shaped to accommodate applying pressure with a thumb, thereby increasing the ergonomic feel of the retractable spindle lock 162.

In examples, the button member 194 may include a spring seat 198 to allow the spring 192 to be securely seated upon the spring seat 198. The spring seat 198 may include an annular shaped cavity within the button member 194 that provides a surface for the spring 192 to push against and/or a cylindrical wall to keep the spring 192 centered and secure within the retractable spindle lock 162. At an end of the spring 192 opposing the button member 194, the spring 192 may be further seated upon a surface of the threaded insert 184.

The button member 194 may be configured to be mounted upon the button end 196 of the pin 176. For example, the pin shaft 178 may have an arrow shape with a barb at the button end 196 which can be snap fit through a narrower portion of the button member 194 to retain the pin 176. The snap fit may rely on some portion of the button end 196 or the button member 194 having elastic properties or be designed for plastic deformation to allow the coupling of the button member 194 to the pin 176.

The gear housing 104 may further include a stepped profile to facilitate the coupling of the retractable spindle lock 162 to the gear housing 104 through an exterior of the gear housing 104. The stepped profile may be oriented radially with respect to the output spindle 172 within the gear housing 104, and may include a first borehole 199A, a second borehole 199B, and a housing opening 199C, as shown in FIG. 3E.

The first borehole 199A may have a first diameter 182A and may be positioned adjacent to the spindle lock recess 168. The first diameter 182A may be sized to allow for the pin head 180 with the pin head diameter 182D to rest within the first borehole 199A when the retractable spindle lock 162 is not engaged. When the retractable spindle lock 162 is engaged by a user, however, the pin head 180 may be pushed out of first borehole 199A into the spindle lock recess 168, as depicted in FIG. 3F.

The second borehole 199B with a second diameter 182B may be positioned adjacent to the first borehole 199A. The second borehole 199B may include the internal housing thread 190 of the gear housing 104 to engage the external insert thread 188 of the threaded insert 184. Because the second diameter 182B may be larger than the first diameter 182A, a shoulder surface is provided within the gear housing 104 that the threaded insert 184 may be tightened against.

The housing opening 199C may be positioned adjacent to the second borehole 199B. The housing opening 199C may have a housing opening minimum width 182C that is larger than the second diameter 182B. In examples, the housing opening 199C may be a circular borehole. In examples, the housing opening 199C may be sized to accommodate any size or shape of the button member 194 in any orientation. Regardless of the shape of the perimeter of the housing opening 199C, so long as the housing opening minimum width 182C is larger than the second diameter 182B, it will be possible to assemble the retractable spindle lock 162 through the opening 163. Allowing the retractable spindle lock 162 to be assembly from an exterior of the gear housing 104 via the opening 163 provides an easier assembly and manufacturing of the gear housing 104 compared to arrangements requiring some of the components to be assembled internally.

In examples, the housing opening 199C may be configured to allow a portion of the button member 194 coupled to the button end 196 of the pin shaft 178 to recess into the gear housing 104.

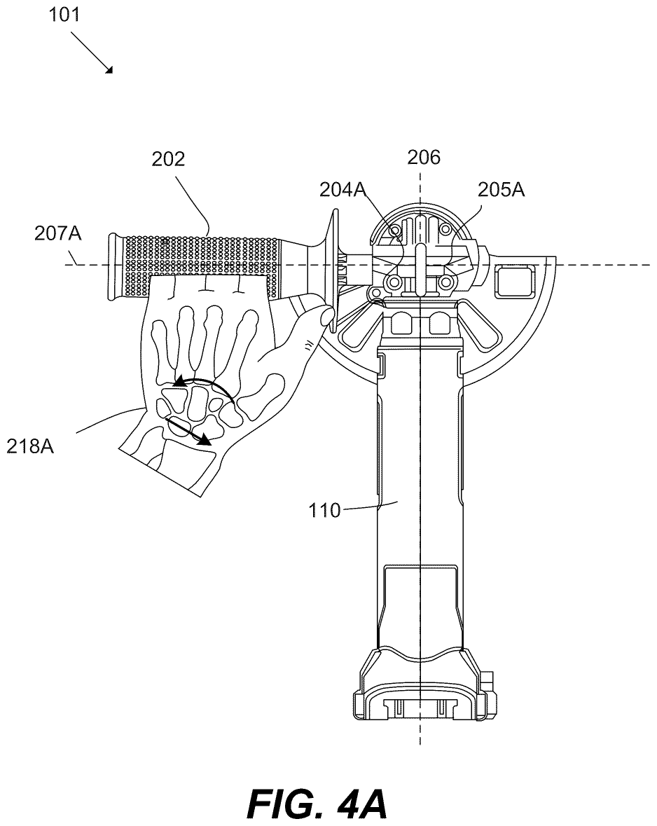

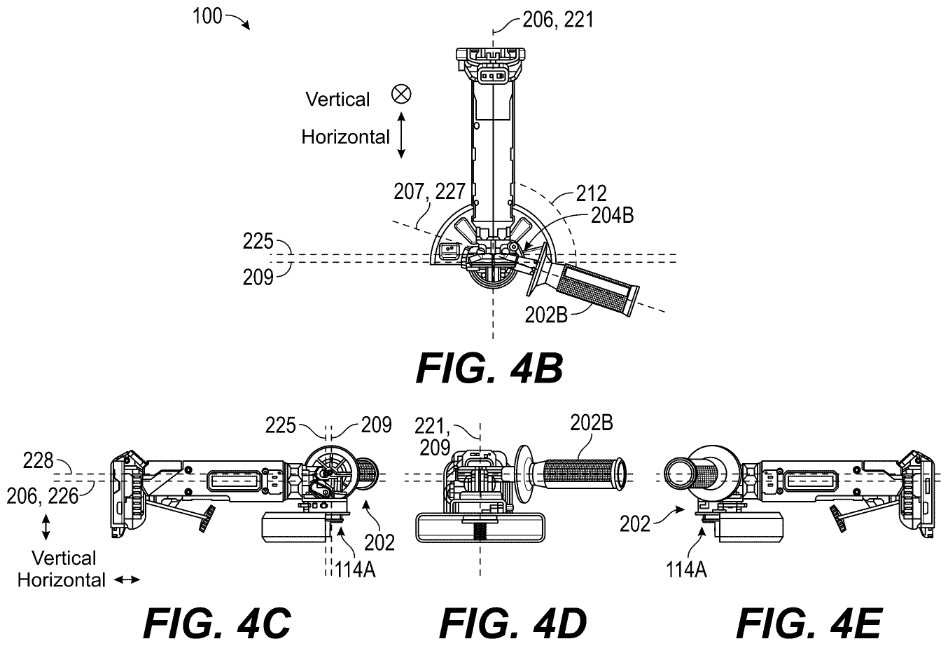

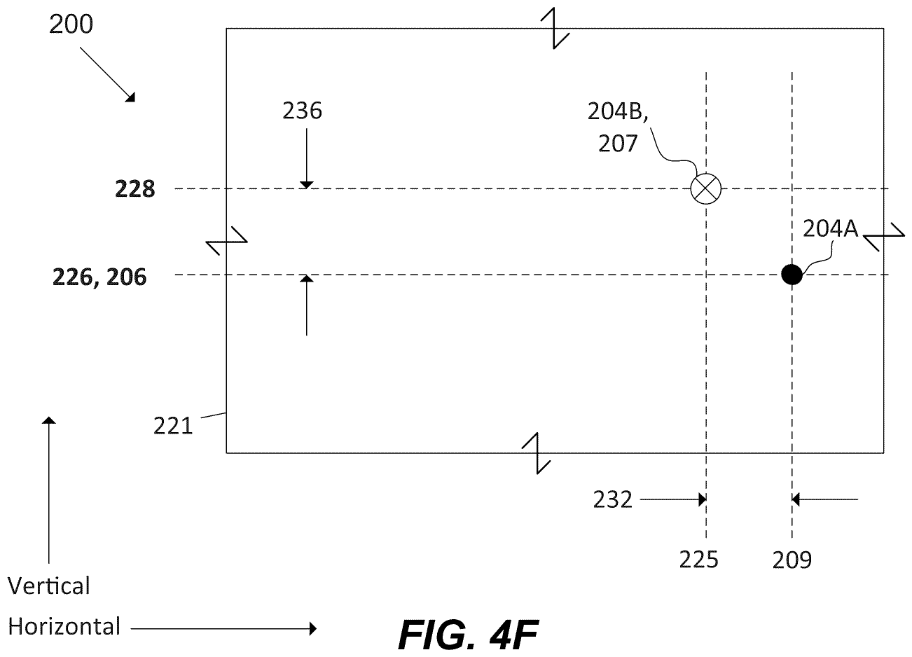

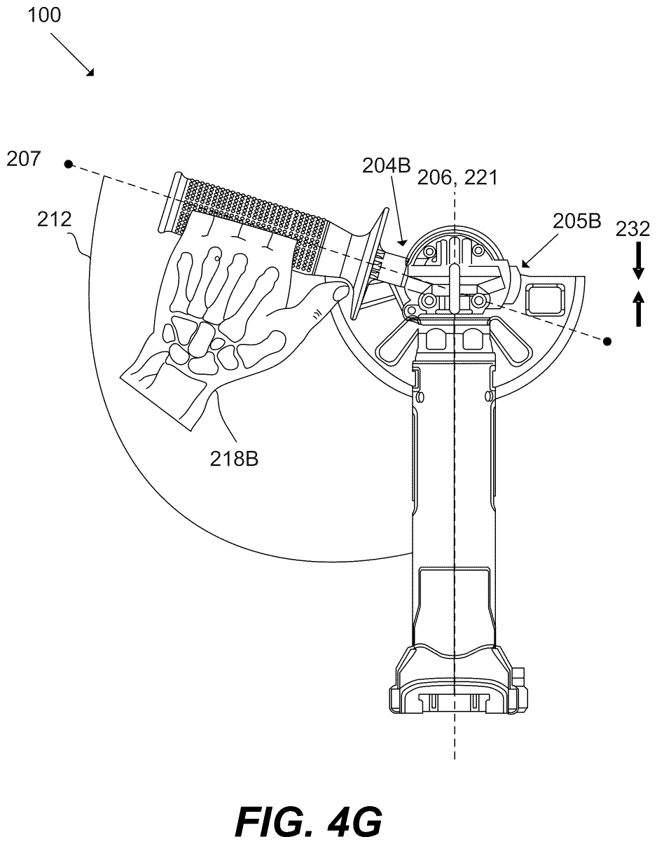

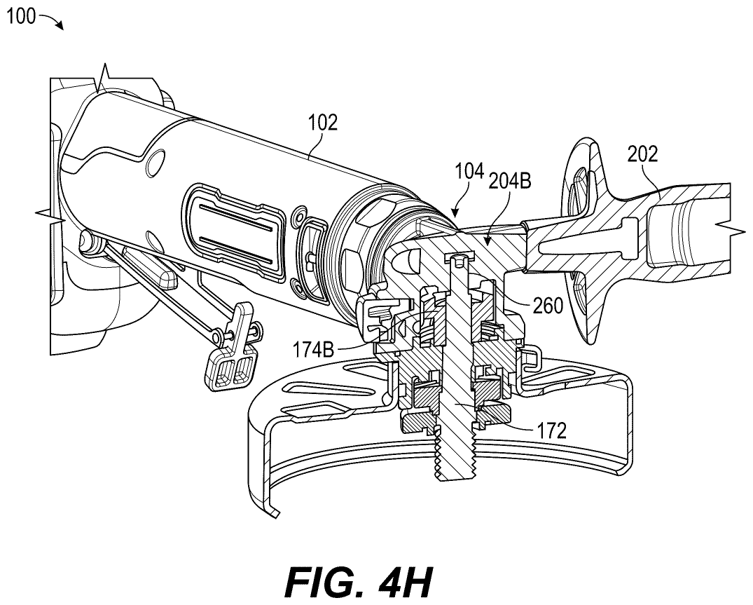

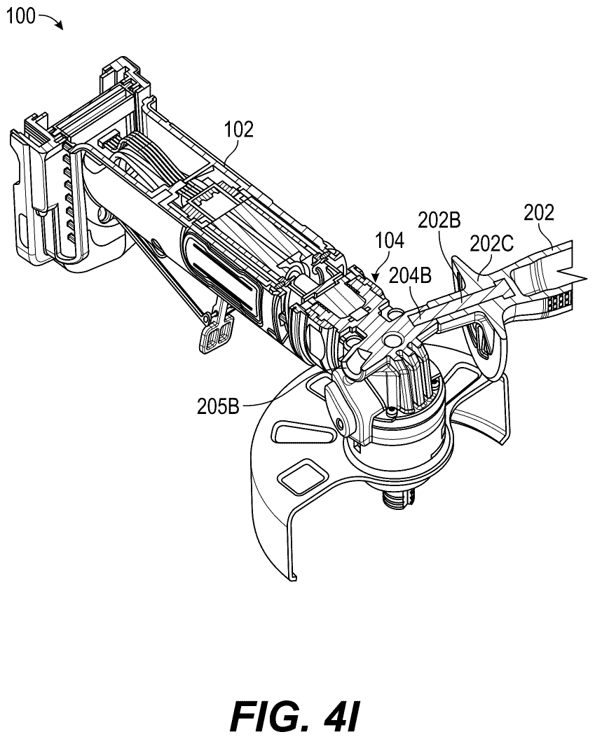

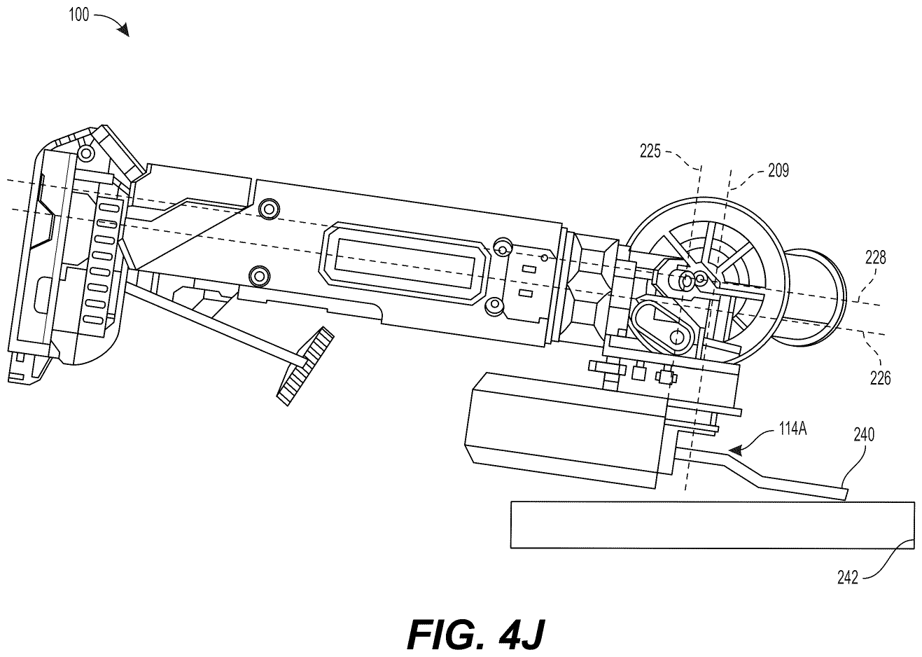

FIGS. 4A and 4G depict top views of a tool with a side handle 202 attached and a representative user's hand for reference. FIG. 4B depicts a top view, FIG. 4C depicts a right view, FIG. 4D depicts a front view, and FIG. 4E depicts a left view of tool 100 with a side handle 202 attached, according to an example of the present disclosure. FIG. 4F depicts a simplified line diagram 200 of the tool 100 depicted in FIG. 4C. FIG. 4H depicts a perspective view of tool 100 with a side handle 202 attached cross-sectioned along a vertical plane through the side handle 202 and the output spindle 172, according to an example of the present disclosure. FIG. 4I depicts a perspective view of the tool 100, with the side handle 202 attached, cross-sectioned along a horizontal plane through a side handle centerline axis 207. FIG. 4J depicts a tool oriented as it may be held by a user according to an example of the present disclosure.

In examples, the tool 100 may include positioning and orientation of the side handle 202 that provide improved ergonomics for a user of the tool 100. FIGS. 4A-4E and 4G-4J all depict the tool 100 with the side handle 202. In examples, the side handle 202 may be removable. To facilitate the removable features, the tool housing 102, or for example the gear housing 104, may include a handle coupling receptacle 204B (see FIG. 4I). In examples, the side handle 202 may include external threads and the handle coupling receptacle 204B may include internal threads. In examples, the side handle 202 may include an integral bolt 202B housed within the side handle main body 202C. An integral bolt 202B may be constructed of steel or other metal material for strength and robustness of connection to the handle coupling receptacle 204B. In examples, other mechanisms of coupling the side handle 202 to the gear housing 104 via the handle coupling receptacle 204B are possible. In examples, there may be more than one instance of the handle coupling receptacle 204B (for example a second handle coupling receptacle 205B) on either side of the tool 100 to facilitate multiple advantageous grip positions for a user.

Referring to FIG. 4A, the tool 101 is shown with the side handle 202 coupled to the handle coupling receptacle 204A with a centerline axis 207A oriented perpendicular to a motor shaft centerline axis 206. In examples, the tool 101 may further include the second handle coupling receptacle 205A. A user holding the tool 101 with the orientation of the side handle 202 depicted in FIG. 4A will grip the tool housing 102 along the cylindrical body 110 with a right hand (not pictured) and hold the side handle 202 with a left hand 218A. The left hand 218A will place a user's wrist joint out of alignment, potentially creating an ulnar deviation between the ulnar bone and the neutral position of the wrist, as represented by the arrows depicted over the hand 218A. Ulnar deviation can cause repetitive strain injury for a user by placing rotational and lateral stress on the wrist joint.

In examples, the tool 100 may include the side handle 202 oriented to reduce ulnar deviation by changing the orientation of the handle coupling receptacle 204B in the gear housing 104. FIGS. 4B-4J depict an orientation for the handle coupling receptacle 204B that places a wrist in a more neutral alignment, as compared to the handle coupling receptacle 204A, to avoid potential strain. Note that while FIGS. 4B-4J may depict the side handle 202 as being coupled to the tool 100 for a left-hand grip, in examples the tool 100 may include any combination of the handle coupling receptacle 204B and/or the second handle coupling receptacle 205B for attaching the side handle 202 to either side of the gear housing 104.

FIGS. 4B-4E depict one or more axes and planes that will be used to describe example placements of one or more of the handle coupling receptacle 204B and/or the second handle coupling receptacle 205B. In examples, the motor shaft 160 rotates about the motor shaft centerline axis 206, the output spindle 172 rotates about an output spindle centerline axis 209, a longitudinal length of the side handle 202 is oriented about a centerline that establishes the handle centerline axis 207, and the longitudinal length of the housing 102 along the cylindrical body 110 is oriented about a centerline axis that may be coincident with the motor shaft centerline axis 206.

The planes described in the present description are named vertical and horizontal with respect to nominal orientations of the tool 100 with the motor shaft centerline axis 206 establishing true horizontal, and the output spindle centerline axis 209 establishing true vertical for simplicity and clarity. FIGS. 4C-4E include a legend depicting vertical as up and down on the sheet and horizontal being left and right across the sheet. FIG. 4B includes a legend depicting that the vertical direction is into the sheet, and the horizontal direction is up and down on the sheet. The use of the terms horizontal and vertical is not intended to be limiting, however, and the terms are only used to reference directions in the description. The tool 100 may be operated in any orientation by a user. The planes described below are defined by dotted lines in the figures and extend into/out of the figures upon which they are drawn.

A vertical handle centerline axis center plane 227, depicted in FIG. 4B, is defined as a vertical plane intersecting the handle centerline axis 207.

A vertical tool centerline plane 221, depicted in FIGS. 4B, 4D, and 4F is defined as a vertical plane that includes the motor shaft centerline axis 206 and the output spindle centerline axis 209.

The handle centerline axis 207 intersects the vertical tool centerline plane 221 at a location of the coupling receptacle 204B, as depicted in FIG. 4F. The location of the coupling receptacle 204B may be offset from the location of the coupling receptacle 204A in a vertical and/or a horizontal direction.

A horizontal tool centerline plane 226, depicted in FIGS. 4C-4F, is defined as a horizontal plane that includes the motor shaft centerline axis 206.

A horizontal handle centerline axis plane 228, depicted in FIGS. 4C-4F, is a horizontal plane and is defined as a horizontal plane that is offset vertically from the horizontal tool centerline plane 226, as represented in FIG. 4F by arrows marking an offset 236. The horizontal handle plane 228 includes the handle centerline axis 207.

A vertical handle receptacle plane 225, depicted in FIG. 4F, is a vertical plane that is offset from the output spindle centerline axis 209 by an offset 232 in a direction opposite the front of the tool 100 that includes the coupling receptacle 204B.

In examples, the offset 236 may be between 7-10 mm long. In examples, the offset 236 may be 8.5 mm long.

In examples, the offset 232 may be between 7-10 mm long. In examples, the offset 232 may be 8.6 mm long.

Turning to the tool 100 depicted in FIG. 4G, in examples, the handle centerline axis 207 may be oriented to avoid ulnar deviation in left hand 218B by titling the handle centerline axis 207 at an angle 212 that is greater than 90 degrees with respect to a portion of the vertical tool centerline plane 221. In examples, by orienting the handle centerline axis 207 with the angle 212 between approximately 105 to 122 degrees, a neutral wrist position may be provided to avoid wrist strain for the user.

FIG. 4J depicts the tool 100 tilted in an operational position, according to examples. The tool 100 includes a grinder wheel 240 and a workpiece 242. During a cutting or grinding operation, the tool 100 is typically oriented so that the tool head 114A is tilted down towards the workpiece 242 at an angle of approximately 30 degrees. As may be seen, when the handle receptable coupling axis 207 is oriented with the angle 212 greater than 90 degrees with respect to a portion of the motor tool centerline plane 221, and the tool 100 is in the operational position depicted in FIG. 4J, the side handle 202 points forward towards the workpiece 242. The displacement of the side handle 202 towards the workpiece 242 may place a user's hand in a dangerous position. Additionally, the displacement of the side handle 202 toward the workpiece 242 may frustrate a user's ability to see the workpiece clearly.

Referring again to FIG. 2F, any combination of the offsets 232, 236 may move a location of the coupling receptacle 204A in a direction opposite the workpiece 242. With the location of the coupling receptacle 204A offset above the motor shaft centerline axis 206 and offset towards a user from the output spindle centerline axis 209, the side handle 202 may be positioned further away from the workpiece 242. This will make it easier for a user to view the workpiece 242 without the side handle 202 obstructing the line of sight.

In examples, the offset 232 and/or the offset 236 may allow for better maneuvering and control by a user utilizing the tool 100.

In examples, the offset 232 and the offset 236 may allow for the handle coupling receptacle 204B to be positioned in a location that avoids interference with the motor shaft 160, the output spindle 172, and/or the bevel gearset 174 within the gear housing 104. For example, as may be seen in FIGS. 4H and 4I, the offset 232 may allow for the handle coupling receptacle 204B to be positioned on an end of the tool housing 102 of the upper gearcase 104A so that the side handle 202 is not collocated with the output spindle 172 and/or the bevel gearset 174. The offset 236 may allow for the handle coupling receptacle 204B to be placed above the output spindle 172 and the bevel gearset 174 on the upper gearcase 104A. In this way, the handle coupling receptacle 204B may avoid interference with, for example, a placement of a needle bearing 260 within the upper gearcase 104A.

In examples, the positioning handle coupling receptacle 204B on the gear housing 104 with the offset 232 and the offset 236 may require adding material to the upper gearcase 104A of the gear housing 104. The additional material needed to form the handle coupling receptacle 204B on the upper gearcase 104A may allow for more distance between user's hand and the hazards of the grinder wheel 240 (or any rotating accessory), the wheel guard 116, and/or the workpiece when the tool is in use. The additional material may further increase the structural integrity of the gear housing 104, making it more resilient to wear, drop impact, etc.

In examples, the upper gearcase 104A may further include a rib structure 222 extending on an exterior of the housing between the handle coupling receptacle and the tool head. The rib structure 222 may be seen in FIG. 3A. The example tool 100 includes three rib structures 222, although one or more rib structures 222 may be utilized. The rib structure 222 may further increase the structural integrity of the tool and maintain a safe touch temperature for the user.

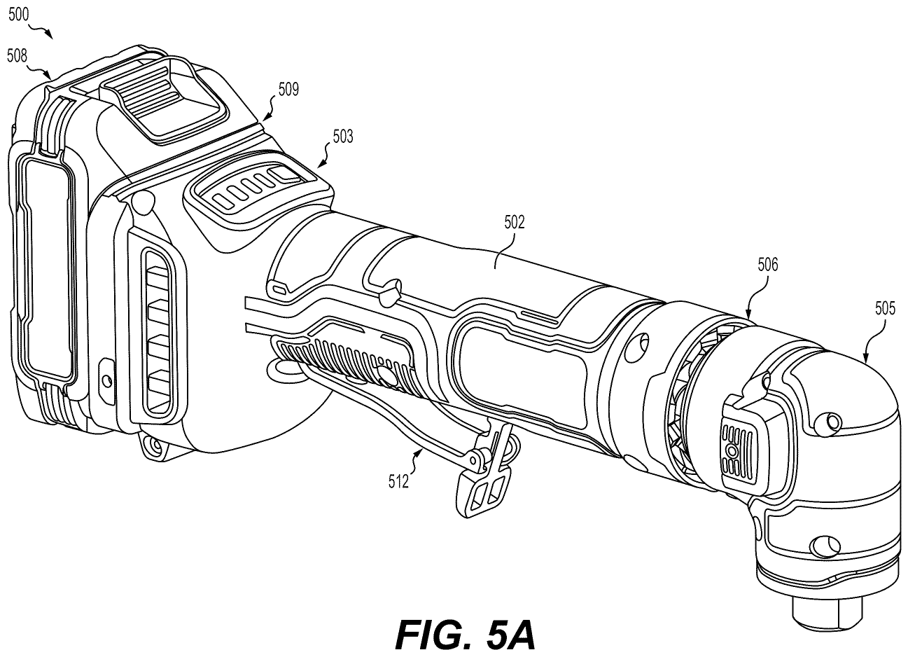

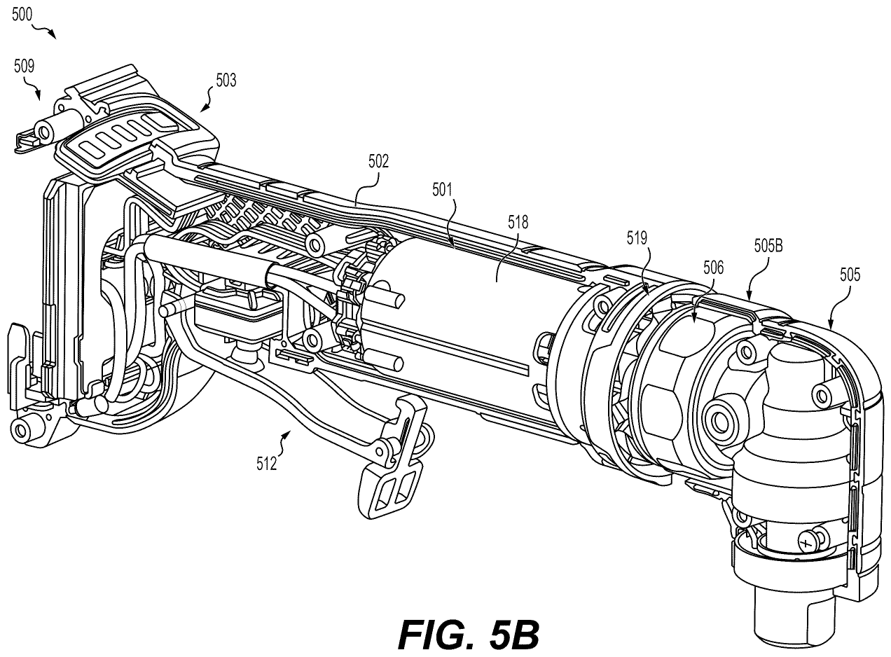

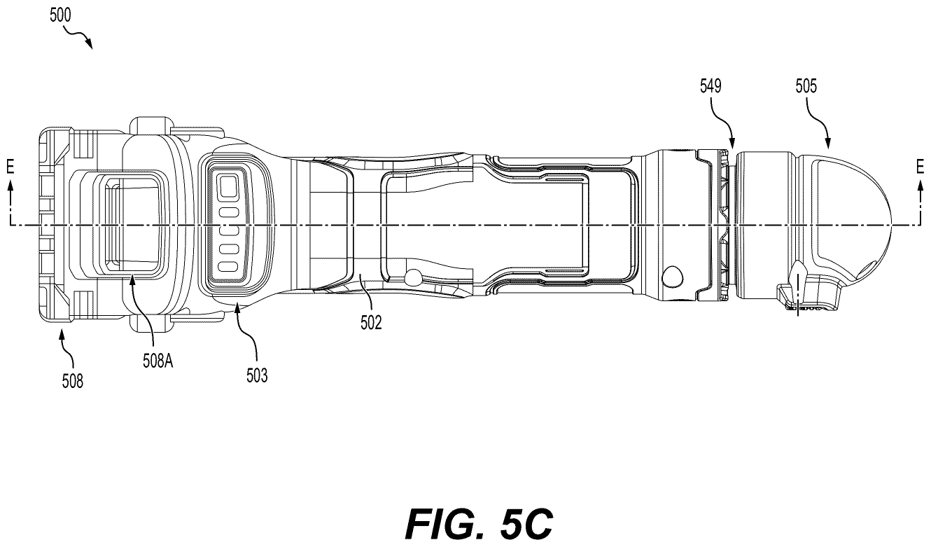

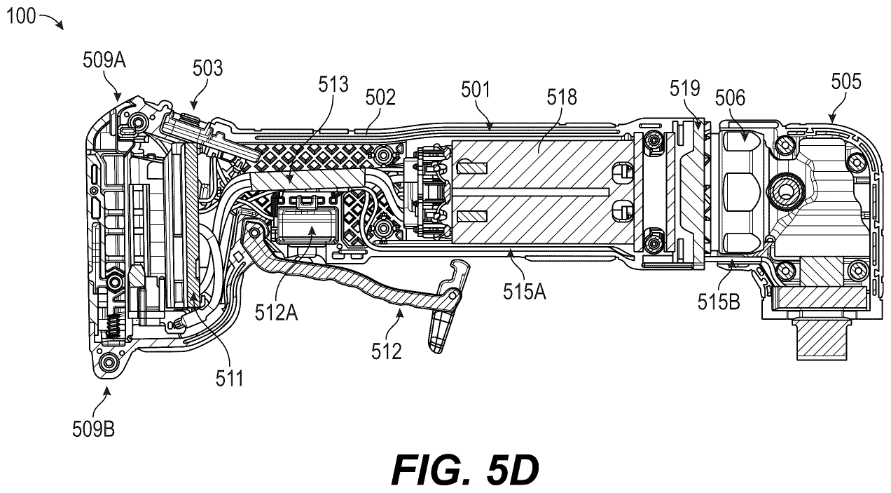

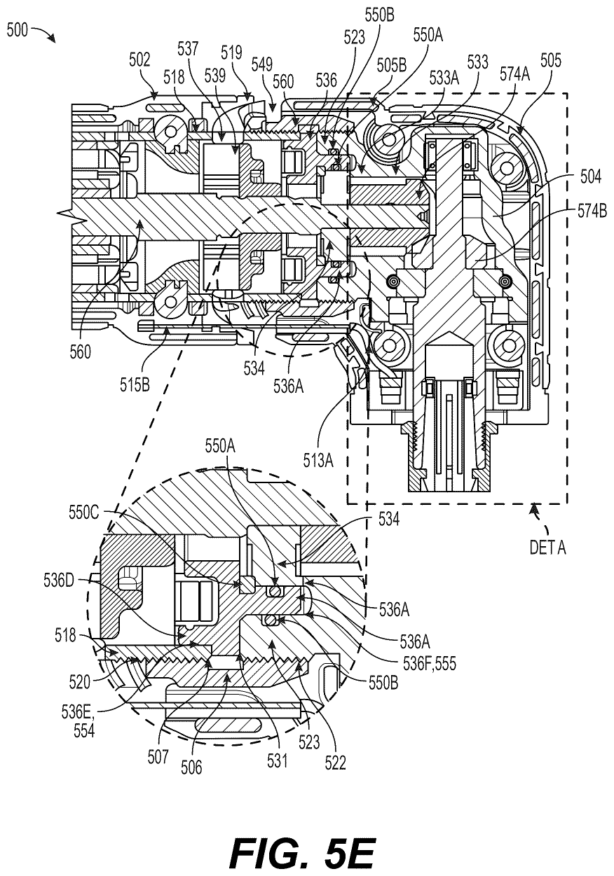

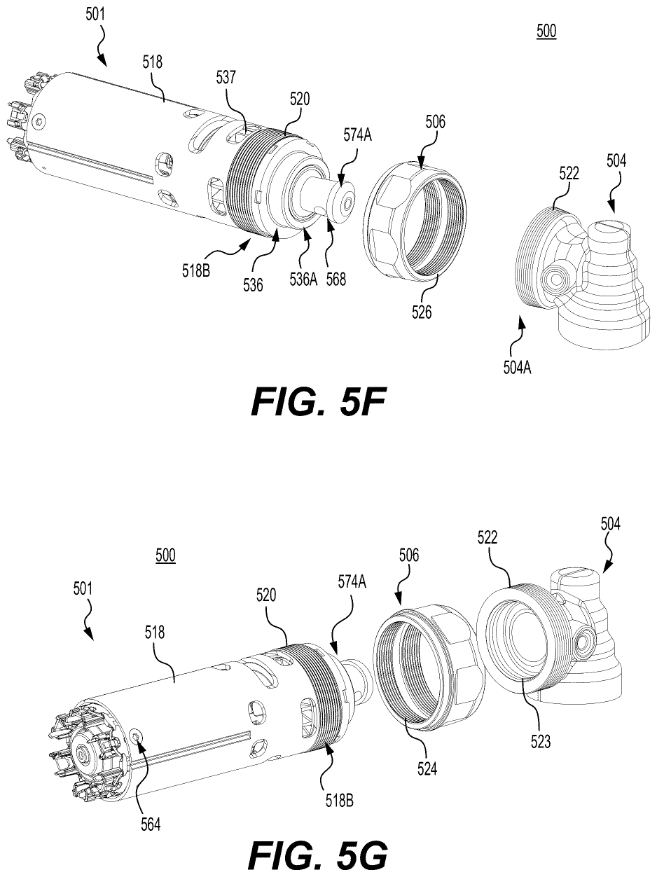

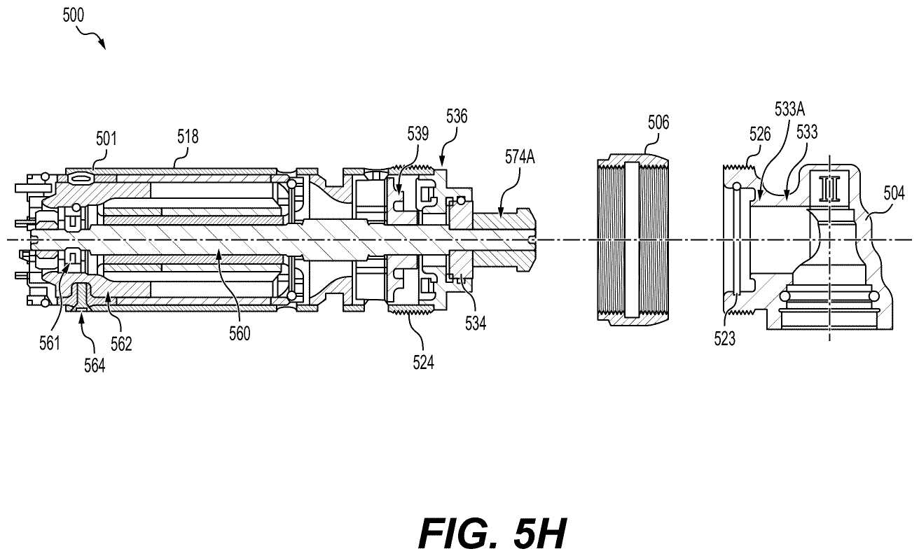

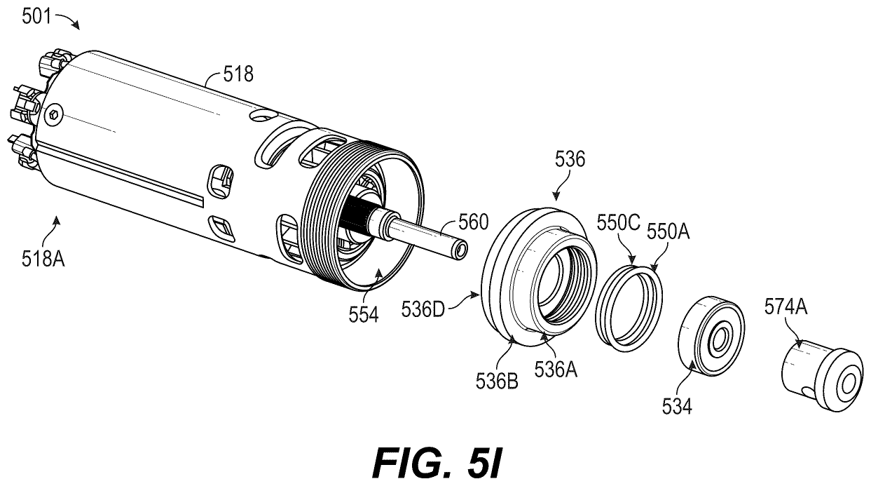

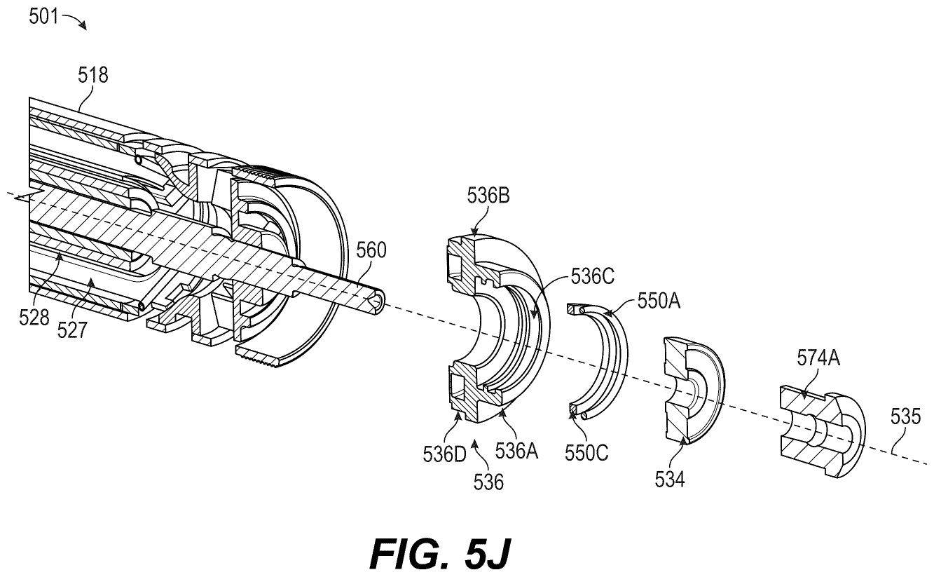

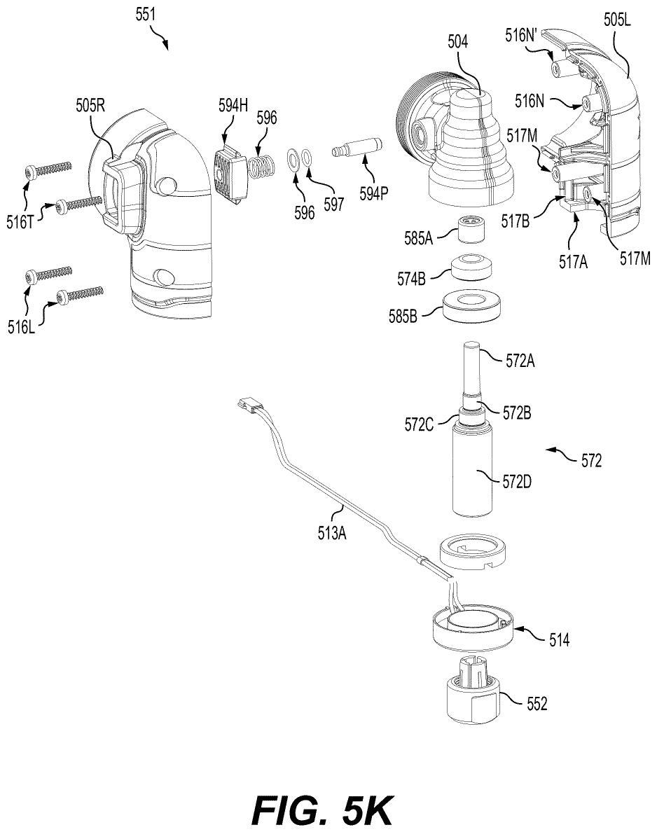

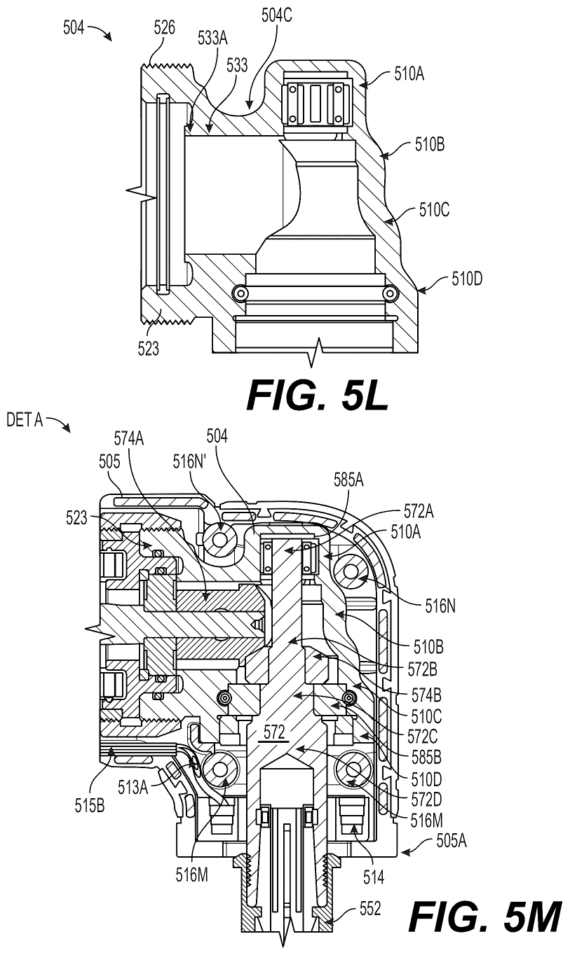

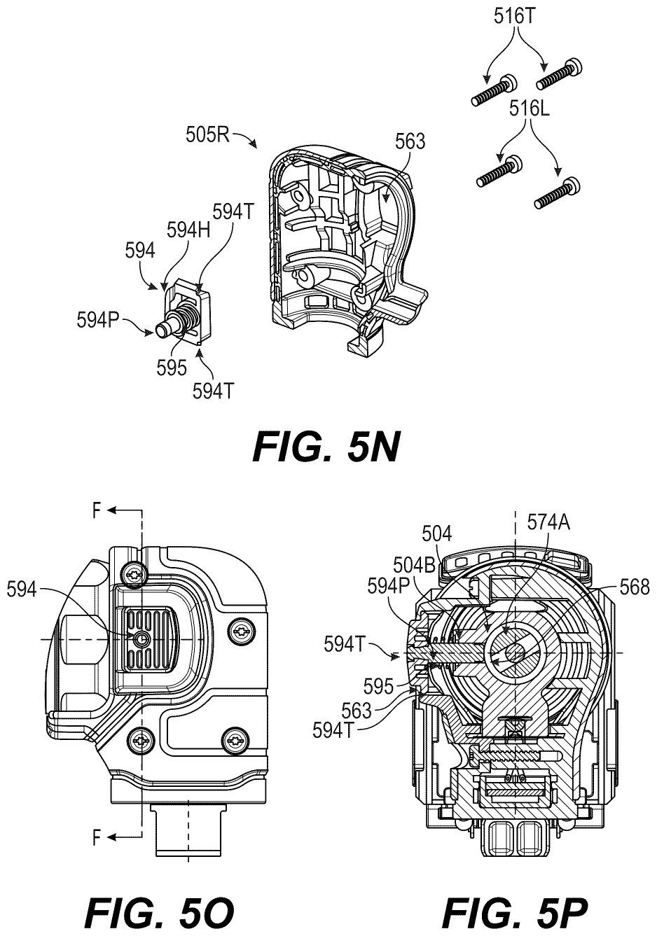

FIGS. 5A-5P depict features of an example tool 500. FIG. 5A depicts a perspective view of the tool 500, FIG. 5B depicts a perspective view of the tool 500 with a portion of the housing and a battery pack removed, FIG. 5C depicts a top plan view of the tool 500, FIG. 5D depicts a right view of the tool 500 with the housing removed, and FIG. 5E depicts a partial cross-section E-E view of the tool 500 depicted in FIG. 5C.

The tool 500 includes a tool housing 502 and a gear case housing (i.e., shroud) 505. In examples, tool 500 includes a motor assembly 501 including a motor housing 518 that houses motor components including a stator and a rotor therein. In examples, the gear case housing 505 may house a gear case 504 that supports one or more gears for supporting an output spindle that is perpendicularly driven by the motor assembly 501. The gear case 504 and the motor housing 518 may both be made of metal while the tool housing 502 and the gear case housing 505 may be made of plastic material. The gear case 504 may be coupled to a front end of the housing 518 via a collar 506, which may be made of metal as will be further described below. The tool 500 may include a battery receptacle 509 that receives a removeable battery pack 508 and a mode select interface 503.

The tool 500 may include any type of power tool with a rotational or fixed head such as a grinding tool, a die tool, a router, a saw, a drill, an impact tool, a hammer tool, a reciprocating tool, or any other tool driven by a rotating motor shaft. In examples, the tool 500 may include a single motor shaft, or a motor shaft and an output spindle coupled together via a transmission such as a bevel gearset, for example. As shown in FIG. 5A, in one example, the tool 500 is an angle die grinder.

In examples, the mode select interface 503 and the battery pack 508 may include features similar to those described for the interface and display panel 103 and the battery receptacle 108 above. In an embodiment, the mode select interface 503 includes a mode select button and a plurality of LEDs that indicate a selected mode of operation to the user.

The battery pack 508 may couple to battery receptacle 509. In an example, the battery receptacle 509 may include a rear portion 509A that extends at an angle of approximately 15-30 degrees from the tool housing 502 towards a body of the tool 500. The battery receptacle 509 may further include a front portion 509B that extends at an angle that is approximately perpendicular to the handle (see FIG. 5D). The battery pack 508 may be accommodated within the rear portion 509A. The sliding axis of the battery pack 508 is such that it may first be received proximate the rear portion. The battery pack 508 may include a latch 508A. When fully received, the latch 508A may be located adjacent to the mode select interface 503.

The battery pack 508 may provide power to a motor to operate the tool 500 when a trigger switch 512 is engaged by a user. In FIG. 5D, a control and power module 511 is depicted. The control and power module 511 may be used to operate the motor of the tool 500 and/or a light 514.

A wire harness 513 may couple the control and power module 511 to the motor and/or light 514. The wire harness 513 may include any number of wires, including a series of power wires that supply electric power to the motor, a series of signal wires routed from the motor to the control and power module 511, and a wire 513A to provide power and/or a control signal to the light 514 (see FIG. 5E). In examples, the light 514 may be an LED light, discussed later in detail. In examples, the light 514 may be a ring light. FIGS. 5D and 5E depict a first channel 515A within the tool housing 502 and a second channel 515B within the gear case housing 505. The first channel 515A is formed within the tool housing 502 below the motor assembly 501 and extends from a front end of the tool housing 502 to a location between the motor assembly 501 and an electronic switch 512A that engages the trigger switch 512. The second channel 515B extends from a rear end of the gear case housing 505 in-line with the first channel 515A to the light 514. Each of the first and second channels is formed by a clamshell construction of the housings. The first channel 515A and the second channel 515B may provide a protected path for the wire 513A to feed through between the wire harness 513 and the light 514. In an example, the wire 513A is bunched together with motor and control wires rearward of the motor assembly 501 and passes through a cavity formed between the switch and the upper wall of the tool housing 502 to be received by the control and power module 511.

Referring again to FIG. 5E, a partial view of a front end of the motor assembly 501 within the tool housing 502 is further depicted. The motor assembly 501 includes a motor shaft 560 which is rotated by the motor. The motor shaft 560 is coupled to the tool 500 via a front motor bearing 534. The motor shaft 560 is rigidly coupled to a pinion bevel gear 574A, which engages with an output bevel gear 574B.

It is highly desirable for the motor assembly 501 to be fully assembled before connecting the tool housing 502 and/or to the gear case 504. The motor assembly 501 includes substantially the same or similar features as previously described with reference to the first embodiment, including a stator forming a plurality of stator windings tightly secured to the motor housing 518, and a rotor rotatably mounted within the stator and including a plurality of permanent magnets that cause rotation of the rotor as they magnetically interact with the stator windings. The rotor is mounted on the motor shaft 560, which is supported relative to the stator via a rear motor bearing (not shown) previously discussed, the front motor bearing 534, and a bearing retainer 536, as described herein. The components of the motor assembly 501 may all be assembled together within the motor housing 518, and the front motor bearing 534 may be secured to the front end of the motor housing 518, before the gear case 504 is mounted to the motor housing 518. In this manner, the time and expense to assemble the tool 500 may be significantly reduced. In an example, the bearing retainer 536 is provided to facilitate the assembly of the motor bearing 534 to the front end of the motor housing 518. In this embodiment, the portion of the power tool 500 including the motor housing 502, all the components contained in the motor housing 502, and the front motor bearing 534 and the associated components, can be platformed as a common back-end assembly and utilized across a range of different gear cases and/or gear case housings and/or output assemblies (e.g., angled gear case for a grinder, a different angled gear case for a die grinder, a linear gear case for a linear die grinder, an impact assembly for an impact driver, a reciprocating assembly for a saw, etc.).

FIG. 5F depicts a right front partially exploded perspective view of the tool 500 including the motor assembly 501 and the gear case 504, FIG. 5G depicts a right rear partially exploded perspective view of the tool 500 including the motor assembly 501 and the gear case 504, FIG. 5H depicts a right partially exploded cross-sectional view of the tool 500 including the motor assembly 501 and the gear case 504 along the section line B-B depicted in FIG. 5C, FIG. 5I depicts a right perspective partially exploded view of the motor assembly 501, and FIG. 5J depicts a right perspective cross-sectional partially exploded view of the motor assembly 501, according to examples.

The bearing retainer 536 may be seen in the exploded views of FIGS. 5I and 5J. The bearing retainer 536 may be operable to retain the front motor bearing 534 on the front end of the motor housing 518 independently of any components of the gear case or similar output assemblies. In an example, the bearing retainer 536 may help provide radial and axial alignment and piloting between the motor housing 518 and the front motor bearing 534. In an example, the bearing retainer 536 may provide a clamping surface to axially constrain the bearing retainer 536 relative to the motor housing 518 and the gear case housing 505. In an example, the bearing retainer 536 may have a substantially circular or annular shape. In examples, the bearing retainer 536 may be a single integrated portion or multiple portions coupled together.

The bearing retainer 536 may include a central body portion 536B from which additional portions with additional surfaces may extend. In an example, the central body portion 536B may include a central annular disk within the bearing retainer 536 (see FIG. 5J). In an example, the central body portion 536B may extend substantially along a radial plane and may be longer in a radial direction than in an axial direction to generate a disk-like platform. The central body portion 536B may include an outer diameter that is approximately equal to the outer diameter of the motor housing 518, so that when the central body portion 536B is sandwiched between the motor housing 518 and the gear case 504, the central body portion 536B does not extend beyond an outer periphery of the motor housing 518. Similarly, the central body portion 536B may include an outer diameter that is approximately equal to the outer diameter of the gear case 504, so that when the central body portion 536B is sandwiched between motor housing 518 and gear case 504 the central body portion 536B does not extend beyond an outer periphery of the gear case 504.

In an example, the bearing retainer 536 may further include a first annular portion 536A formed on a first surface of the central body portion 536B facing the gear case 504 and a second annular portion 536D formed on a second surface of the central body portion 536B opposing the first annular portion 536A. The first annular portion 536A has a substantially cylindrical body, providing an inner annular surface and an outer annular surface formed coaxially around the central axis 535. The inner annular surface of the first annular portion 536A may form a bearing pocket that faces away from the motor and is sized to receive and support an outer face of the front motor bearing 534 therein. In an embodiment, the inner annular surface of the first annular portion 536A may include one or more annular recesses forming at least one O-ring seat 536C. In examples, the O-ring seat 536C may be operable to retain an inner O-ring 550A and a crush ring 550C between one or more ribs. When seated in the O-ring seat 536C, the inner O-ring 550A may be located radially outside the outer race of the front motor bearing 534. The inner O-ring 550A may be operable to retain the outer race of the front motor bearing 534 against rotation after it is pressed into the bearing pocket of the first annular portion 536A, and/or function as a seal against passage of grease between the gear case 504 and the motor assembly 501. In examples, the crush ring 550C may include a square cross-section and may be located axially behind the outer race of the front motor bearing 534.

In an example, the gear case 504 includes a first annular body 533 that extends longitudinally from its main body around the front end of the motor shaft 560 and the pinion bevel gear 574A. The first annular body 533 includes an inner diameter that is smaller than an outer diameter of the front motor bearing 534, but greater than an outer diameter of the pinion bevel gear 574A. The first annular body 533 forms a gearcase shoulder 533A that engages a front portion of the outer race of the front motor bearing 534 as the collar 506 is tightened. This ensures that the front motor bearing 534 is securely held within bearing pocket of the first annular portion 536A. In an example, the crush ring 550C is pressed between the front motor bearing 534 and the bearing retainer 536 as the collar 506 is tightened. This ensures all stack-up tolerances and/or clearances are taken up between the bearing retainer 536, the front motor bearing 534, and the gearcase shoulder 533A, and that the front motor bearing 534 is always clamped tightly to the gearcase shoulder 533A.

In an example, the gear case 504 may further include a second annular body 523 that extends from a rear end of the first annular body 533, radially outwardly of the front motor bearing 534, around the central axis 535 for coupling with the front end of the motor housing 518. In an example, the second annular body 523 includes an inner diameter that is larger than the inner diameter of the first annular body 533 and an outer diameter that is substantially equal to an outer diameter of the motor housing 518. In an example, an outer annular surface of the first annular portion 536A of the bearing retainer 536 opposing the inner annular surface may be sized to be fittingly and securely received within the second annular body 523 of the gear case 504. The outer annular surface of the first annular portion 536A is secured through the open end of the second annular body 523 during the final assembly process.

In an embodiment, at least one of the outer annular surfaces of the first annular portion 536A or the inner surface of the second annular body 523 may provide a seat for an outer O-ring 550B. The outer O-ring 550B may provide a seal against flow of grease out of the gear case 504, through the bearing retainer 536 and adjacent surfaces, to outside the motor assembly 501 and/or an exterior surface of the power tool 500. In an example, the O-ring 550A and the O-ring 550B both keep grease out of the gear case 504, where the O-ring 550A seals against entry of grease to the motor housing 518, and the O-ring 550B seals against grease leakage to areas outside the motor assembly 501 and/or an exterior surface of the power tool 500. The first annular portion 536A may be fittingly received through the gear case housing 505 via the second annular body 523 of the gear case 504 during assembly, with the outer O-ring 550B in between.

Referring to FIG. 5E, a detailed view of the bearing retainer 536 is depicted. In an example, the first annular portion 536A of bearing retainer 536 may include an outer surface 536F configured to come at least partially into contact with an interior cylindrical surface 555 of the second annular body 523 of the gear case 504. The first annular portion 536A may therefore provide concentricity between the front motor bearing 534 and the second annular body 523 of the gear case 504, with all three being oriented along substantially the same radial plane.

In an example, the second annular portion 536D of the bearing retainer 536 may include a substantially cylindrical body having an outer diameter that is sized to be fittingly received through the front end of the motor housing 518. The second annular portion 536D may include an axial length of, e.g., 1-3 mm to ensure the bearing retainer 536 is properly piloted and fixed relative to the motor housing 518. In an example, the second annular portion 536D extends proximate a motor fan 539 mounted on the motor shaft 560 to generate a cooling airflow through the motor assembly 501.

In an example, the second annular portion 536D may include an outer surface 536E configured to come at least partially into contact with an interior cylindrical surface 554 of the motor housing 518. By providing contact with the interior cylindrical surface 554, the second annular portion 536D may provide concentricity between the bearing retainer 536 and the motor housing 518 to fix and secure the bearing retainer 536, and thus the front motor bearing 534, relative to the motor housing 518, along the radial direction. In turn, this ensures that the motor shaft 560 is radially fixed relative to the motor housing 518 and consequently the rest of the motor assembly 501.

In an example, as shown in FIGS. 5G and 5H, a rear motor bearing 561 is supported relative to the motor housing 518 via a rear bearing support structure 562. The details of the rear bearing support structure 562 may be found by way of example in U.S. Patent Publication No. 2022/0247257, filed Feb. 1, 2022, which is incorporated herein by reference in its entirety. In an example, the rear bearing support structure 562 is secured to the motor housing 518 via a series of radially received fasteners 564. In an example, when the rotor assembly including the shaft 560 and the rear bearing support structure 562 are mounted within the motor housing 518 and the bearing retainer 536 is positioned properly on the front end of the motor housing 518, the fasteners 564 are fastened into corresponding threaded openings of the rear bearing support structure 562. The fasteners 564 axially constrain the rear bearing support structure 562, which in turn axially constrains the shaft 560, which in turn axially constrains and securely holds the bearing retainer 536 against the front end of the motor housing 518. In this manner, the bearing retainer 536 is assembled with the rest of the motor assembly 501 as a single unit, independent of the gear case components.

The outer surface 536E and the outer surface 536F of the bearing retainer 536 may additionally help maintain concentricity between the motor housing 518 and the gear case 504, thus ensuring that the gear case 504 is properly aligned and piloted with the motor housing 518. The outer surface 536E and the outer surface 536F may allow for the bearing retainer 536 to be radially affixed with respect to the motor housing 518 and the gear case 504. In an example, the outer surface 536E and the outer surface 536F may keep an exterior motor housing thread 520 of motor housing 518 substantially radially in line with an exterior motor housing thread 522 of the gear case 504 so that collar 506 may be engaged without harming the threads.

In an embodiment, the central body portion 536B has a greater diameter than the second annular portions 536D and, as such, forms an annular flange extending from the outer surface of the second annular portions 536A. In an example, while the second annular portion 536D is sized to be fittingly received in contact with contact with the interior cylindrical surface 554 of the motor housing 518, the annular flange formed by the central body portion 536B is sized to abut against the end surface of motor housing 518.

In an example, the central body portion 536B may provide annular surfaces oriented in opposing axial directions for a gear housing exterior shoulder 531 and a motor housing exterior shoulder 507 to butt up against when the bearing retainer 536 is sandwiched between the motor housing 518 and the gear case 504.

Referring again to FIGS. 5I and 5J, to assemble the motor assembly 501, the stator 527 is assembled into the motor housing 518. The rotor 528 and the fan are fixedly mounted on the motor shaft 560. The bearing retainer 536 sub-assembly, including the crush ring 550C, the inner O-ring 550A, and the front motor bearing 534, are assembled together and mounted on the motor shaft 560. The pinion bevel gear 574A is further mounted onto the motor shaft 560, which completes the rotor sub-assembly for placement into the motor housing 518. The rotor sub-assembly is rotatably coupled to the motor housing 518 at a far end 518A via a rear motor bearing (not depicted) previously discussed. The second annular portion 536D of the bearing retainer 536 may be inserted just inside the interior cylindrical surface 554 during the assembly process.

Referring again to FIGS. 5F and 5G, the motor housing 518 includes a motor collar thread 524 positioned at the front end thereof adjacent to a gear end 518B, while the gear case 504 includes a gear collar thread 526 positioned exterior of the second annular body 523 adjacent to a motor end 504A. In order to couple the motor assembly 501 to the gear case 504, the motor end 504A of the gear case 504 is inserted over the first annular portion 536A of the bearing retainer 536. The collar 506 includes the motor collar thread 524 on an inside surface which may engage the exterior motor housing thread 520, and the collar 506 further includes the gear collar thread 526 which may engage the exterior gear housing thread 522, thereby clamping the motor assembly 501 and the gear case 504 together. Tightening the collar 506 may axially constrain the bearing retainer 536 relative to the motor housing 518 and the gear case 504. In an example, the motor assembly 501 and the gear case 504 may each clamp against a respective side of the bearing retainer 536. In an example, a thread tightening resistance or retention material to provide some bonding or adhesion between any pair of coupled threads.

In an example, after the motor assembly 501 and the gear case 504 are assembled as described above, the motor assembly 501 secured within the clamshell arrangement of the tool housing 502, and the gear case 504 is secured within the clamshell arrangement of the gear case housing 505. In an example, the gear case housing 505 may be shaped to fully or at least substantially capture the periphery of the collar 506. In an example, the gear case housing 505 includes a stepped portion 505B (FIG. 5B) designed to be disposed around at least a gripping surface of the collar 506 to block user access to the collar 506 from the outside environment.

In an example, the motor collar thread 524 of the motor housing 518 may be located axially forward of the motor fan 539, which may be fully contained within the motor housing 518. One or more air openings 537 (e.g., vents) may be formed in the motor housing 518 around the motor fan 539 to allow the fan to exhaust the air from the motor assembly 501 in a substantially radial/tangential trajectory. The front end of tool housing 502 may be approximately radially aligned with the air openings 537, forming an axial gap 549 from the stepped portion 505B of the gear case housing 505 to allow airflow to exit the power tool 500. In an example, a fan diffuser 519 may be further mounted on the front end of the motor housing 502. The fan diffuser 519 may include air outlets formed therein in communication with the fluid with the air openings 537 to allow the air to be guided away through the axial gap 549. In an example, the diffuser 519 may include air outlet geometry to gradually diffuse the exhaust airflow existing the air openings 537 in a forward-facing trajectory.

FIG. 5K depicts an exploded view of a gear assembly 551 including the gear case 504 and the gear case housing 505, FIG. 5L depicts a cross-section view of the gear case 504 along E-E, as depicted in FIG. 5E, and FIG. 5M depicts a cross-section view of the gear assembly 551 on the power tool 500 designated as DET A as detailed in FIG. 5E. The gear assembly 551 includes the gear case housing 505 (including an outer gear housing portion 505L and an outer gear housing portion 505R), the gear case 504, an upper gear bearing 585A, an output bevel gear 574B, a lower gear bearing 585B, an output spindle 572, the light 514, a wheel retainer 552, and the wire 513A.

Referring to FIG. 5L, in an example, the gear case 504 may have a conical external shape with an internal a four-step profile, with each step increasing in size from a top end of the gear case 504 to a bottom end. The steps may include, in order from narrowest at the top to widest at the bottom, a first step 510A, a second step 510B, a third step 510C, and a fourth step 510D.

The stepped profile of the gear case 504 may allow the gear housing portion 505L and the gear housing portion 505R to be coupled together via two top screws 516T received on two sides of the first step 510A (see FIG. 5K). There are additionally two lower screws 516L received below the fourth step 510D of the gear case 504.

Referring to FIG. 5K, the output spindle 572 may also include a stepped profile, including, in order from narrowest at the top to the widest at the bottom, a first step 572A, a second step 572B, a third step 572C, and a fourth step 572D.

Referring to FIGS. 5K and 5M, in an example, during the assembly process, the upper gear bearing 585A may be initially secured into the gear case 504, and the output spindle 572 may be assembled with the lower gear bearing 585B and the output bevel gear 574B before assembling the output spindle 572 into the gear case 504. The fourth step 572D may be configured to couple to the wheel retainer 552 for a die grinder. The third step 572C may be configured to seat an inner race of the lower gear bearing 585B. The second step 572B may be configured to seat the output bevel gear 574B. The first step 572A of the output spindle 572 may be configured to seat an inner race of the upper gear bearing 585A. In an example, the wheel retainer 552 may be secured to a lower end of the output spindle 572 at a conclusion of the assembly process.

Once the output spindle 572 is assembled with the lower gear bearing 585B, the output bevel gear 574B, and the upper gear bearing 585A, the output spindle 572 may be inserted into a central bore of the gear case 504. As shown in FIG. 5M, upon assembling the output spindle 572 into the gear case 504, the first step 510A of the gear case 504 may be configured to seat the upper gear bearing 585A. The second step 510B may provide space for the diameter of the pinion bevel gear 574A. The third step 510C may provide space for the output bevel gear 574B to spin. Finally, the fourth step 510D may provide a seat for an exterior race of the lower gear bearing 585B. The upper gear bearing 585A and the lower gear bearing 585B may rotatably couple the output spindle 572 to the gear case 504.

In an example, the gear case 504 may be formed from metal and the gear case housing 505 may be formed from plastic. In an example, the gear case housing 505 may be a two-portion clamshell-like housing including the outer gear housing portion 505L and the gear housing portion 505R.

In an example, the gear housing portion 505L may include lower screw bosses 516M located below the lower end of the fourth step 510D of the gear case 504 that receive the lower screws 516L, and screw bosses 516N and 516N′ located around the first step 510A of the gear case 504 that receive the top screws 516T. The gear housing portion 505R may include corresponding screw holes that allow passage of the lower screws 516L and the upper screws 516T. In an example, the gear case 504 includes a recessed portion 504C located between the first step 510A and the second annular body 523 to allow passage of the screw boss 516N′ and the corresponding screw 516T.

In an example, the gear case housing 505 may extend below the gear case 504 to support and/or receive the light 514. In an example, the light 514 may be an LED light. In an example, the light 514 may be an LED ring including a plurality of LED lights mounted on a ring-shaped circuit board and encapsulated within a translucent plastic housing and/or an overmold structure mounted around the output spindle 572. The light 514 may be retained within a lower end 505A of the gear case housing 505. Specifically, in an example, the gear case housing 505 may include a lower rib 517A defining its lower end, and an annular recess 517B formed between the lower screw bosses 516M and the lower rib 517A, with the annular recess 517B sized to fixedly support the light 514 therein. In an example, the light 514 may include two or more LEDs that illuminate a grinding surface of a workpiece. The wire 513A may run through the second channel 515B formed between the gear case 504 and the gear case housing 505. The wire 513A may further pass into channel the 515A, which is formed between the motor housing 518 and the tool housing 502 and is aligned with the channel 515B, to couple the wire 513A to the control and power module 511, as described above.

FIG. 5K depicts an exploded view of the spindle lock, FIG. 5N depicts an inside view of the gear housing portion 505R, which includes an opening 563 for a button 594, FIG. 5O depicts a right plan view of the gear case housing 505, and FIG. 5P depicts a cross-section F-F depicted in FIG. 5O of the gear case housing 505.

In examples, the tool 500 may include a spindle lock including the button 594, a spring 595, and a washer 596. In an example, the button 594 may include a pin shaft 594P and a head 594H (see FIG. 5N).

To assemble the spindle lock, the spring 595 and the washer 596 may be threaded onto the pin shaft 594P of button 594, as depicted in FIG. 5N. Next, the button head 594H may be placed on the inside of the opening 563 in the gear housing portion 505R with the pin shaft 594P pointing towards the center of the gear case housing 505. In an example, the head 594H may include one or more tabs 594T. In an example, the opening 563 may include a lip configured to prevent the one or more tabs 594T from passing to the outside of the gear case housing 505 through the opening 563 (see FIG. 5P).

Next, the gear housing portion 505R with the button 594 positioned within the gear housing portion 505R may be mated to the gear housing portion 505L to surround the gear case 504. In an example, the gear case 504 may include an aperture 504B for receiving the pin shaft 594P. The gear housing portion 505L may be coupled to the gear housing portion 505R using, for example, the two top screws 516T and the two lower screws 516L. The washer 596 may provide a seat for the spring 595 adjacent to the aperture 504B. The spring 595 may further be seated against an inner surface of the head 594H to bias the button 594 against the gear housing portion 505R. In an example, the spring 595 may be provided to transmit an evenly distributed bias for an O-ring 597 to provide sealing and prevent grease leakage or environmental contamination.

To operate the spindle lock, a user may press the button 594, overcoming the spring 595 and causing the head 594H to pass into the gear housing portion 505R, which causes the pin shaft 594P to apply pressure to the pinion bevel gear 574A. The pinion bevel gear 574A may include one or more spindle lock recesses 568 (see FIGS. 5F and 5P). When the end of the pin shaft 594P encounters the depression of the spindle lock recess 568, the pin shaft 594P will enter the spindle lock recess 568 and any the spindle rotation will be halted and the output bevel gear 574B will be locked. The pin shaft 594P may engage the spindle lock recess 568 in a position that is slightly rearward of the output spindle 572.

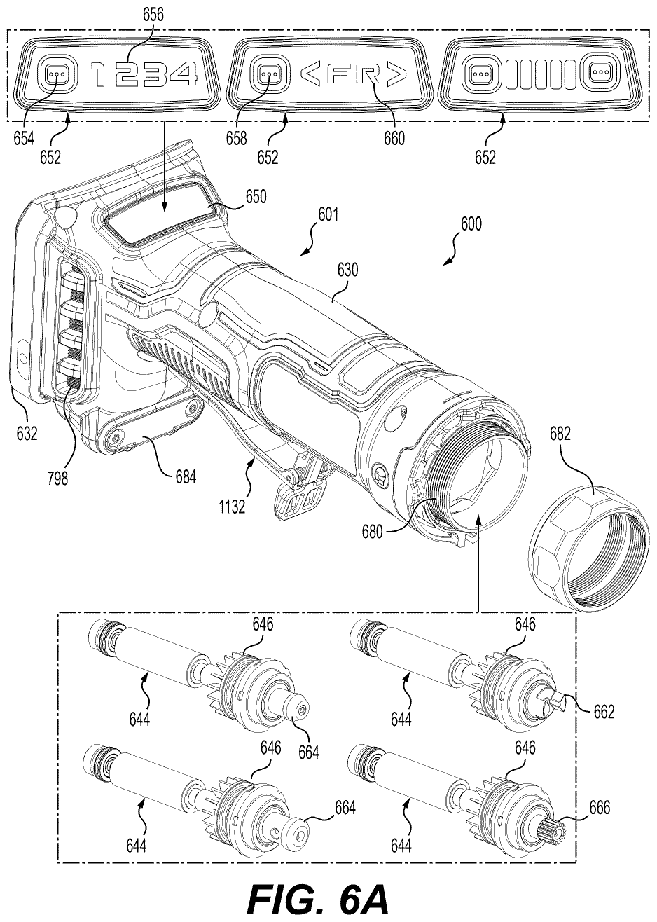

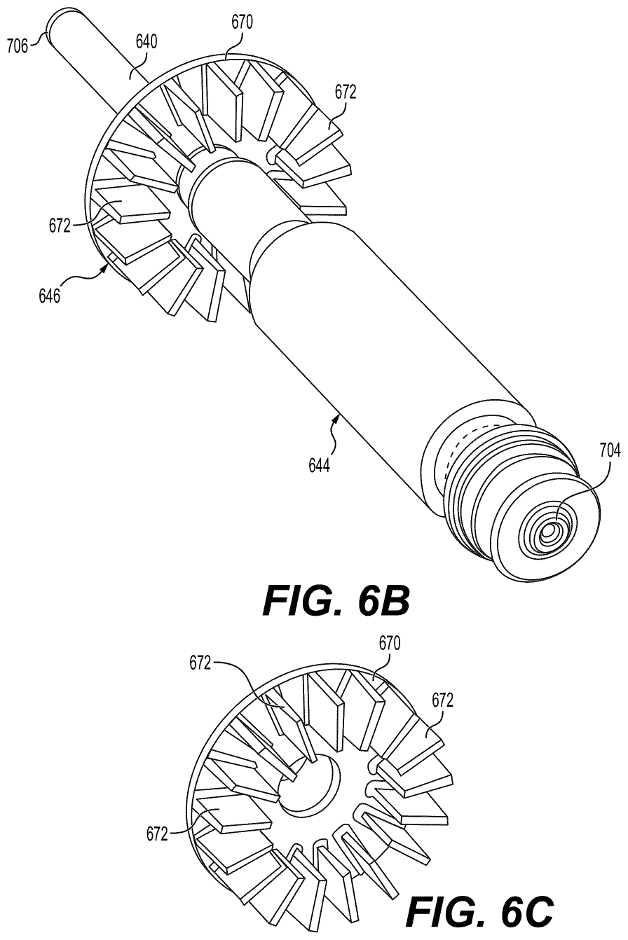

An aspect of the invention is described herein with reference to FIGS. 6A-9 and 22A-28I. Here, a system 600 including a family of power tools 602, 606, 610, 614, 618, 622, 626 is described. In an embodiment, the family of tools 602, 606, 610, 614, 618, 622, 626 is designed to include a back-end assembly 601 that is substantially unchanged across the family, coupled to different front-end assemblies 604, 608, 612, 616, 620, 624, 628 that includes gear cases, output assemblies, transmission assemblies, etc. that are unique to individual tools. With this arrangement, substantially the same or similar components may be utilized in the manufacturing and assembly processes of the power tools to the extent possible to reduce manufacturing cost and complexities, and platform components and resources.

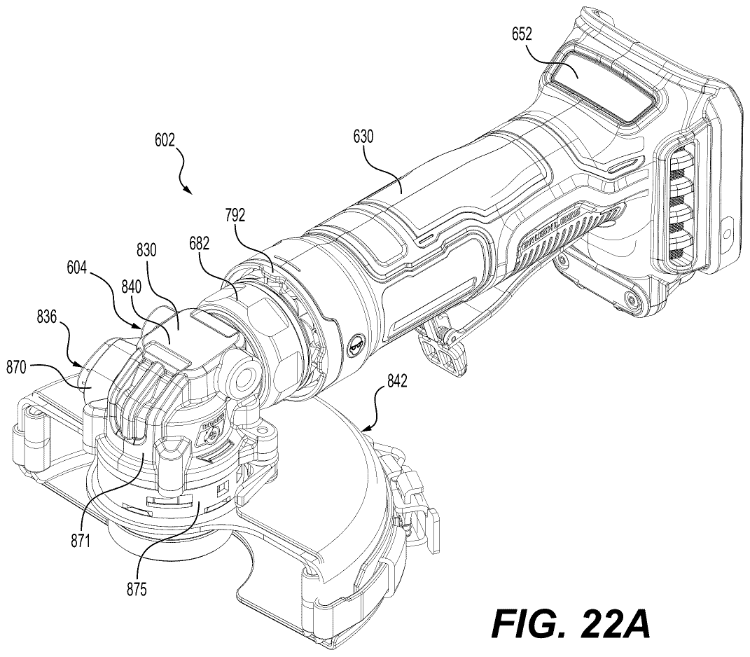

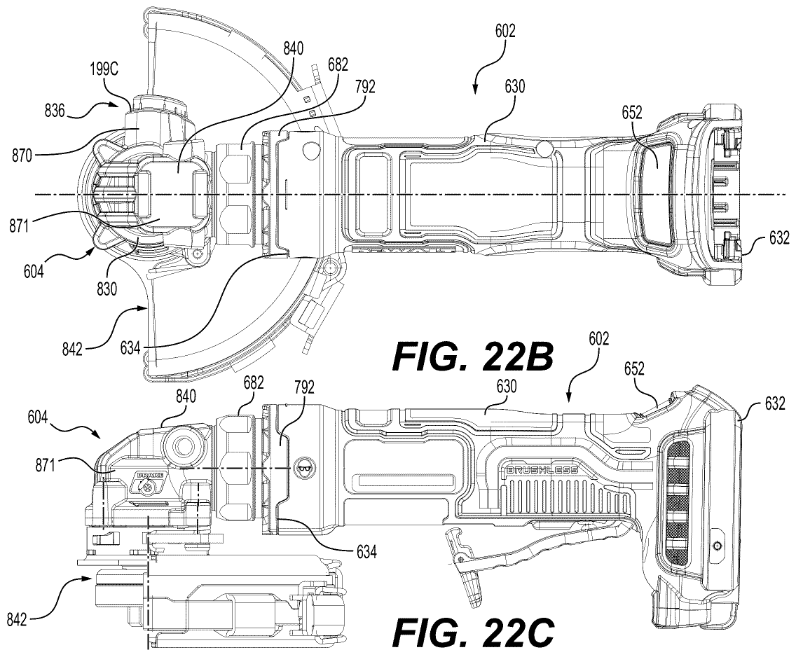

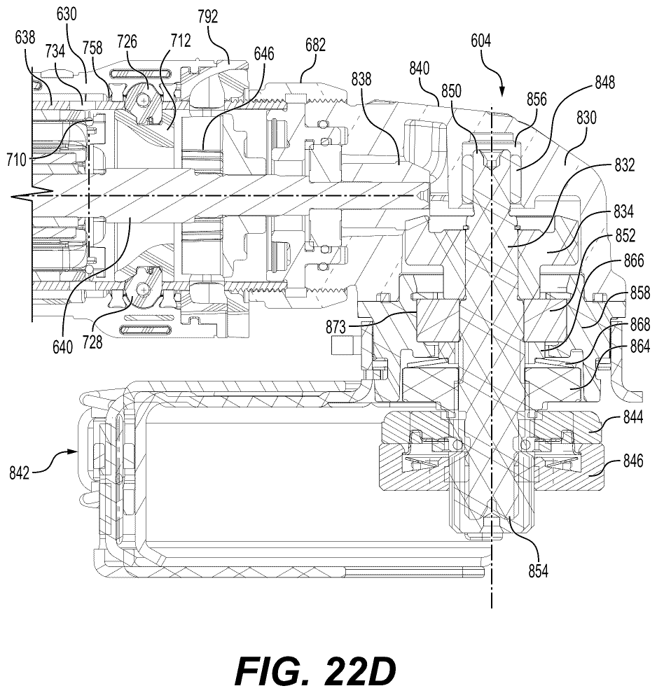

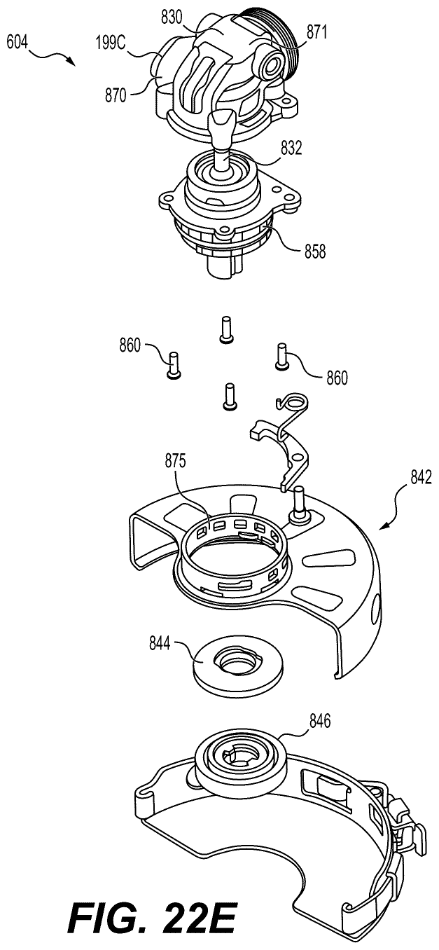

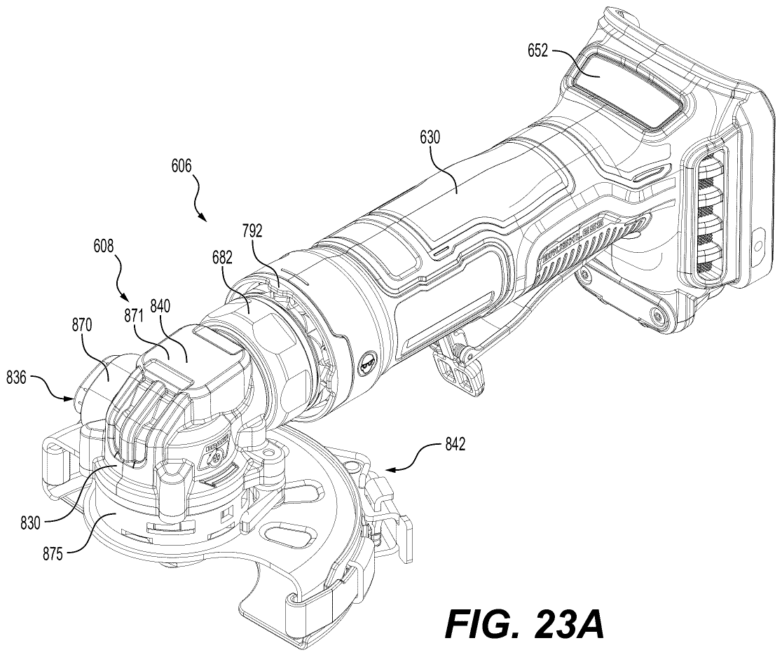

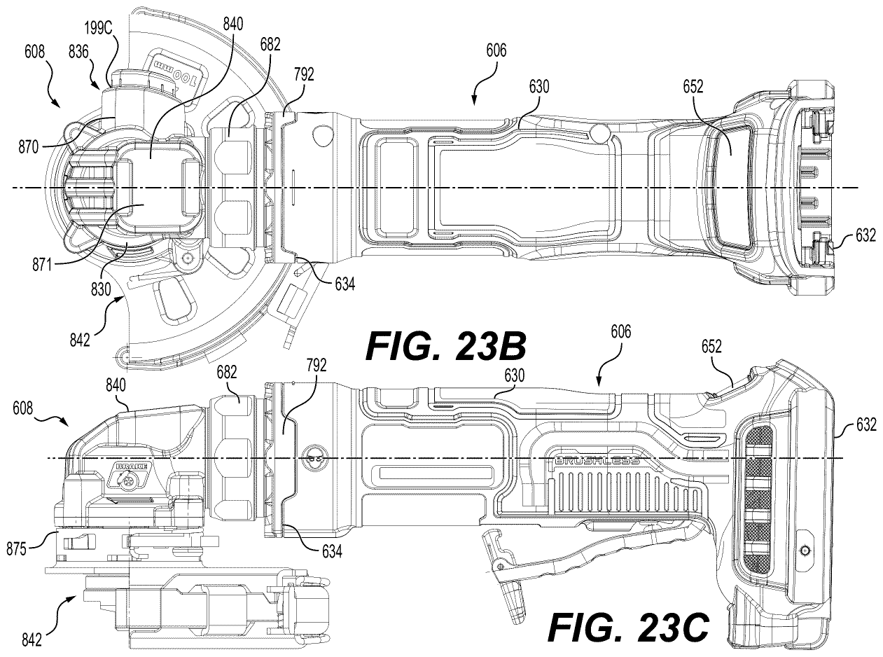

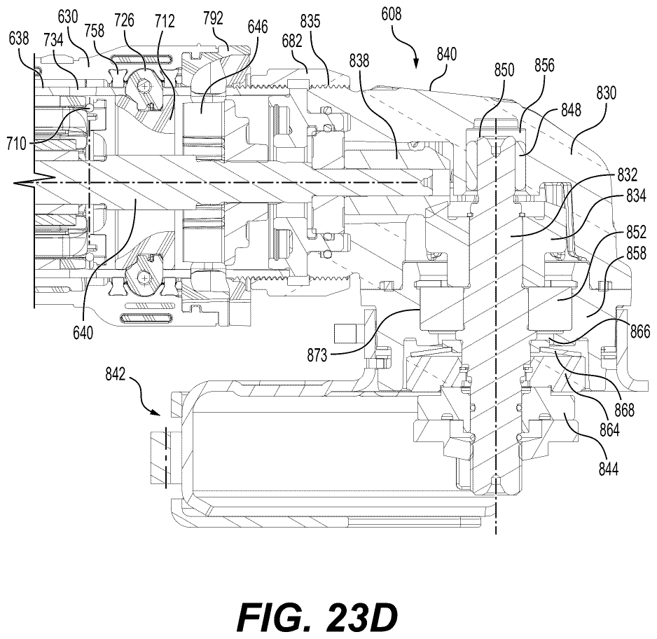

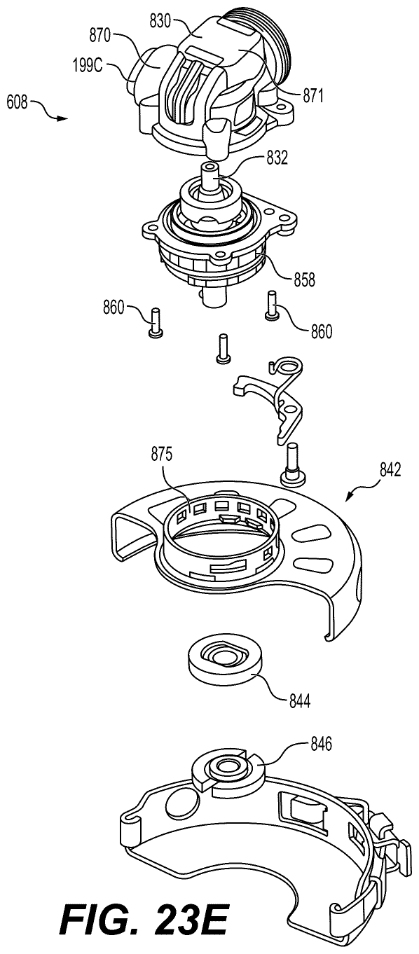

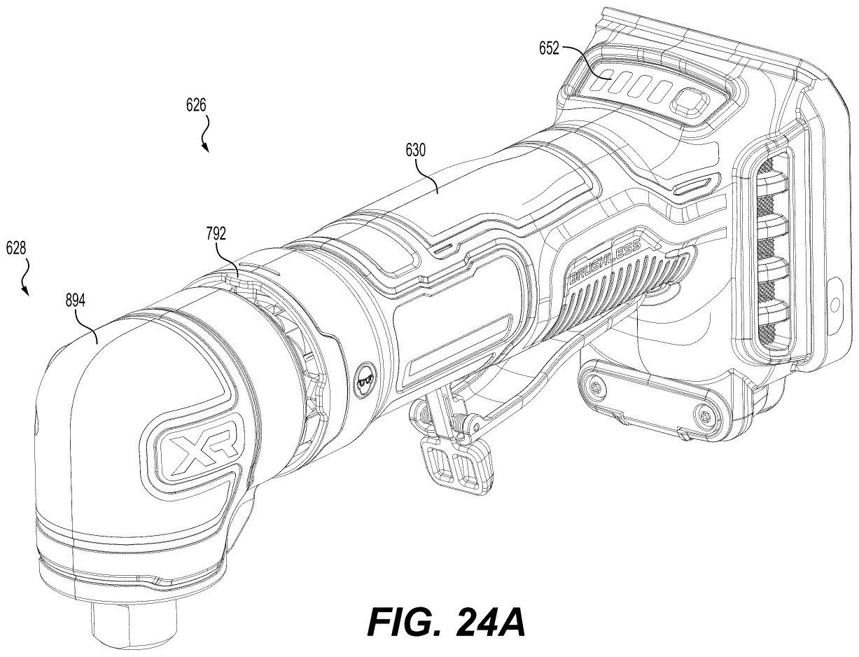

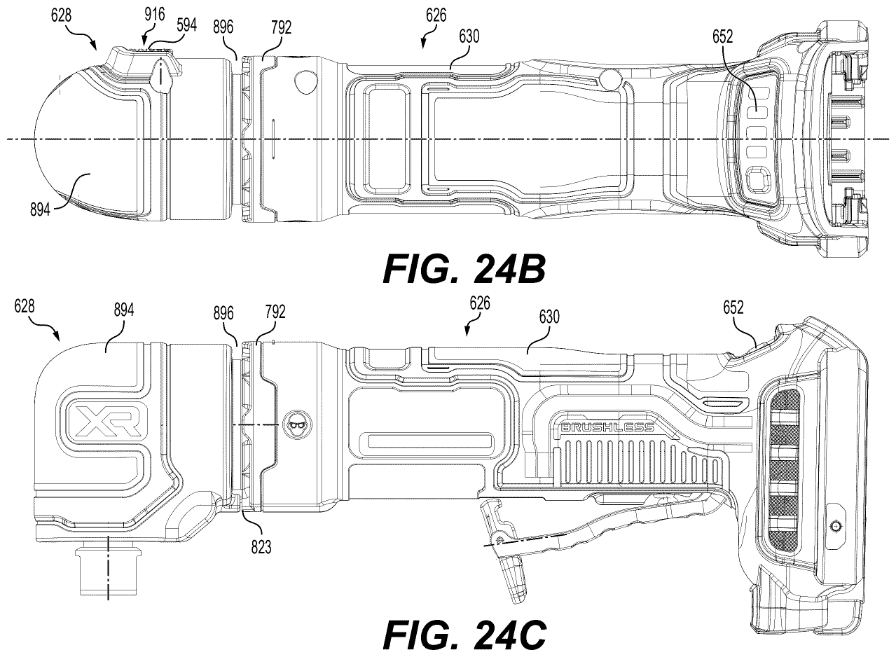

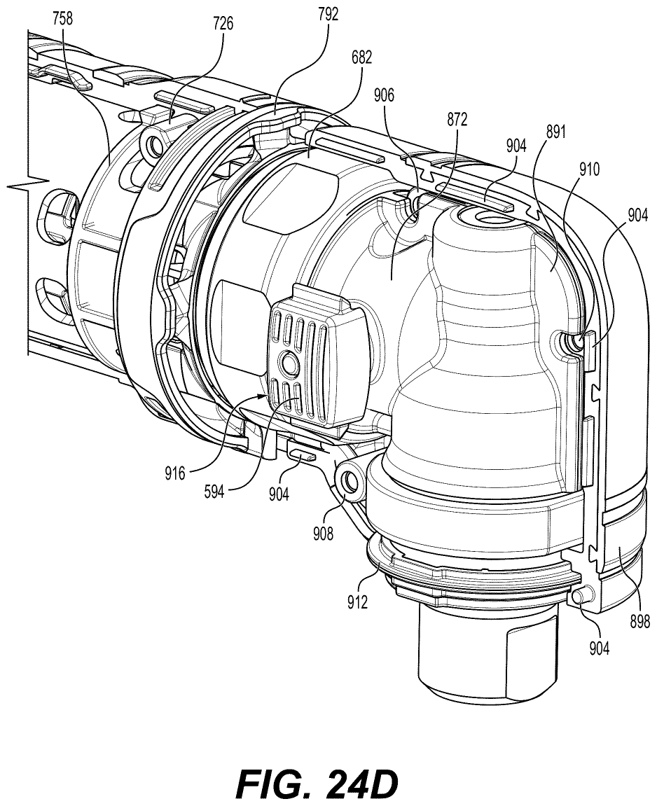

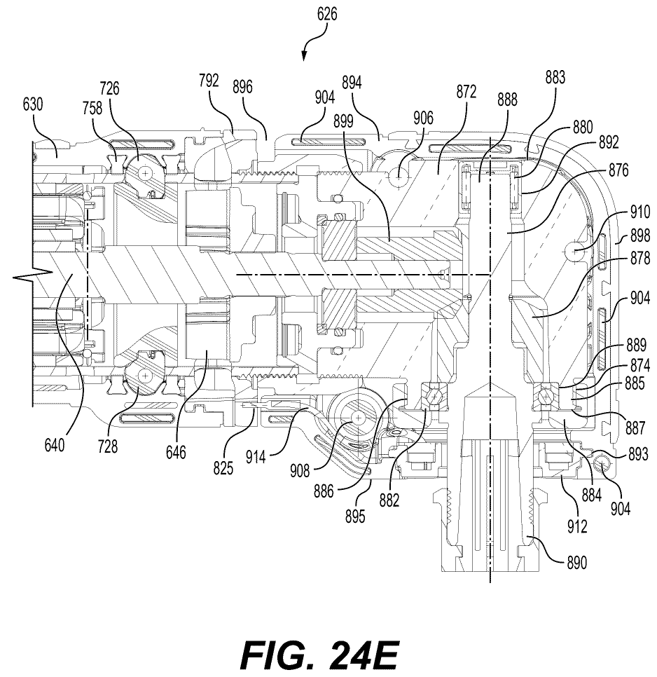

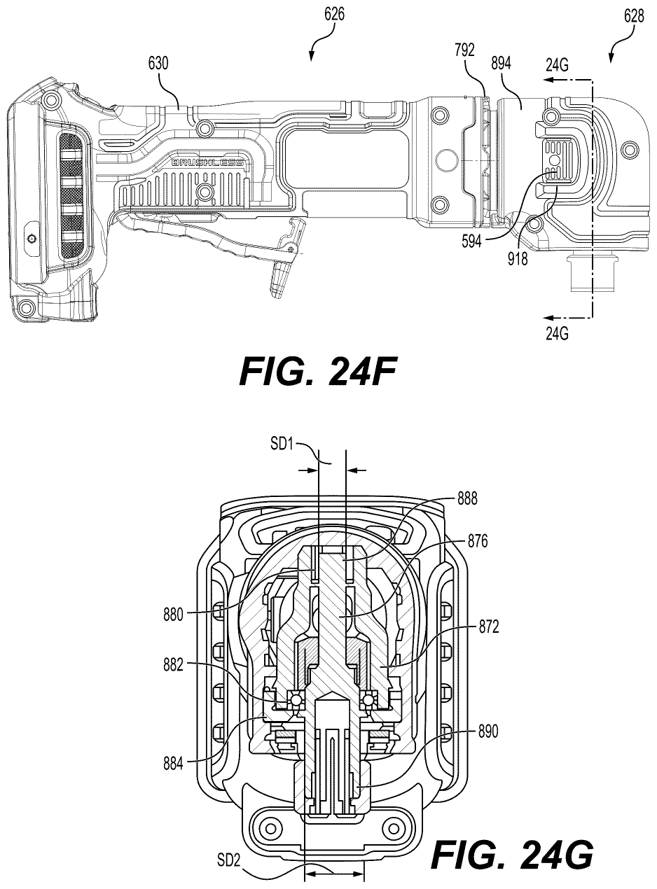

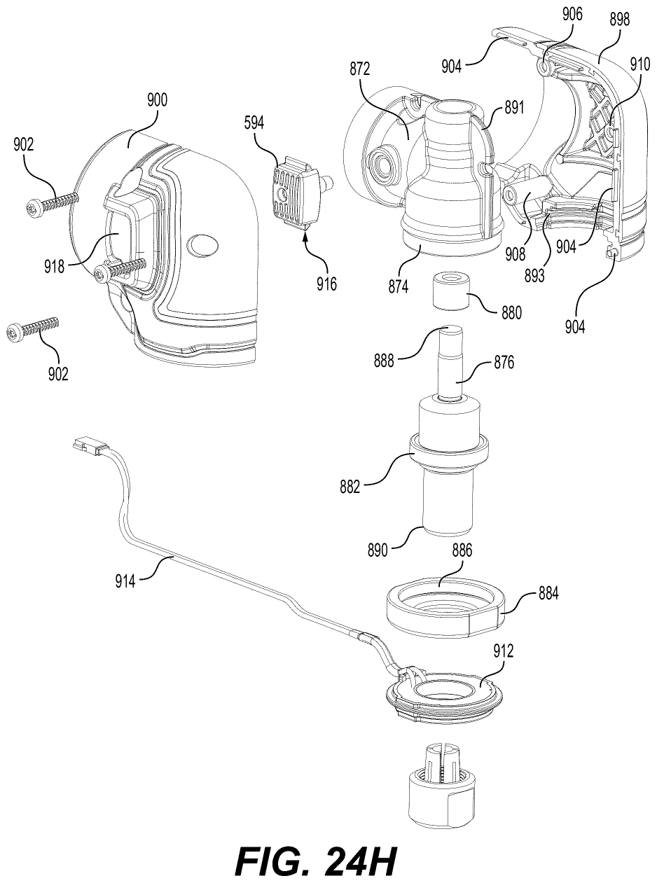

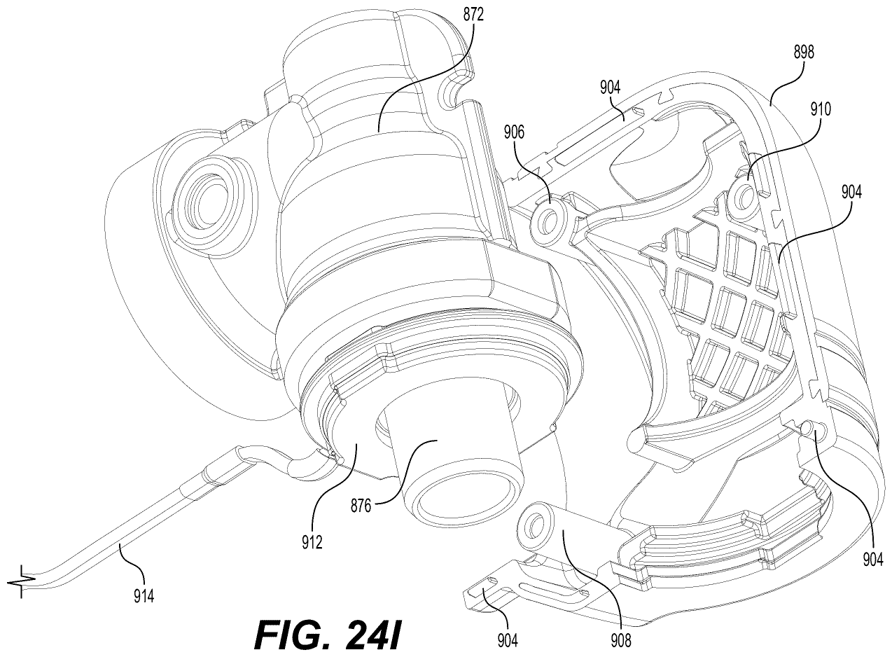

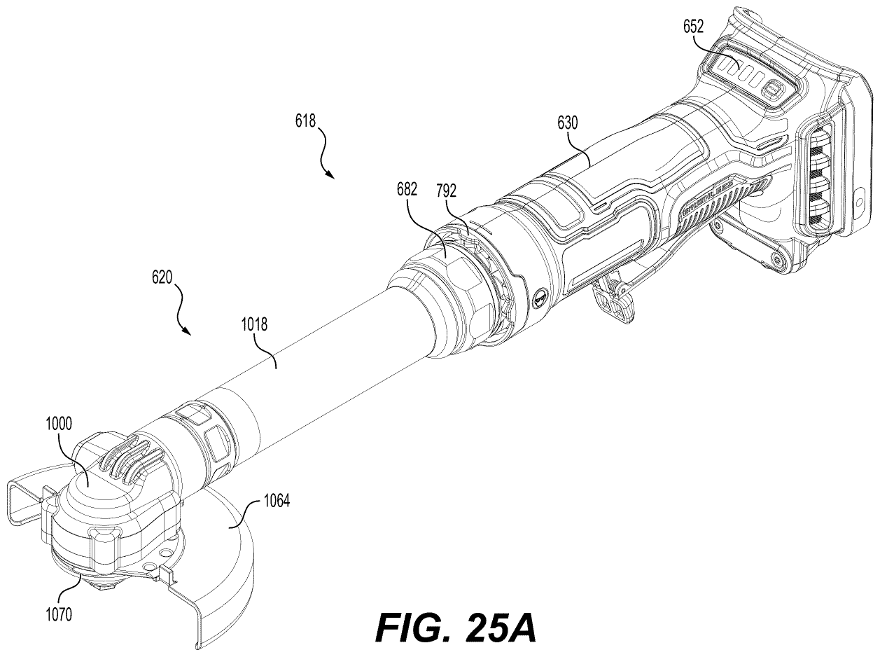

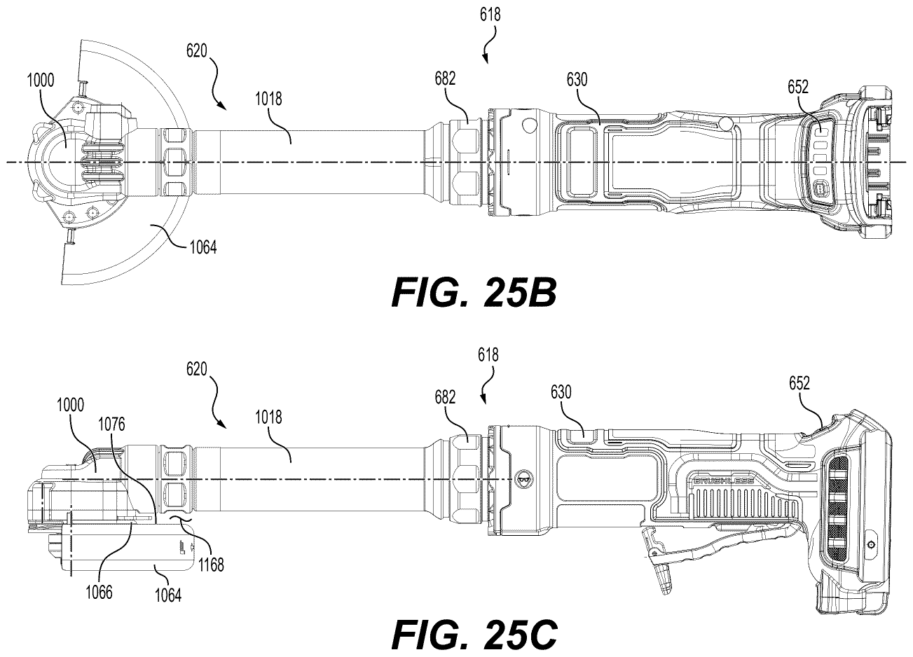

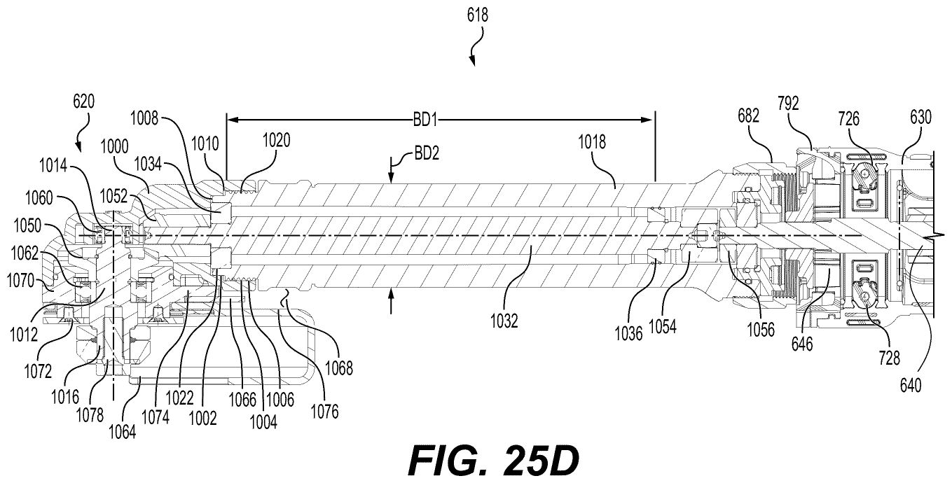

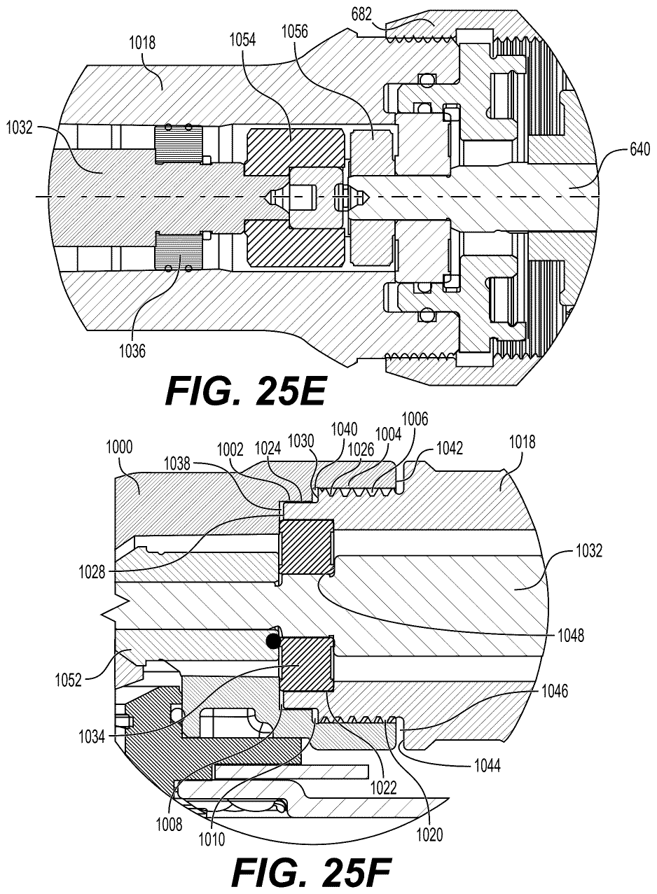

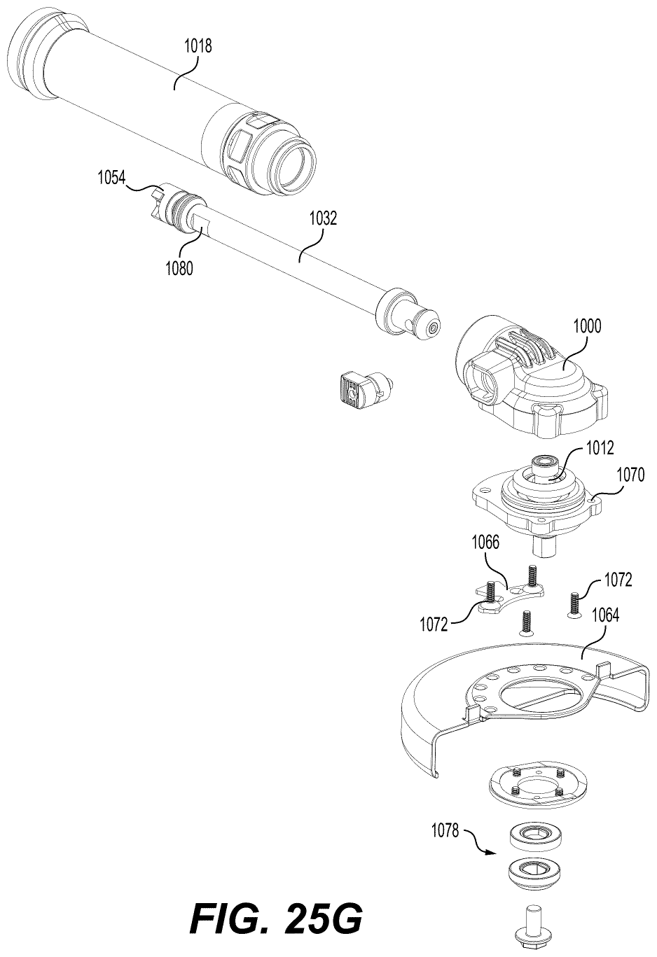

Referring to FIGS. 6A-9 and 22A-28I, the system 600 of tools according to one embodiment is shown. As discussed in more detail below, the system 600 of tools includes one or more power tools 602, 606, 610, 614, 618, 622, 626 with each power tool sharing various components while having different front-end tool assemblies 604, 608, 612, 616, 620, 624, 628 as well as other components that are not shared between the power tools. In an embodiment, the power tools 602, 606, 610, 614, 618, 622, 626 include a 4.5-inch angle grinder 602 (FIGS. 22A-22E), a 4-inch angle grinder 606 (FIGS. 23A-23E), a die grinder 610 (FIGS. 24A-24G), an extended die grinder 614 (FIGS. 25A-25E), an extended cut-off tool 618 (FIGS. 26A-26G), a cut-off tool 622 (FIGS. 27A-27D), and an angle die grinder 626 (FIGS. 28A-28I), although other tools and front-end tool assemblies may be utilized with the system. Such tools may include, but are not limited to, wrenches, fasteners, drilling tools, impact tools, percussive tools, electrical and/or mechanical tools such shears and nibblers, etc. The system 600 is configured to provide a base tool platform having shared components for the various power tools thereby reducing cost and manufacturing complexity.

In an embodiment, the back-end assembly 601 includes a tool housing 630 that has substantially identical geometry and construction across all the power tools 602, 606, 610, 614, 618, 622, 626, including substantially the same length, diameter, ergonomics, etc.

In an embodiment, the tool housing 630 of each power tool 602, 606, 610, 614, 618, 622, 626 includes a battery receptacle 629 located at a first end thereof 632 for receiving a removeable battery pack. The battery pack may include a plurality of lithium-based battery cells arranged in series and/or parallel configurations. Examples of such battery packs may be found, for example, in U.S. Pat. No. 11,569,541, which is incorporated herein by reference in its entirety, and which discloses a sliding battery pack including a multiple pouch cell. The battery pack may alternatively include cylindrical battery cells, an example of which may be found in U.S. Pat. No. 7,944,174, which is also incorporated herein by reference in its entirety. In an embodiment, the battery pack may be coupled to the battery receptacle 629 along a receiving axis that is substantially perpendicular to a longitudinal axis of the tool housing.

In an embodiment, the tool housing 630 of each power tool 602, 606, 610, 614, 618, 622, 626 includes a handle portion having a first section 1152 that houses an electric motor 636, a second section 1154 located forward of the first section 1152 that is located around a motor fan 646 that is coupled to the motor 636, a handle section 1156 that extends rearwardly from the first section 1152 and houses an electronic switch 1130 therein, and a foot section 1158 that extends rearwardly from the handle section 1156 and forms the battery receptacle 629. The geometry and construction of all these sections 1152, 1154, 1156, 1158 are substantially identical across the family of power tools 602, 606, 610, 614, 618, 622, 626.

In an embodiment, the tool housing 630 of each power tool 602, 606, 610, 614, 618, 622, 626 forms a peripheral switch opening 650, which will be discussed later in detail, in the foot section 1158. In particular, the foot section 1158 of the tool housing 630 includes a sloped surface 631 that extends from a top of a rear end of the handle section 1156 to an opening 633 of the battery receptacle 629 through which the battery pack is received. Referring to FIG. 6A, one of the power tools 602, 606, 610, 614, 618, 622, 626 may include a first peripheral switch 652 and one of the other power tools may include a second peripheral switch 652, with the first peripheral switch including a switch 654 and a speed display 656 and the second peripheral switch 652 including a switch 658 and a rotation direction display 660. One of the power tools 602, 606, 610, 614, 618, 622, 626 may also include a third peripheral switch 652 having a plurality of switches 654, 658 and a plurality of display options. The peripheral switch 652 is discussed in more detail below. In an embodiment, the peripheral switch opening has an identical geometry across the family of power tools, although a peripheral switch disposed within the peripheral switch opening 650 may be custom selected in accordance with the power tool characteristics. For example, a die grinder may include a peripheral switch that includes a speed-select interface, while a cut-off tool may include a peripheral switch that includes a forward-reverse interface.

In an embodiment, the tool housing 630 of each power tool 602, 606, 610, 614, 618, 622, 626 houses a motor control module 625 within the foot section 1158. In an embodiment, the motor control module 625 may include a controller and a multi-phase inverter switch circuit that regulates the supply of electric power from the battery pack to the electric motor. An example of the motor control module 625 may be found, for example, in US Patent Publication No. 2022/0247280, which is incorporated herein by reference in its entirety. In an embodiment, the motor control module 625, including its size, geometry, and components, as well as the internal geometry of the foot section 1158 of the tool housing 630 that engages and supports the motor control module 625, are substantially identical across the family of power tools 602, 606, 610, 614, 618, 622, 626.

In an embodiment, while the motor control module 625 includes substantially the same size, geometry, and components across the family of power tools, it may be configured to execute control programs to control the operation of the motor 636 differently based on the power tool. For example, the motor control module 625 may be configured to set a speed threshold according to an input from the speed-select interface in tools such as a die grinder, or control the rotation of the motor 636 in a forward or reverse direction according to an input from the forward-reverse interface.

In an embodiment, the motor control module 625 may be further configured to control a current limit applied to the power drawn from the battery pack in a dynamic fashion in order to prevent sudden heating of the motor 636 and the associated components. Specifically, in an embodiment, the motor control module 625 may be configured to apply a current limit to the instantaneous measure of current being drawn from the battery on a cycle-by-cycle basis in order to maintain an average current drawn from the battery at a level that is substantially close to the current limit. In other words, the average current is “clipped” at approximately the current threshold level. In an embodiment, the motor control module 625 is further configured to dynamically lower the current limit as the number of events where the instantaneous current exceeds the current limit increases. In other words, as the user engages in operations that require higher current draw, the current limit is gradually reduced to give the motor 636 a break and provide feedback to the user to ease off the motor operation. An example of this feature may be found, for example, in U.S. patent application Ser. No. 18/767,091, filed Jul. 9, 2024, titled “VARIABLE CURRENT CLIP CONTROL IN POWER TOOL,” which is incorporated herein by reference in its entirety. In some embodiments, application of this variable current limit (i.e., current clip) technique allows the motor 6363 to operate more efficiently and at a higher continuous (sustained) power, while preventing sudden rises in the temperature of the motor 636 due to high currents. In an embodiment, this control configuration, combined with the motor cooling and airflow features described later in this disclosure, allow the motor 636 to operate at high continuous and sustained power output levels (e.g., continuous power output of greater than or equal to approximately 520 watts out) while maintaining the motor temperature at acceptable levels (e.g., less than or equal to 150 degrees C. as measures at the motor windings).

In an embodiment, the tool housing 630 of each power tool 602, 606, 610, 614, 618, 622, 626 includes a pocket 686 formed at a bottom portion of the foot section 1158, opposite the peripheral switch opening 650 and proximate a terminal block 635 of the battery receptacle 629. In an embodiment, the pocket 686 defines an opening that faces away from the battery receptacle 692. The pocket 686, as will be discussed later in detail, is designed to removably receive an audit chip 684 for wireless tracking of the power tool. Alternatively, in some embodiments, the pocket 686 may be provided an internal support structure for removably receiving a secondary power supply (e.g., a coin cell) and with wires for routing the secondary power supply to an internal wireless communication device located within the tool housing. In an embodiment, while the wire and the internal support structure of the pocket 686 may be designed in accordance with the power tool, the geometry and orientation of the pocket are substantially identical across the family of power tools 602, 606, 610, 614, 618, 622, 626.

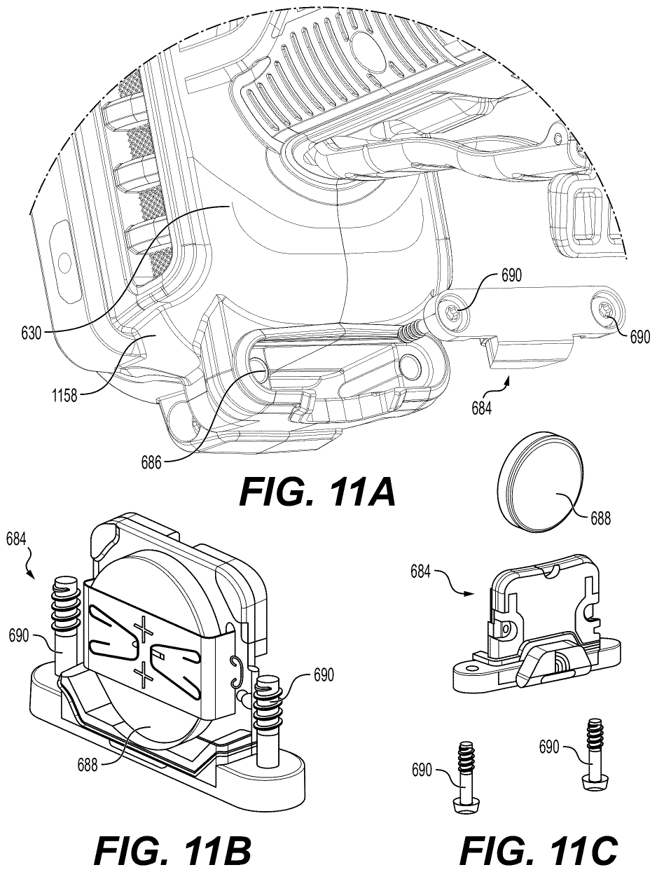

Referring to FIGS. 11A-11C, in an embodiment, each of the power tools 602, 606, 610, 614, 618, 622, 626 may include an audit chip 684 received within the pocket 686 defined by the tool housing 630. The audit chip 684 includes a wireless communication device and an antenna that periodically transmits a beacon signal including a unique ID, which can be used to detect a position of the audit chip 684. The audit chip 684 further includes coin cell 688 for powering the wireless communication device, and it is secured within the pocket 686 via screws 690, although other suitable securing arrangements and power sources may be utilized. In an embodiment, the audit chip 684 is a TOOL CONNECT™ commercially available from Stanley Black & Decker, Inc. and compatible with the TOOL CONNECT™ system and related software for managing jobsite inventory and tracking for power tools and other products. The audit chip 684 is configured to provide wireless tracking capabilities, such as through Bluetooth wireless communication. In an embodiment, the audit chip 684 and coin cell 688 are oriented in parallel to a lower end wall of the foot section 1158, perpendicular to lateral side walls 637 of the foot section 1158. In an embodiment, a receiving axis of the audit chip 684 is substantially parallel to the longitudinal axis of the tool housing.

Referring to FIGS. 6A-10D, in an embodiment, the tool housing 630 further includes intake openings 798 located at lateral side walls 637 of the foot section 1158 proximate guide rails of the battery receptacle 629. The intake openings 798 provide entryway for airflow generated by the motor fan 646 into the tool housing 630. In an embodiment, the location and structure of the intake openings 798 are substantially identical across the family of power tools 602, 606, 610, 614, 618, 622, 626.

In an embodiment, the tool housing 630 of each power tool 602, 606, 610, 614, 618, 622, 626 further includes internal ribs 639 for locating and housing the electronic switch 1130 within the handle section 1156. The electronic switch 1130, in an embodiment, may be an electronic contact switch configured to activate upon engagement of a push-button 641. This engagement generates an ON signal that is sent to the motor control module 625 and causes it to begin energization of the motor 636. In an embodiment, the electronic switch 1130 may further include variable-speed capabilities, where a variable-speed signal is generated corresponding to the travel distance of the button 641 and provided to the motor control module 625. In an embodiment, the electronic switch 1130 may be a compact variable-speed switch constructed using conductive elastomer material, examples of which may be found in U.S. Patent Publication No. 2022/0376584 and U.S. Patent Publication No. 2024/0347290, both of which are incorporated herein by reference in their entireties. In an embodiment, the design, construction, and geometry of the electronic switch 1130, as well as the geometry of the internal ribs 639 of the tool housing 630 that position and support the electronic switch 1130, are substantially identical across the family of power tools 602, 606, 610, 614, 618, 622, 626. In an embodiment, where a given power tool is designed to operate at fixed speeds, i.e., where the variable-speed function of the electronic switch 1130 is not utilized by the power tool, the motor control module 625 is configured to activate upon initial engagement of the button 641, but to ignore the variable-speed signal received from the electronic switch 1130.

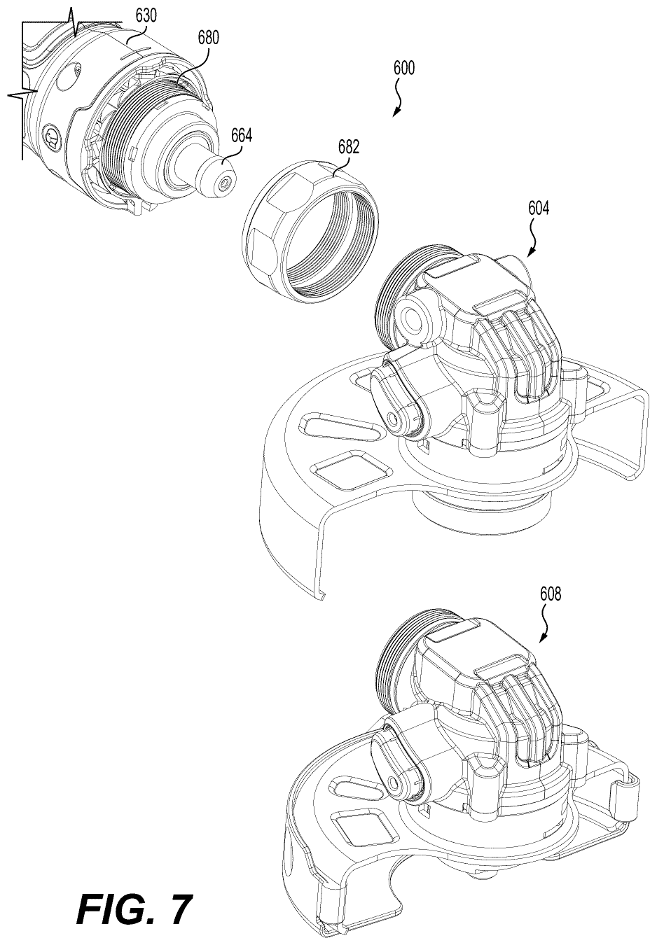

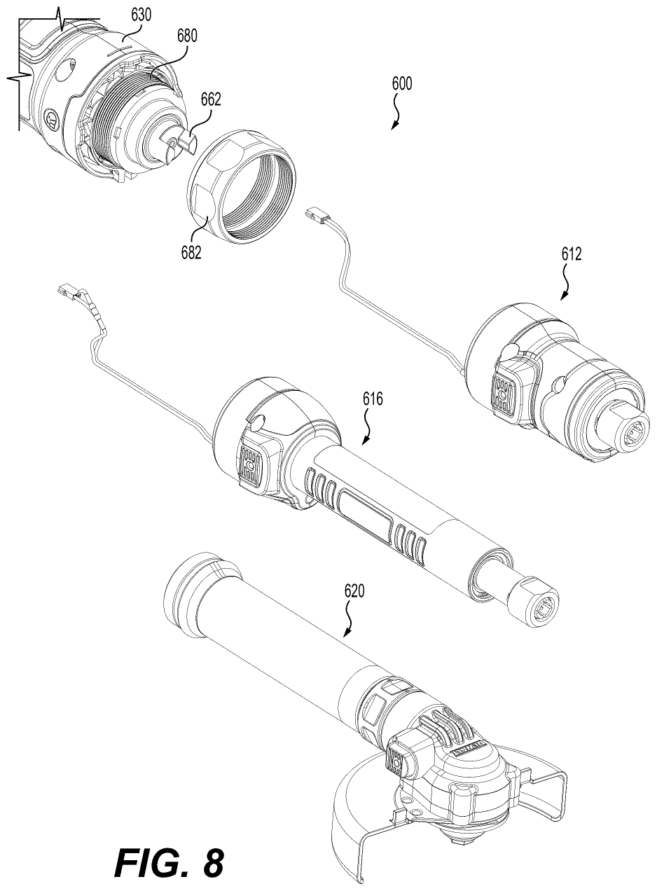

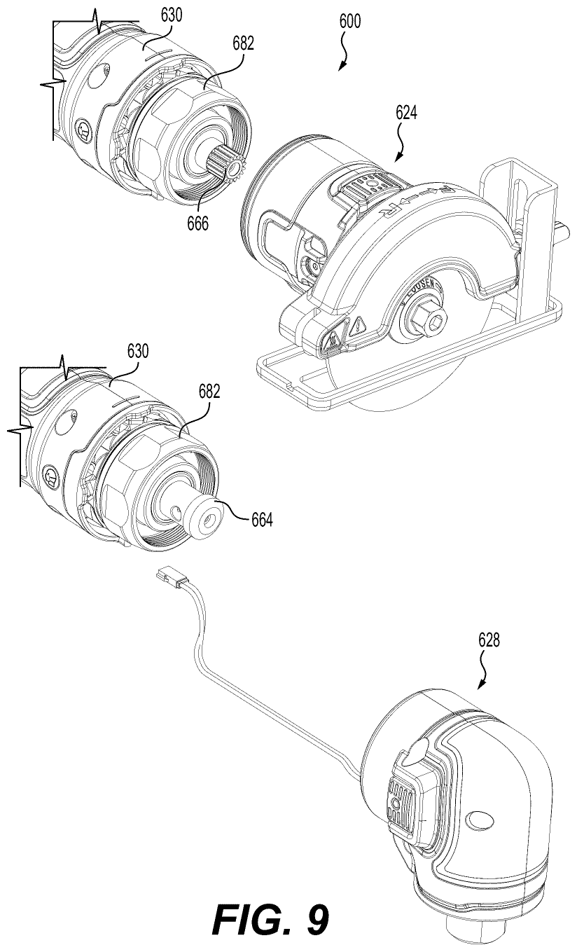

Referring to FIGS. 6A-10D, in an embodiment, the system 600 includes a first power tool, such as one of the power tools 602, 606, 610, 614, 618, 622, 626, and a second power tool, such as one of the other power tools 602, 606, 610, 614, 618, 622, 626. The first tool includes a first tool housing 630 having a first end 632 and a second end 634 positioned opposite the first end 632, a first motor 636 at least partially received within the first tool housing 630, and a first front-end tool assembly 602, 606, 610, 614, 618, 622, 626. Further, the first tool includes the motor control module 625, the electronic switch 1130, the peripheral switch 652, and other components described above. The first motor 636 includes a motor housing 638, a motor shaft 640 that extends longitudinally through the motor housing 638, a stator assembly 642 mounted fixedly within the motor housing 638, a rotor assembly mounted on the motor shaft 640 shaft that is rotatable relative to the stator assembly 642, and a motor fan 646 mounted on the motor shaft 640. The motor shaft 640, the stator assembly 642, the rotor assembly 644, and the motor fan 646 are at least partially received within the motor housing 638 of the first motor 636. The second power tool 602, 606, 610, 614, 618, 622, 626 includes a second tool housing 630 having a first end 632 and a second end 634 positioned opposite the first end 632, a second motor 636 at least partially received within the second tool housing 630, and a second-front end tool assembly 604, 608, 612, 616, 620, 624, 628. Further, the second tool includes the motor control module 625, the electronic switch 1130, the peripheral switch 652, and other components described above. The second motor 636 includes a motor housing 638, a motor shaft 640, a stator assembly 642, a rotor assembly 644, and a motor fan 646. The motor shaft 640, the stator assembly 642, the rotor assembly 644, and the motor fan 646 are at least partially received within the motor housing 638 of the second motor 636. The first front-end tool assembly 604, 608, 612, 616, 620, 624, 628 is different than the second front-end tool assembly 604, 608, 612, 616, 620, 624, 628. For example, the first front end tool assembly may be the front-end tool assembly 604, 608 associated with one of the power tools 602, 606 shown in FIG. 7 and the second front-end tool assembly may be the front-end tool assembly 612, 616, 620, 624, 628 associated with one of the power tools 610, 614, 618, 622, 626 shown in FIGS. 8 and 9. The first tool housing 630, the motor housing 638 of the first motor 636, and the motor fan 646 of the first motor 636 are identical in size and shape to the second tool housing 630, the motor housing 638 of the second motor 636, and the motor fan 646 of the second motor 636

In an embodiment, the motor 636 is a brushless direct-current (BLDC) motor, and in an embodiment, an inner-rotor BLDC motor. In an embodiment, the rotor assembly 644 includes a rotor core (which may be a steel lamination stack) mounted on a motor shaft 640, and a plurality of magnets mounted on the rotor core. In an embodiment, the stator assembly 642 includes a stator core 643 that is made up on a steel lamination stack forming a series of stator teeth, a series of stator windings (coils) 708 wound around the stator teeth in magnetic interaction with the plurality of magnets, and two end insulators mounted on two ends of the stator to insulate the stator core from the stator windings. In an embodiment, a rear end insulator (i.e., a routing insulator) supports a plurality of stator terminals that are electrically coupled to the stator windings. Further, in an embodiment, a circuit board is mounted to the routing insulator in contact with the plurality of stator terminals to supply electric power to the stator windings. A rear bearing support structure is mounted within the routing insulator to support the rear bearing 561 of the rotor assembly 644. An example of the motor 636, including the above-mentioned components of the motor 636, may be found in U.S. Pat. No. 11,955,863, and U.S. application Ser. No. 18/969,902 filed Dec. 5, 2024, both of which are incorporated herein by reference in their entireties. The motor 636 includes the front bearing 534, as previously described, and is supported by a bearing retainer 536 mounted on a front end of the motor housing 638. The motor fan 646 is mounted on the motor shaft 640 proximate the front end of the motor housing 638 to generate an airflow through the motor housing 638.

In an embodiment, the motor 636 has a substantially identical geometry and construction across all the power tools 602, 606, 610, 614, 618, 622, 626. In particular, the stator assembly structure and geometric features, including the stator core diameter and stack length, the number of stator teeth, the end insulator structure and geometry, stator terminals, etc. are identical across the family of power tools 602, 606, 610, 614, 618, 622, 626. Similarly, the rotor geometry, including the diameter and length of the rotor core, the number and size of the magnets, are identical across the family of power tools. In addition, the location of the bearings, thickness and structure of the motor shaft 640 as it passes through the stator, the geometry and structure of the rear bearing support structure and the front bearing retainer 536, and the size and geometry of the motor fan 646, are identical across the family of power tools 602, 606, 610, 614, 618, 622, 626. In an embodiment, the grade of the rotor magnets, the stator winding pattern, wire gauge, and the number of turns, may be custom selected based on the power tool speed and torque output requirements. For example, a tool that has a relatively high operating speed may utilize a different wire gauge and number of turns than a tool that has a relatively high operating torque. In addition, in an embodiment, the size and geometry of the front end of the motor shaft 640 may vary and may be provided with different front output mechanisms depending on the front-end assembly 604, 608, 612, 616, 620, 624, 630.

Referring to FIGS. 6B and 6C, in an embodiment, the motor fan 646 includes an annular fan body 670 with a plurality of fan blades 672 extending from the annular body 670. Each of the fan blades 672 extends from an outer circumference of the annular fan body 670 toward a center of the annular body 670. Each of the fan blades 672 may extend to a mid-point between the outer circumference of the annular fan body 670 and the center of the annular body 670. The motor fan 646 is configured to be bi-directional. In some power tools, such as the angle grinders and the die grinders, the motor 636 is configured to rotate in a single direction, whereas in some power tools such as the cut-off tools, the motor 636 is configured to rotate in both directions. However, the geometry and structure of the motor fan 646, and the associated airflow guidance and expulsion geometry (including but not limited to, fan baffle, intake and exhaust openings, diffuser, etc. discussed later in detail), are substantially identical across the family of power tools 602, 606, 610, 614, 618, 622, 626 and are designed for optimized airflow through the motor 636 for maximum cooling in either a unidirectional or a bidirectional fan configuration. In some power tools, such as the angle grinders and the die grinders, the motor 636 is configured to rotate in a single direction, whereas in some power tools such as the cut-off tools, the motor 636 is configured to rotate in both directions. However, the geometry and structure of the motor fan 646, and the associated airflow guidance and expulsion geometry (including but not limited to, fan baffle, intake and exhaust openings, diffuser, etc. discussed later in detail), are substantially identical across the family of power tools 602, 606, 610, 614, 618, 622, 626 and are designed for optimized airflow through the motor 636 for maximum cooling in either a unidirectional or a bidirectional fan configuration.

Referring to FIGS. 6A-9, in an embodiment, the motor housing 638 of each of the power tools 602, 606, 610, 614, 618, 622, 626 includes a first end 676 and a second end 678 positioned opposite the first end 676, with the motor housing 638 including a threaded portion 680 at the second end 678 of the motor housing 638. The first end 676 projects axially forward of a front end of the tool housing 630 so as to expose the threaded portion 680. Each power tool 602, 606, 610, 614, 618, 622, 626 includes a collar 682 engaged with the threaded portion 680 and the respective front-end tool assemblies 604, 608, 612, 616, 620, 624, 628. The collar 682 is configured to secure the motor housing 638 to the respective front-end tool assembly 604, 608, 612, 616, 620, 624, 628 for each of the power tools 602, 606, 610, 614, 618, 622, 626. The collar 682 may be the same or similar to the collars 106, 506 discussed above. Similarly, the threaded portion 680 may be the same or similar to threaded portion 520 previously discussed with reference to FIGS. 5A-5J. In an embodiment, the bearing retainer 536 is mounted forward of the threaded portion 530 to support the front motor bearing 534 of the motor shaft 640. In an embodiment, the geometry and configuration of the motor housing 638 and the threaded portion 680 relative to the tool housing 630, the collar 682, the front motor bearing 534, and the bearing retainer 536, are substantially identical across the family of power tools. Further, in all the power tools, the output mechanism (i.e., coupling 662, bevel gear or pinion 664, or sun gear 666) is mounted on the front end of the motor shaft 640 proximate and abutting the front motor bearing 534. However, in an embodiment, the selection of the output mechanism is tool-dependent based on angular and/or linear orientation, a gear arrangement, of the front-end assembly.

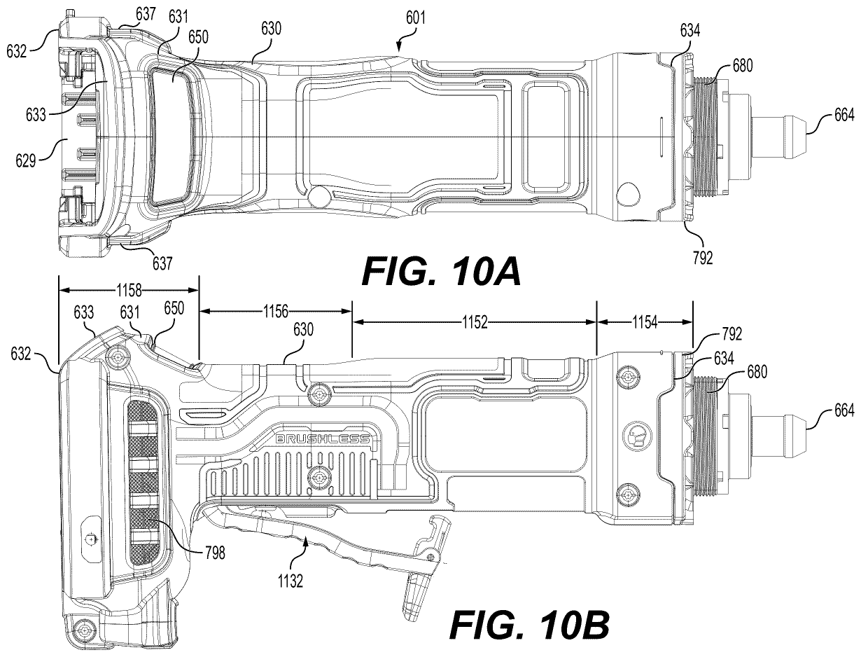

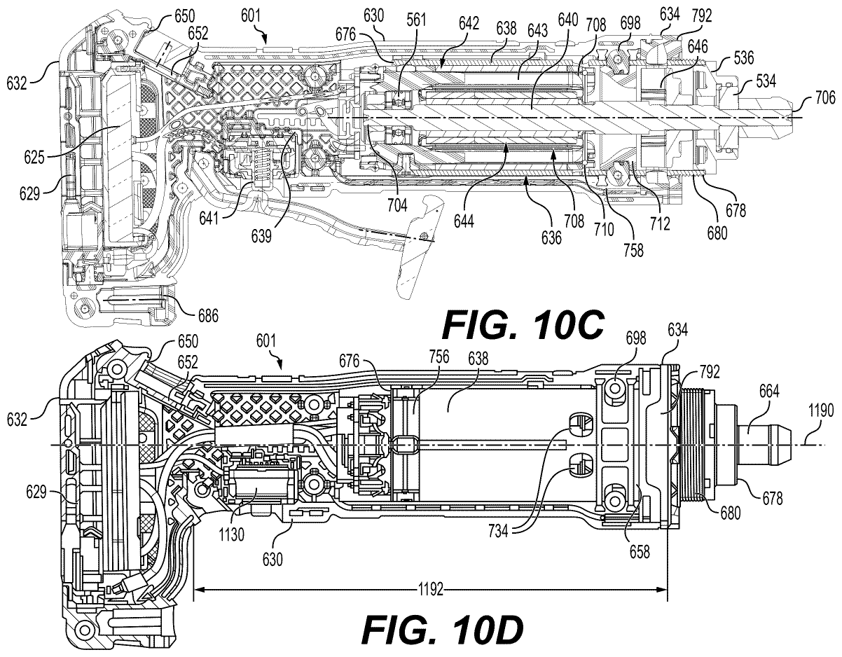

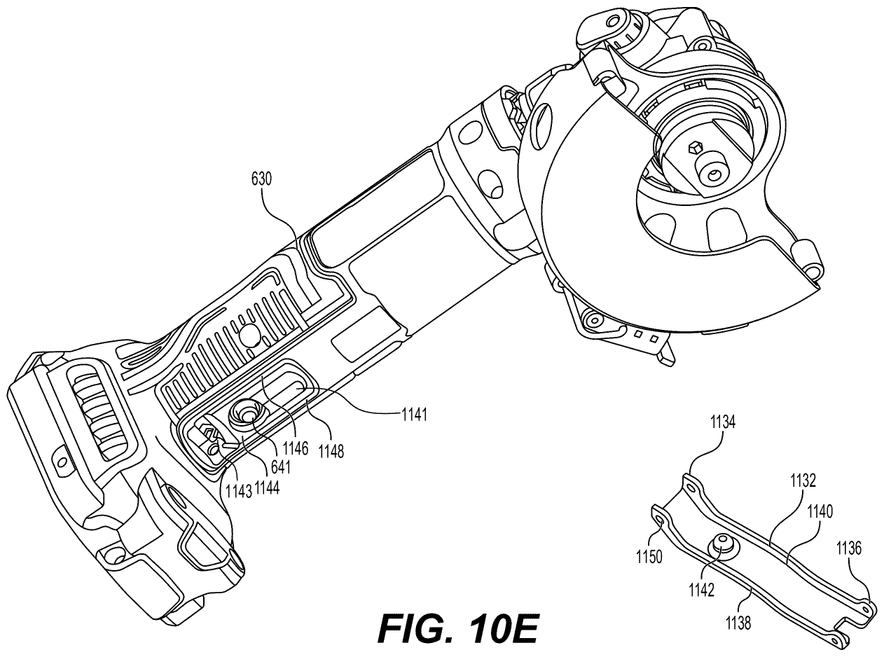

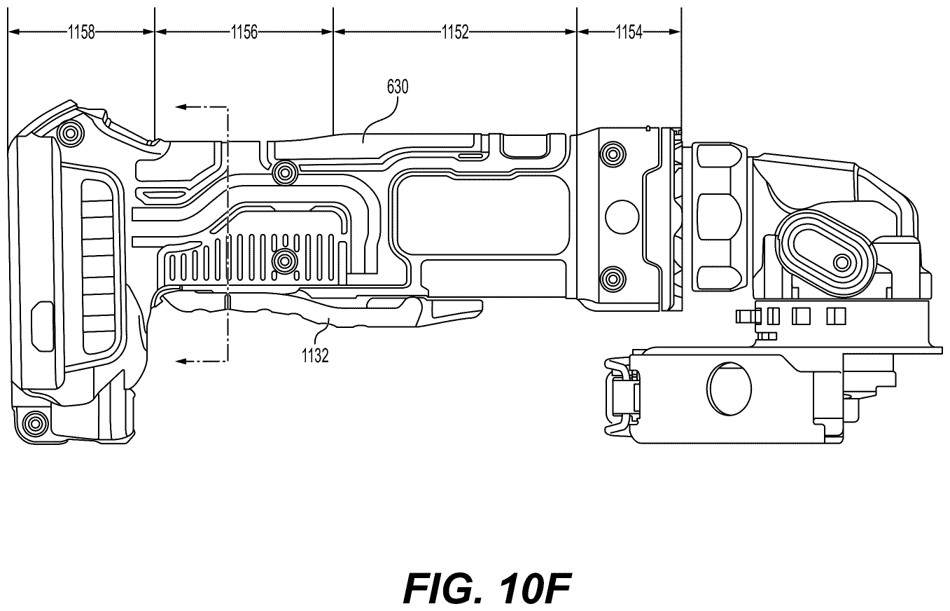

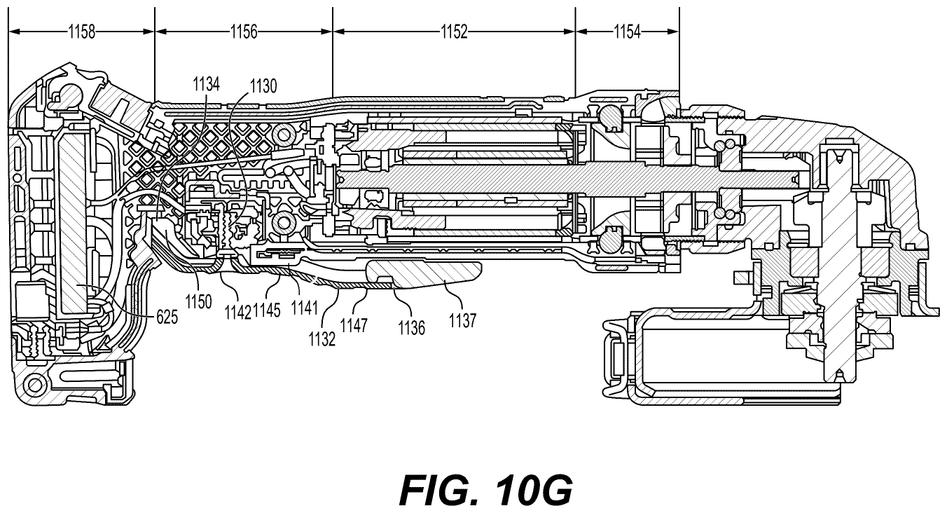

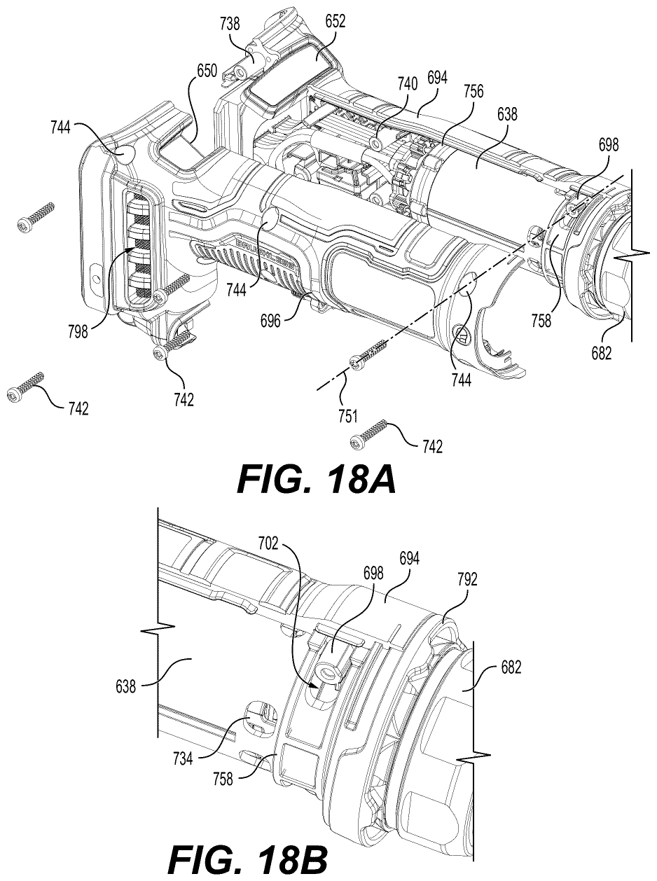

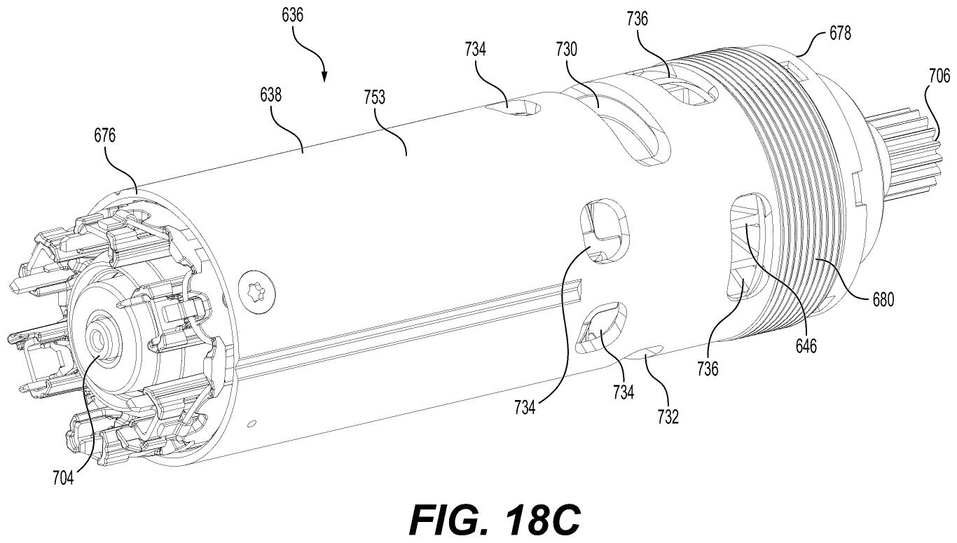

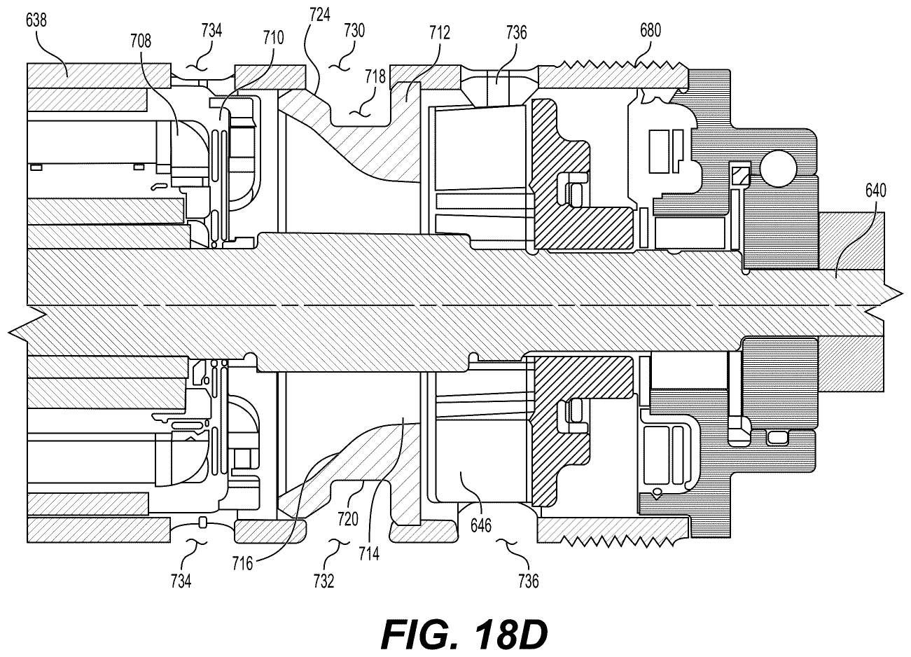

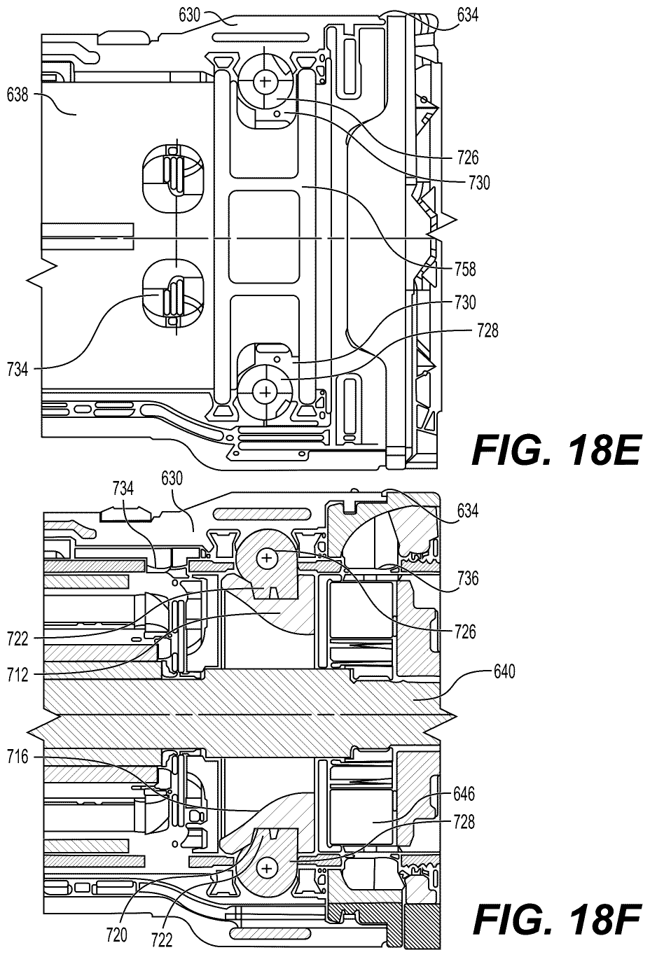

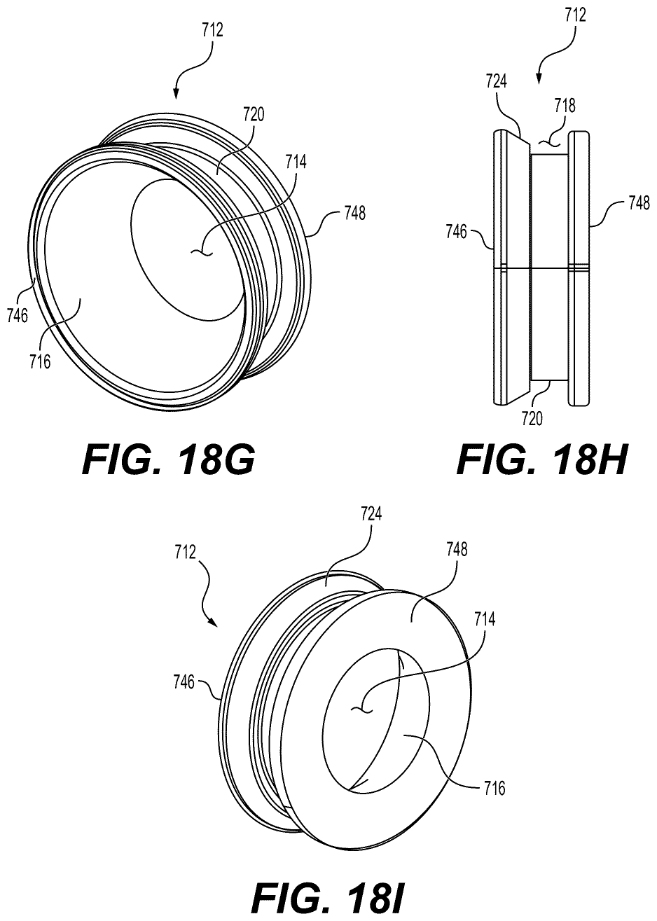

Referring to FIGS. 10A-10D and 18A-18F, in an embodiment, the tool housing 630 of each power tool 602, 606, 610, 614, 618, 622, 626 includes a first portion 694 and a second portion 696 connected to the first portion 694 in a clamshell configuration along a mating plane that extends horizontally though the tool housing 630 and the motor 636, with the first portion 694 of the tool housing 630 including a housing screw boss 698 configured to receive a screw for securing the first portion 694 of the tool housing 630 to the second portion 696 of the tool housing 630. The motor housing 638 defines a screw boss opening 702 with the housing screw boss 698 at least partially received within the screw boss opening 702. The motor shaft 640 has a first end 704 and a second end 706 positioned opposite the first end 706, with the second end 678 of the motor housing 638 positioned closer to the second end 706 of the motor shaft 640 than the first end 704 of the motor shaft 640. The screw boss opening 702 of the motor housing 638 is positioned closer to the second end 678 of the motor housing 638 than the first end 676 of the motor housing 638. The stator assembly 642 includes a stator winding 708, with an end 710 of the stator winding 708 positioned closer to the second end 678 of the motor housing 638 than the first end 676 of the motor housing 638. The housing screw boss 698 is axially positioned between the end 710 of the stator winding 708 and the motor fan 646.

Referring to FIGS. 10E-10G, in an embodiment, each of the power tools 602, 606, 610, 614, 618, 622, 626 includes the electronic switch 1130 at least partially received within the tool housing 630, as previously described, and a trigger switch 1132 having a first end 1134 and a second end 1136 positioned opposite the first end 1134. The trigger switch 1132 includes a main body, first flange 1138 and a second flange 1140 laterally spaced from the first flange 1138 on two sides of the main body, and a trigger protrusion 1142 mounted on the main body between the first and second flanges. In an embodiment, the first end 1134 is pivotably coupled via a pivot point 1150 to a pivoting support structure 1143 of the tool housing 630, and the second end 1136 is pivotably coupled to a trigger lock 1137. In an embodiment, the trigger switch 1132 is rotatable around the pivoting support structure 1143 relative to the tool housing 630 between a first position, where the trigger protrusion 1142 is spaced from the push-button 641 of the electronic switch 1130, and a second position, where the trigger protrusion 1142 is engaged with the push-button 641 of the electronic switch 1130. The trigger lock 1137 extends transverse to the tool housing 630 in a default orientation to block movement of the trigger switch 1132 to the second position, but it is pivoted by the operator to a parallel position relative the tool housing 630 to allow movement of the trigger 1132 to the second position. The trigger lock 1137 provides added safety by requiring a dual actuation by the user to start the tool operation. In an embodiment, the trigger switch 1132 includes a first portion 1145 that supports the trigger protrusion 1142, and a second portion 1147 that extends to the second end 1136 and forms a sloped section as it extends from the first portion 1145. The trigger switch 1132 may function similarly to the trigger switches 112, 512 discussed above and the electronic switch 1130 may function similarly to the electronic switch 512A discussed above.

In an embodiment, the tool housing 630 defines a trigger recess 1144 around the push-button 641, with at least the first portion 1145 of the trigger switch 1132 received by the trigger recess 1144 when the trigger switch 1132 is in the second position. The trigger recess 1144 includes a first channel 1146 and a second channel 1148, with the first channel 1146 receiving at least a portion of the first flange 1138 at the first portion 1145 when the trigger switch 1132 is in the second position and the second channel 1148 receiving at least a portion of the second flange 1140 at the first portion 1145 when the trigger switch 1132 is in the second position. In the embodiment, the first and second channels 1146 and 1148 may be grooves or flat surfaces formed on two sides of the opening of the push-button 641. Receiving the first portion 1145 of the trigger switch 1132 within the trigger recess 1144 of the tool housing 630 is configured to minimize an outer diameter of the tool housing 630 at the location of the trigger switch 1132 when the trigger switch 1132 is in the second position thereby improving ergonomics of the tool housing 630. In an embodiment, at least the two flanges 1138 and 1140 at the first section 1145 of the trigger switch 1132, in the second position of the trigger switch 1132, substantially circumferentially intersect and/or are located approximately aligned with a circumferential profile of the tool housing 630 around the push-button 641. In an embodiment, a post 1141 projects from the tool housing 630 forward of the push-button 641 and is nested within the trigger switch 1132 between the two flanges 1138 and 1140 in the second position of the trigger switch 1132.

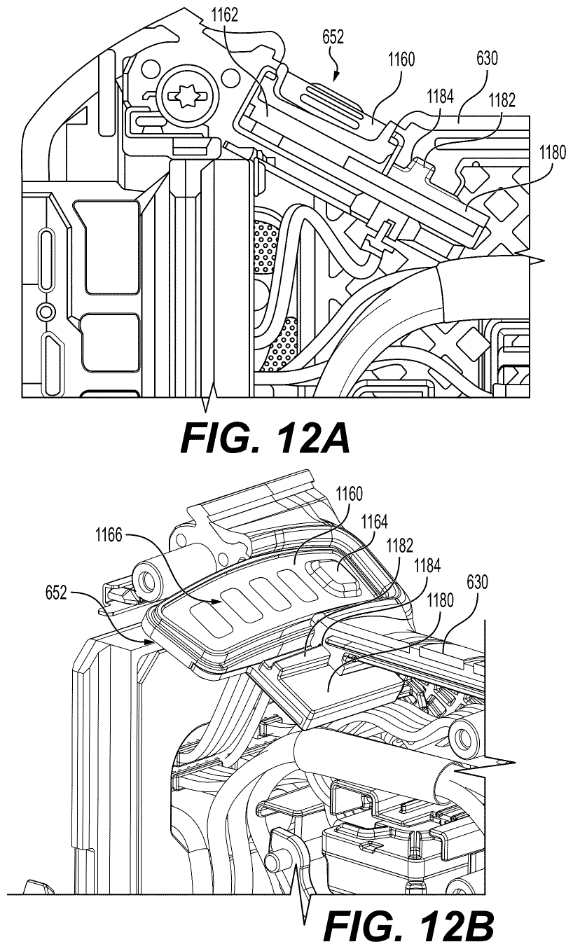

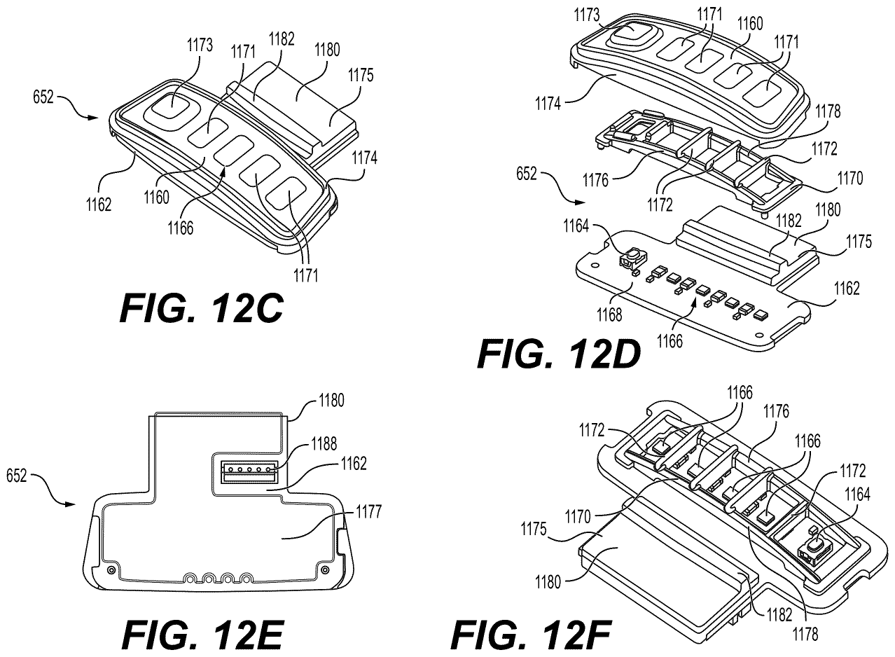

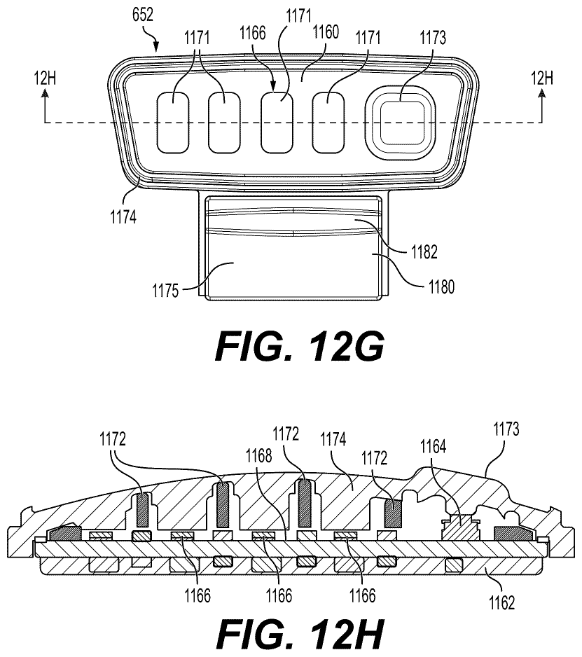

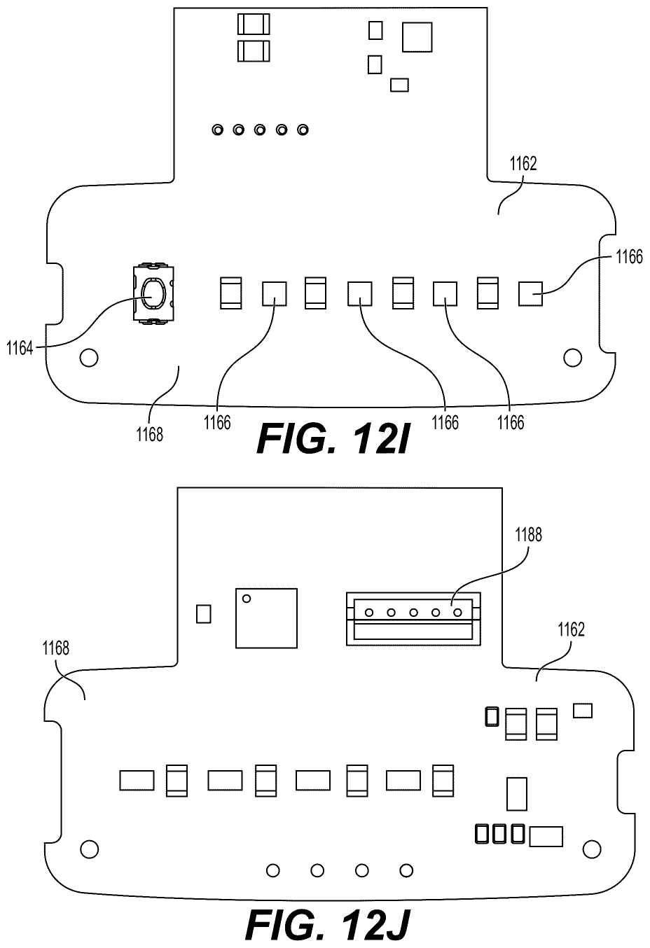

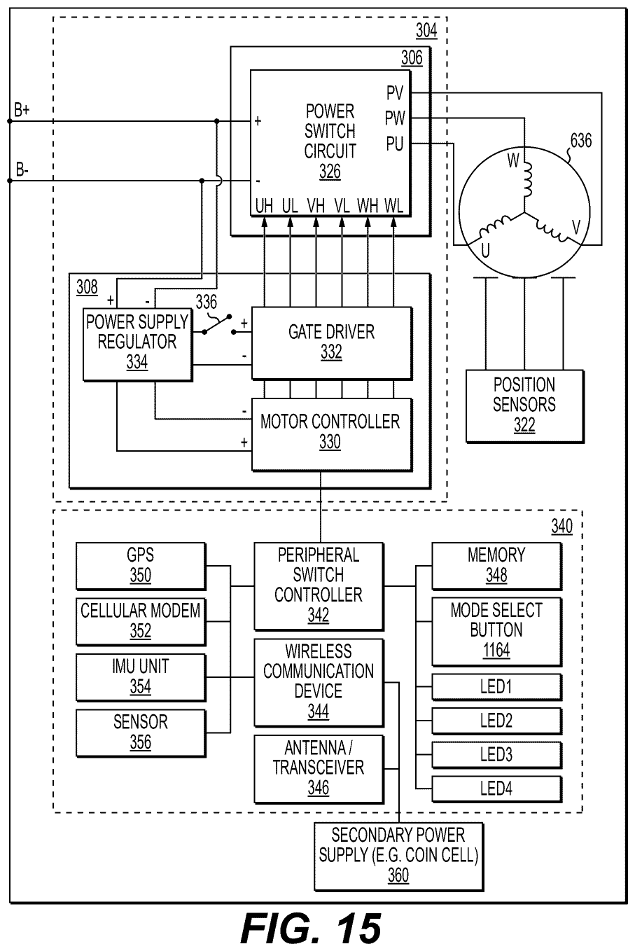

Referring to FIGS. 12A-15, in an embodiment, the tool housing 630 of each power tool 602, 606, 610, 614, 618, 622, 626 defines the peripheral switch opening 650 as discussed above. Each power tool 602, 606, 610, 614, 618, 622, 626 also includes the peripheral switch 652 at least partially received within the peripheral switch opening 650. The peripheral switch 652, includes a curved display surface 1160 and a printed circuit board (PCB) 1162, with the PCB 1162 including a switch 1164 and a plurality of indicator lights 1166 positioned on a planer body portion 1168 of the PCB 1162. In an embodiment, the PCB 1162 further includes a peripheral switch controller 342 (FIG. 15) mounted on a front or a surface thereof and configured to set a mode of operation according to engagement of the switch 1164 and provide an output signal accordingly. The planer body portion 1168 is substantially flat or planer and not curved. In an embodiment, the planer body portion 1168 lies along a single plane with industry standard flatness tolerances for printed circuit boards for power tools. In an embodiment, the peripheral switch 652 includes a computer readable memory 348 and a connection port 1188.

In an embodiment, the plurality of indicator lights 1166 each include a light emitting diode (LED). As shown in FIGS. 12C and 12D, the plurality of indicator lights 1166 may include four individual lights, although one or more indicator lights 1166 may be provided. In an embodiment, the switch 1164 is mounted on the planar body portion 1168 of the PCB 1162 in line with the indicator lights 1166 along an array. With each engagement of the switch 1164, the peripheral switch controller 342 cycles through a preset number of modes and causes one or more of the indicator lights 1166 to light up in corresponding with a presently selected mode.

In an embodiment, the peripheral switch 652 further includes a barrier member 1170 positioned between the curved display surface 1160 and the PCB 1162, with the barrier member 1170 including a plurality of walls 1172 positioned between each of the plurality of indicator lights 1166. One of the plurality of walls 1172 is positioned between the switch 1164 and one of the indicator lights 1166. The walls 1172 provide lighting barriers between the indicator lights 1166. Heights of the plurality of walls 1172 are greater near a middle of the peripheral switch 652 and become gradually smaller towards the edges of the peripheral switch 652. This structure supports the curved structure of the flexible display member 1174 over the PCB 1162. The barrier member 1170 may include a first curved wall 1176 and a second curved wall 1178 spaced from the first curved wall 1176, with each of the plurality of walls 1172 extending from the first curved wall 1176 to the second curved wall 1178.

In an embodiment, the curved display surface 1160 is defined by a flexible display member 1174 supported by the barrier member 1170. The flexible display member 1174 may be formed from an elastomeric material, such as silicone, although other suitable materials and arrangements may be utilized. The flexible display member 1174 includes translucent windows 1171 aligned with the indicator lights 1166, and a resilient push-button 1173 that is aligned with the switch 1164 and can be resiliently pressed to engage the switch 1164. The walls 1172 ensure that each translucent window 1171 is illuminated via only a corresponding one of the plurality of indicator lights 1166.

In an embodiment, the PCB 1162 includes a connection interface 1180 extending from the planer body portion 1168, which is provided with an overmolded layer 1175 that is coupled with the tool housing 630 to secure the peripheral switch 652 to the tool housing 630. The overmolded layer 1175 of the connection interface 1180 includes a rib 1182 received within a channel 1184 defined by the tool housing 630. Referring to FIGS. 12C-12J, in an embodiment, the connection interface 1180 of the peripheral switch 652 of each power tool 602, 606, 610, 614, 618, 622, 626 is identical in size and shape.

In an embodiment, as shown in FIG. 12E, the connection port 1188 is mounted on the rear surface of the connection interface 1180 of the PCB 1162 opposite the rib 1182. The connection port 1188 may be a ribbon connector or any other known type of serial or digital connector. In an embodiment, the rear surface of the PCB 1162, including the connection interface 1180 and the planer body portion 1168, may be covered with an overmolded layer 1177.

In an embodiment, as shown in FIGS. 12B-12G, the peripheral switch 652 may be configured as a speed-select switch, where the four indicator lights 1166 respectively correspond to four discrete speed thresholds (e.g., 12K RPM, 15k RPM, 18k RPM, and 21k RPM). The peripheral switch controller 342 may be configured to cycle through a preset number of discrete signals that correspond to the number of times the switch 1164 is engaged by the user via the display surface 1160, and it illuminates the indicator lights 1164 accordingly. The peripheral switch controller 342 may be configured to provide the discrete signal to the motor control module, which then sets then maximum operating speed thresholds of the motor 636 accordingly.

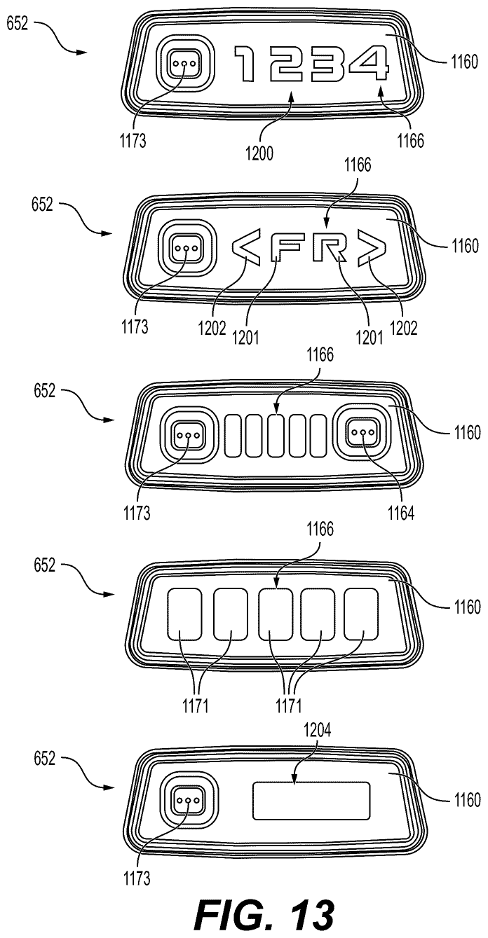

In an embodiment, as shown in FIG. 13, the peripheral switch 652 may be configured and utilized as an alternative type of mode-select switch and/or provide a different type of display than shown in FIGS. 12B-12G. For example, the peripheral switch 652 may be configured as an operating mode-selection switch (e.g., in a hammer-drill, where it can be used to switch between a hammer mode, a drill-mode, and a hammer-drill mode), a speed-select switch, a forward/reverse switch, or safety switch, or any other switch capable of receiving a user input and transmitting one of a plurality of discrete outputs to the motor control module.

In the illustrated example of FIG. 13, from top to bottom, in a first embodiment, the peripheral switch 652 may be configured as a speed-select or a mode-select switch including translucent windows 1200 that are shaped to display numbers 1 through 4 corresponding to the indicator lights 1166. In a second embodiment, the peripheral switch 652 may be a forward-reverse switch, where a signal corresponding to a direction of rotation of the motor 636 is switched every time the switch 1164 is engaged. Here, the two inner translucent windows 1201 are shaped as F and R, and the two outer translucent windows 1202 shaped as arrows that correspond to the direction of rotation. The indicator lights 1166 are illuminated in pair when switching directions. In a third embodiment, the peripheral switch 652 may include two switches 1164, each associated with a particular function (e.g., one for mode select and one for rotation direction). In this embodiment, an additional switch is mounted on the PCB adjacent the array of indicator lights 1166. In a fourth embodiment, where no mode-selection is needed, the flexible display member 1174 may be provided without a resilient push-button, and the indicator lights 1166 might be configured to illuminate in a pattern that is indicative of an operating condition of the tool. For example, the indicator lights 1166 may be indicative of a tool load, where illumination of a number of the indicator lights 1166, and/or a brightness or color of the indicator lights 1166, is controlled as a function of motor overload conditions and/or amount of load applied to the motor 636. In a fifth example, the flexible display member 1174 may be configured as an LED or LCD display panel 1204 that displays alerts or texts to the user.

Referring to FIGS. 12A-14, 24A-24G, and 27A-27D, in an embodiment, a system of tools is provided that includes power tools 602, 606, 610, 614, 618, 622, 626 having different front-end tool assemblies 604, 608, 612, 616, 620, 624, 628 and with each power tool 602, 606, 610, 614, 618, 622, 626 having the peripheral switch 652, where the display surface 1160 and the PCB 1162 of each peripheral switch 652 are identical in size and shape and where indicia of each peripheral switch 652 on the display surface 1160 are different. For example, the system of tools includes a first power tool 610, such as the die grinder shown in FIGS. 24A-24G, and a second power tool 622, such as the cut-off tool shown in FIGS. 27A-27D, with each power tool 610, 622 including the peripheral switch 652 with the display surface 1160 and the PCB 1162 of each peripheral switch 652 identical in size and shape. In an embodiment, as shown in FIG. 13, for example, the power tool 610 of FIGS. 24A-24G may include an operating speed indicator 1200 and the power tool of FIGS. 27A-27D may include a rotation direction indicator 1201, 1202. The power tools 602, 606, 610, 614, 618, 622, 626 may include various switch and display configurations as shown in FIG. 13.

Referring to FIGS. 10A, 10B and 12H, the peripheral switch 652 includes a curved outer profile formed by the curved display surface 1160 that can be placed substantially in alignment with the curvature of the tool housing at the sloped surface 631 of the foot section 1158 of the tool housing 630. In an embodiment, a curvature of the curved display surface 1160 may be designed to substantially match a curvature of the tool housing 630 along at least a rear edge of the peripheral switch opening 650. In an embodiment, the curved display surface 1160 may have a curvature center point defining a radius of approximately 58 mm to 66 mm. In an embodiment, since the tool housing 630 is compact, a display panel without the curvature would require added size to the sloped surface 631 of the foot portion 1158.

Referring to FIGS. 10C and 10D, in an embodiment, the tool housing 630 of each power tool 602, 606, 610, 614, 618, 622, 626 defines a central axis 1190 extending through a mid-point of a grip portion 1192 of the tool housing 630, with the peripheral switch 652 extending angularly inward from the peripheral switch opening 650 at an angle of approximately 30 to 45 degrees to a position between the peripheral switch opening 650 and the central axis 1190. The length of the peripheral switch 652 and the position of the peripheral switch 652 within the peripheral switch opening 650 is configured to limit the extension of the peripheral switch 652 into the tool housing 630 to maximize the airflow through the tool housing 630, i.e., minimize obstructions that may inhibit airflow. In an embodiment, the planer body portion 1168 of the PCB may be substantially fit into a cavity of the tool housing near the sloped surface 631 of the foot portion 1158, while connection interface 1180 protrudes minimally into the body of the tool housing 630 by no more than 20% of the cross-sectional area of the tool housing.

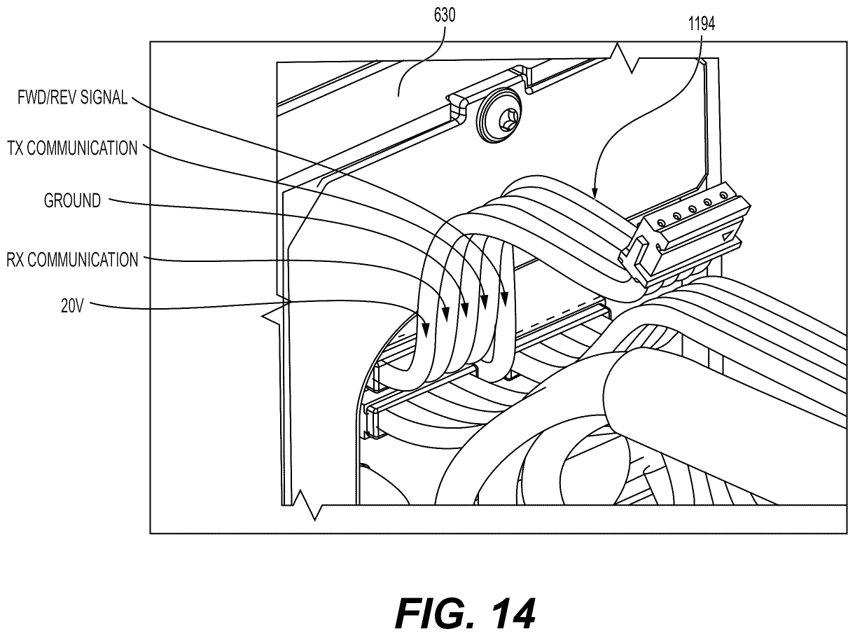

Referring to FIG. 14, the connection port 1188 of the peripheral switch 652 may be connected to the motor control module 34 via wiring 1194 including, for example, an FWD/REV signal wire, a TX communication wire, a ground wire, RX communication wire, and a power wire (20V), although other suitable arrangements may be utilized.

Referring to FIG. 15, a circuit block diagram for each power tool 602, 606, 610, 614, 618, 622, 626 according to one embodiment is shown. The circuit block diagram includes a motor control circuit 304 with a power unit 306 and a control unit 308. In an embodiment, the motor control circuit 304 is implemented fully or substantially within the motor control module 625. The power tool receives DC power from a DC power source such as a battery pack via B+ and B− terminals. The power unit 306 includes a power switch circuit 326 coupled between the power source B+/B− terminals and motor windings to drive the motor 636. In an embodiment, the power switch circuit 326 may be a three-phase bridge driver circuit including six controllable semiconductor power devices (e.g. FETs, BJTs, IGBTs, etc.).

In an embodiment, the control unit 308 may include a controller 330, a gate driver 332, a power supply regulator 334, and a power contact switch 336. In an embodiment, the controller 330 is a programmable device arranged to control a switching operation of the power devices in the power switching circuit 326. In an embodiment, the controller 330 receives rotor rotational position signals from a set of position sensors 338 provided in close proximity to a rotor of the motor 636. In an embodiment, the position sensors 338 may be Hall sensors, although other types of positional sensors may be alternatively utilized. The controller 330 may be configured to calculate or detect rotational positional information relating to the rotor of the motor 636 without any positional sensors (known in the art as sensorless brushless motor control). The controller 330 may also receive a variable-speed signal from variable-speed actuator or a speed-dial. Based on the rotor rotational position signals from the position sensors 338 and the variable-speed signal, the controller 330 outputs drive signals UH, VH, WH, UL, VL, and WL through the gate driver 332, which provides a voltage level needed to drive the gates of the semiconductor switches within the power switch circuit 326 in order to control a PWM switching operation of the power switch circuit 326.

In an embodiment, the power supply regulator 334 may include one or more voltage regulators to step down the power supply to a voltage level compatible for operating the controller 330 and/or the gate driver 332. In an embodiment, the power supply regulator 334 may include a buck converter and/or a linear regulator to reduce the power voltage of power supply interface 128-5 down to, for example, 15V for powering the gate driver 332, and down to, for example, 3.2V for powering the controller 330.

In an embodiment, the power contact switch 336 may be provided between the power supply regulator 334 and the gate driver 332. The power contact switch 336 may be an ON/OFF switch coupled to the ON/OFF trigger or the variable-speed actuator to allow the user to begin operating the motor 636, as discussed above. The power contact switch 336 in this embodiment disables supply of power to the motor 636 by cutting power to the gate drivers 332. The power contact switch 336 may be provided at a different location. In an alternative embodiment, the power contact switch 336 is provided within the power unit 306 between the battery terminal (B+ and/or B−) and the power switch circuit 326. In certain embodiments, each power tool 602, 606, 610, 614, 618, 622, 626 may be provided without the ON/OFF switch 336, and the controller 330 may be configured to activate the power devices in power switch circuit 326 when the ON/OFF trigger (or variable-speed actuator) is actuated by the user.

In an embodiment, one of the power tools, such as the power tool 610 of FIGS. 24A-24G, includes a peripheral switch circuit 340 incorporated partially or fully into the peripheral switch 652, including a peripheral switch controller 342 configured to cause the motor controller 330 to execute a first type of operation designated for the power tool 210 when the switch 1164 of the peripheral switch 652 is actuated. Another of the power tools, such as the power tool 622 of FIGS. 27A-27D, also includes the peripheral switch controller 342 configured to cause the motor controller 330 to execute a second type of operation designated for the power tool 622 when the switch 1164 of the peripheral switch 652 is actuated. In an embodiment, the first type of operation is a speed select operation and the second type of operation is a rotation direction operation, although the peripheral switch circuit 340 may be configured to execute other suitable operations as previously described. In an embodiment, each power tool 602, 606, 610, 614, 618, 622, 626 includes the peripheral switch 652 with the display surface 1160 and the PCB 1162, with the PCB 1162 including the switch 652, the plurality of indicator lights 1166, and the peripheral switch controller 342.

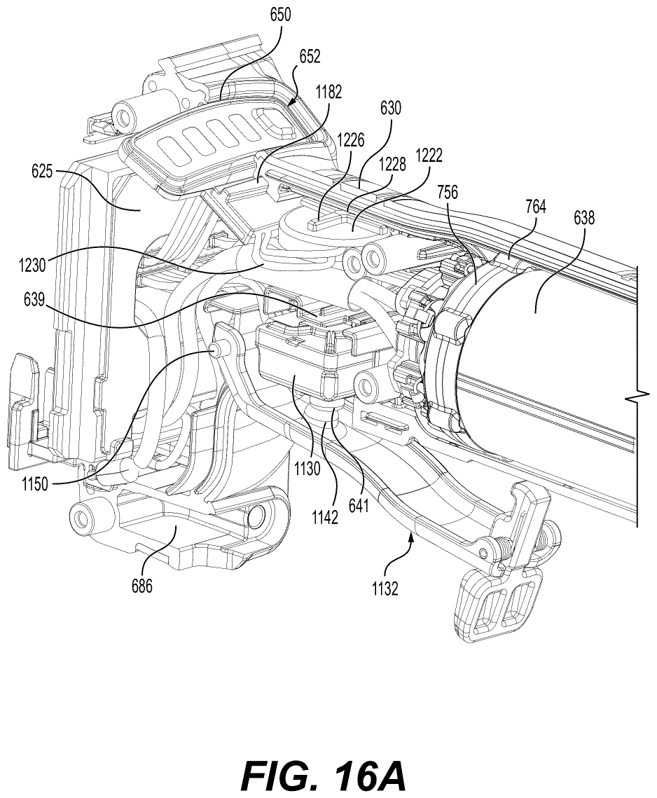

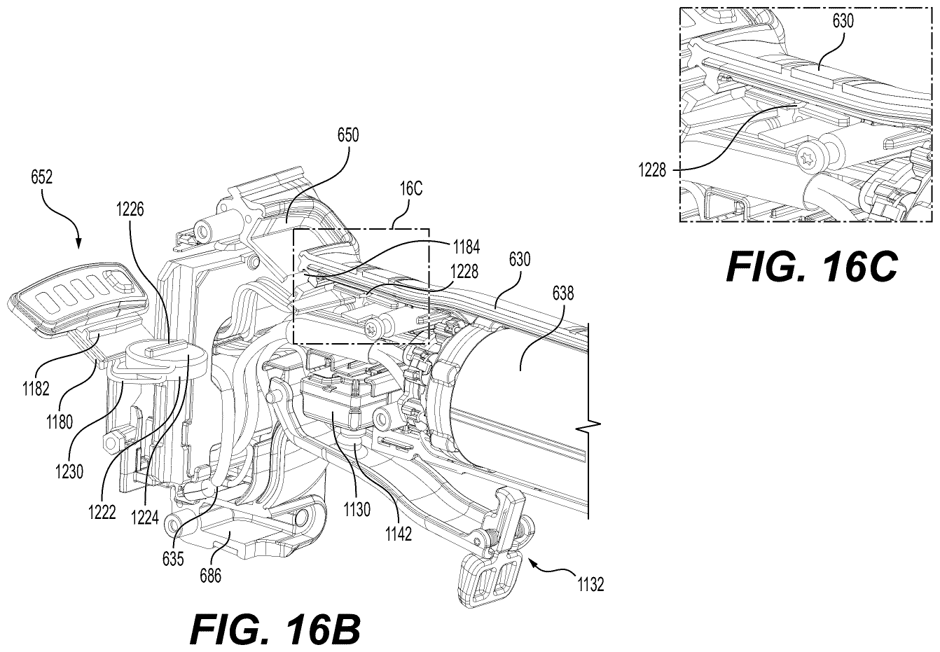

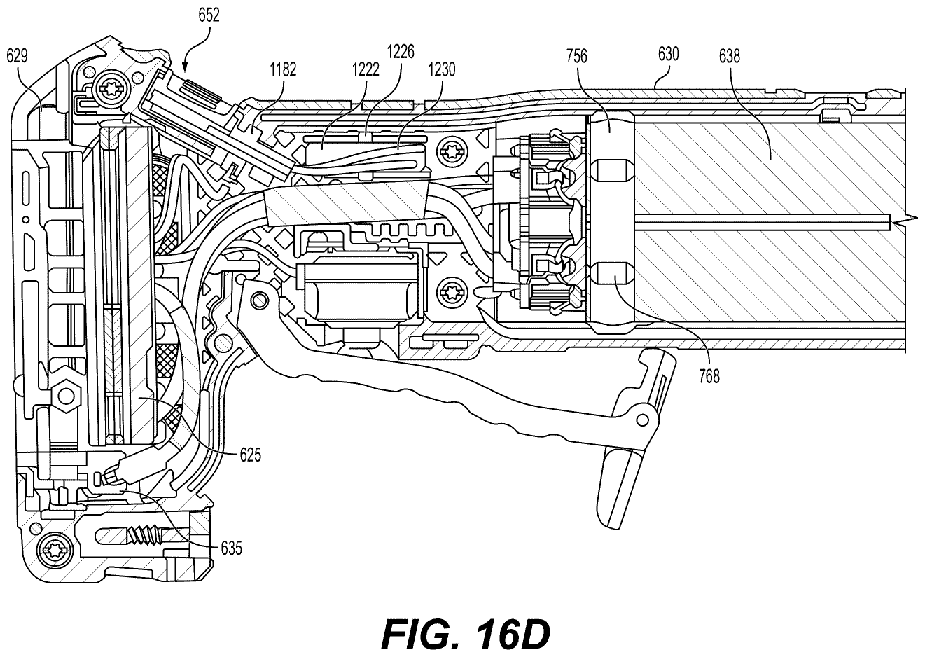

Referring to FIGS. 15 and 16A-16E, in an embodiment, one of more of the power tools 602, 606, 610, 614, 618, 622, 626 may optionally include a wireless communication device 344 provided as a part of the peripheral switch circuit 340. The motor controller 330 is in electronic communication with the wireless communication device 344, directly or through the peripheral switch controller 342, with the wireless communication device 344 configured to send or receive data between the motor controller 330 and a remote device, such as a remote computer, mobile device, or the like. In an embodiment, the wireless communication device 344, and the associated components described below, may be incorporated partially or fully into the peripheral switch 652 and mounted on the PCB 1162.

In an embodiment, the peripheral switch 652 further includes a GPS unit 350 configured to provide a location of the power tool 602, 606, 610, 614, 618, 622, 626. In an embodiment, the peripheral switch 652 further includes a cellular modem 352 configured to wirelessly communicate with a remote device via a cellular network. In an embodiment, the peripheral switch 652 further includes an inertial measurement unit 354 such as a gyroscope and/or an accelerometer configured to detect rotation and/or movement of the power tool 602, 606, 610, 614, 618, 622, 626. In an embodiment, the peripheral switch 652 further includes an additional sensor 356 to measure various other parameters, such as a temperature sensor, a humidity sensor, etc. In an embodiment, the peripheral switch 652 further includes an antenna/transceiver 346 coupled to the wireless communication device 344 for sending or receiving a signal or data to and from a remote device.

In an embodiment, a secondary power source 360 may be further provided within the tool housing. The secondary power source 360 may be configured to provide backup power to the wireless communication device 344 to enable wireless tracking of and communication with the wireless communication device 344 even when a primary battery pack is not coupled to the power tool. In an embodiment, the wireless communication device 344 may be configured to periodically transmits a beacon signal including a unique ID, which allows a gateway or central device to detect the location or presence of the power tool within a jobsite.

Referring to FIGS. 16A-16E, in an embodiment, the secondary power source 360 may be captured by a cell housing 1222 that may be made of complementary plastic pieces coupled together around the secondary power source 360 or overmolded around the secondary power source 360. The cell housing 1222 is secured to the tool housing 630 via a cell connection interface 1224, with the cell housing 1222 spaced from the peripheral switch 652 and the peripheral switch 652 positioned closer to the first end 632 of the tool housing 630 than the cell housing 1222. The cell connection interface 1224 includes a rib 1226 received by a channel 1228 defined by the tool housing 630 proximate the connection interface 1180 of peripheral switch 652, although other suitable arrangements to secure the cell housing 1222 to the tool housing 630 may be utilized. In an embodiment, the rib 1226 locates and supports the secondary power source 360 directly behind the motor proximate an upper wall of the tool housing 630 opposite the electronic switch 1130, so it does not interfere with the wirings located within the tool housing 630 and/or airflow passing through the tool housing 630.

In an embodiment, the secondary power source 360 is connected to the peripheral switch 652 via wiring 1230. The secondary power source 360 may be a coin cell or a button battery received within the cell housing 1222, although other suitable power sources, such as other types of cell batteries or photovoltaic cells, may be utilized. In an embodiment, the wireless communication device 344 is formed integrally with the peripheral switch controller 342.

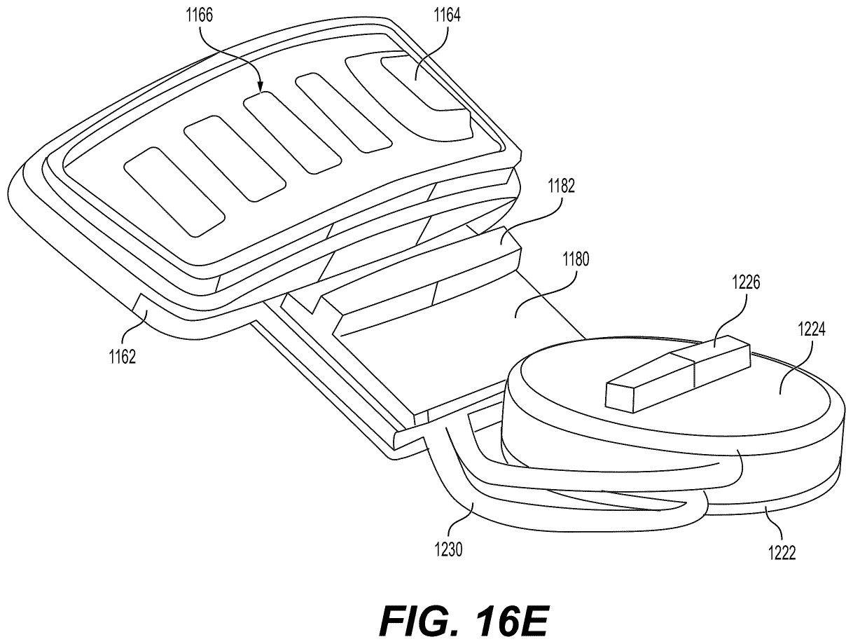

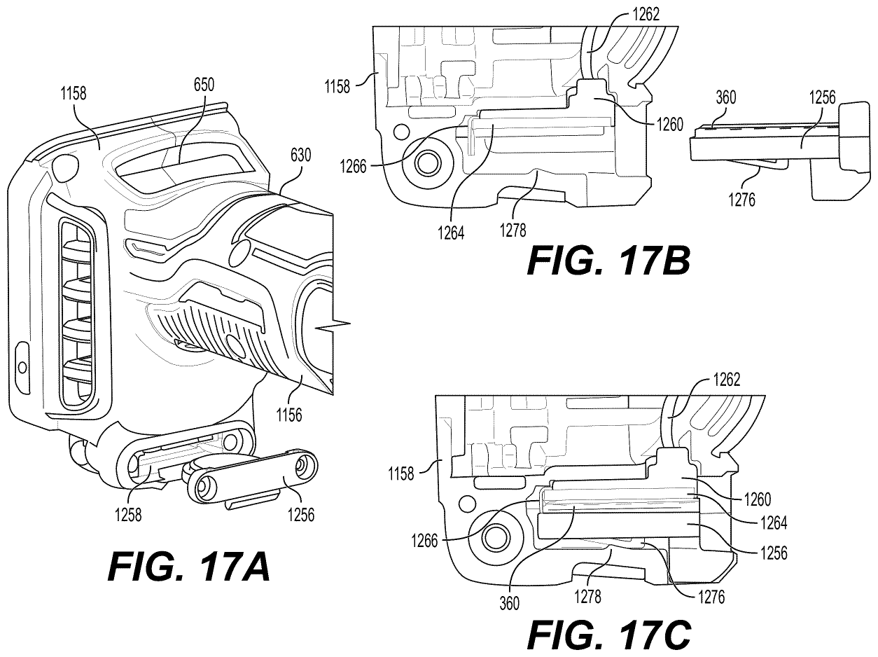

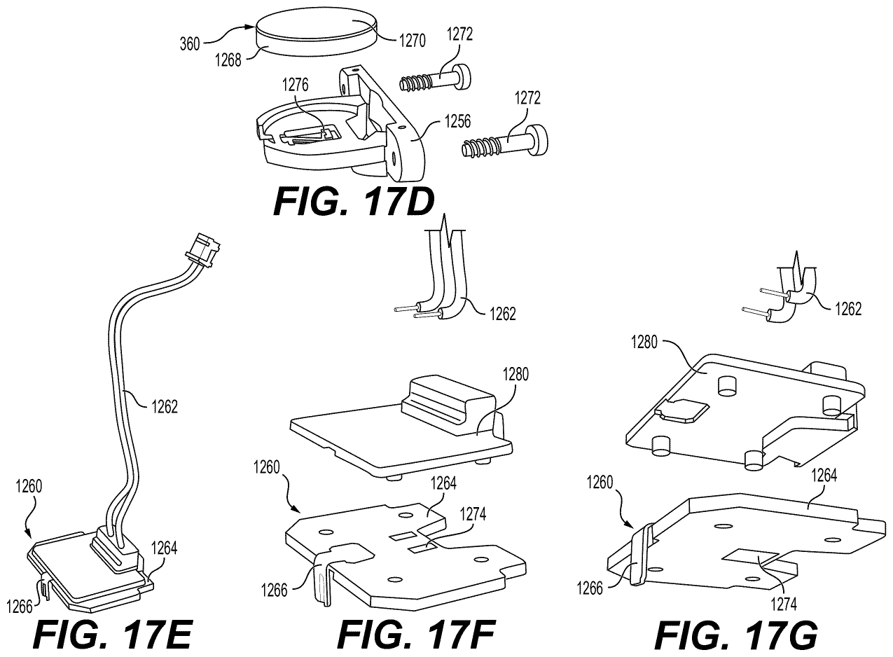

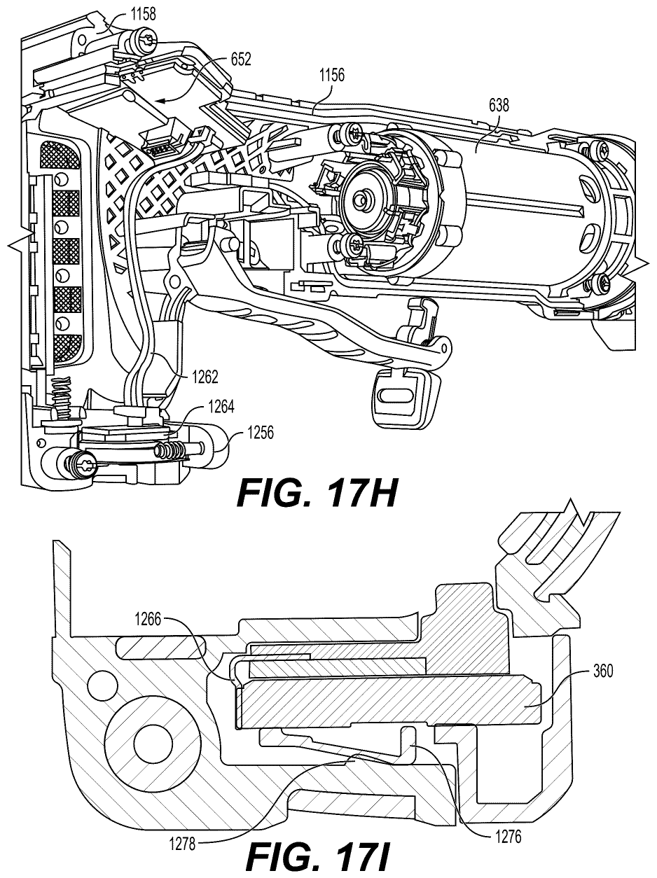

In an embodiment, as previously discussed with reference to FIGS. 11A-11C, each power tool 602, 606, 610, 614, 618, 622, 626 includes the pocket 686, which is formed at a bottom portion of the foot section 1158, opposite the peripheral switch opening 650 and proximate a terminal block 635 of the battery receptacle 629. The pocket 686, as previously discussed, is designed to removably receive an audit chip 684 for wireless tracking of the power tool. Alternatively, as described herein with reference to FIGS. 17A-17B, in some embodiments, one or more of the power tool 602, 606, 610, 614, 618, 622, 626 is provided with a modified pocket 1258 provided an internal support structure for removably receiving a secondary power supply (e.g., a coin cell) and with wires for routing the secondary power supply to an internal wireless communication device located within the tool housing 630.

Referring to FIGS. 17A-17I, in an embodiment, the pocket 1258 includes an electrical contact 1260 and an opening that receives a wire 1262 therethrough, where the wire 1262 extends from the electrical contact 1260 to the peripheral switch 652 (and or another component of the power tool that house the wireless communication device 344). The pocket 1258 may also be provided with a protrusion 1278 on a side of its cavity that is opposite the electrical contact 1260. The remaining structure of the pocket 1258 is substantially similar to that of pocket 686.

In an embodiment, the secondary power source 360 is serviceably and removably mounted into a cell housing 1256 via, e.g., a snap-fit connection. The cell housing 1256 is configured to be removably received into the pocket 1258 via a pair of fasteners 1272. The cell housing 1256 is configured to be removed from an exterior of the tool housing 630. In an embodiment, the secondary power source 360 is a coin cell, and the electrical contact 1260 is engaged with the coin cell when the cell housing 1256 is positioned within the pocket 1258. In this position, wire 1262 electrically couples the coin cell with the peripheral switch 652.

As shown in FIGS. 17F and 17G, in an embodiment, the electrical contact 1260 includes a printed circuit board (PCB) 1264 having a first L-shaped contact 1266 that projects approximately perpendicularly from an edge of the PCB 1264 and is engaged with a first conductor 1268 of the coin cell 360 (i.e., on a circumferential side of the coin cell 360), and a second contact 1274 engaged with a second conductor 1270 of the coin cell 360 (e.g., on a front face of the coin cell 360 facing the PCB 1264). The wire 1262 is securely coupled to the first and second contacts 1266 and 1274 via an overmold structure 1280 mounted on the PCB 1264. The cell housing 1256 includes a biasing member 1276 that projects away from the coin cell 360 and is engaged with a protrusion 1278 positioned within the pocket 1258, with the biasing member 1276 biasing the coin cell 360 toward the second contact 1274. The protrusion 1278 is a sloped chamfer, and the biasing member 1247 includes a sloped lower surface that comes into sliding contact with the sloped chamfer and biases the coin cell in contact with the second contact 1274 as the cell housing 1256 is slidingly received into the pocket 1258. In this manner, the coin cell remains securely coupled to the electrical contact 1260 even in the presence of high vibration.

Referring to FIGS. 18A-18F, in an embodiment, the motor 636 of each power tool 602, 606, 610, 614, 618, 622, 626 includes a fan baffle 712 axially positioned between the end 710 of the stator winding 708 and the motor fan 646, with the fan baffle 712 defining a central opening 714 defined by a sloped or curved inner surface 716. A portion of the motor shaft 640 extends through the central opening 714 of the fan baffle 712. The fan baffle 712 is configured to direct air toward the motor shaft 640 and toward a central portion of the motor fan 646. An outer surface of the fan baffle 712 defines a recessed portion 718 receiving at least a portion of the housing screw boss 698. The recessed portion 718 of the fan baffle 712 includes a cylindrical surface 720 engaged with a protruding portion 722 of the housing screw boss 698. The outer surface of the fan baffle 712 includes a frustoconical surface 724 configured to engage the housing screw boss 698 during assembly of the motor 363 within the tool housing 630. More specifically, the frustoconical surface 724 is configured to provide an axial tolerance such that, during assembly, the protruding portion 722 of the housing screw boss 698 can be initially misaligned with the recessed portion 718 of the fan baffle 712, with the frustoconical surface 724 guiding the protruding portion 722 to the recessed portion 718 of the fan baffle 712. The positioning of the protruding portion 722 of the housing screw boss 698 within the recessed portion 718 of the fan baffle 712 is configured to provide axial alignment between the fan baffle 712 and the tool housing 630 and secure the axial position of the fan baffle 712 within the motor housing 638.

In certain embodiments, as shown in FIGS. 18A-18F, the housing screw boss 698 includes a first screw boss 726 and a second screw boss 728 radially spaced from the first screw boss 726, with the screw boss opening 702 including a first screw boss opening 730 and a second screw boss opening 732. The first and second screw boss openings 730, 732 are arcuate. In an embodiment, the motor housing 638 further defines inlet openings 734 and exhaust openings 736 axially spaced from the inlet openings 734, with the screw boss opening 730, 732 of the motor housing 638 axially positioned between the inlet openings 734 and the exhaust openings 736 of the motor housing 638. The motor fan 646 may be aligned with at least a portion of the exhaust openings 736 in a radial direction.

Referring to FIGS. 10C and 18A, in an embodiment, the tool housing 630 further includes a first set of supplementary housing screw bosses 738 and a second set of supplementary housing screw bosses 740, with the first set of supplementary housing screw bosses 738 positioned closer to the first end 632 of the tool housing 630 than the second end 634 of the tool housing 630. The second set of supplementary housing screw bosses 740 is positioned closer to an axial midpoint of the tool housing 630 than the first and second ends 632, 634 of the tool housing 630. The first portion 694 of the tool housing 630 is connected to the second portion 696 of the tool housing 630 via screws 742 extending through respective openings 744 in the second portion 696 of the tool housing 630 and the respective first and second screw bosses 726, 728 and the respective first and second set of supplementary housing screw bosses 738, 740. The first portion 694 of the tool housing 630 extends from the first end 632 of the tool housing 630 to the second end 634 of the tool housing 630, and the second portion 696 of the tool housing 630 extends from the first end 632 of the tool housing 630 to the second end 634 of the tool housing 630. The first portion 694 of the tool housing 630 may form one-half of the tool housing 630 and the second portion 696 of the tool housing 630 may form one-half of the tool housing 630, although other suitable arrangements may be utilized.

In an embodiment, a mating plane of the first portion 694 and the second portion 696 intersects a longitudinal axis of the motor shaft 640, with the housing screw boss 698 oriented along a screw axis 751 that is transverse to the mating plane. In an embodiment, the motor housing 638 includes a cylindrical body 753 and the screw boss opening 702 includes a cut-out in the cylindrical body 753 that is transverse to the mating plane and offset relative to the longitudinal axis of the motor shaft 640. The housing screw boss 698 is in contact with a portion of the motor housing 638 defining the screw boss opening 702 to rotationally and axially clock and constrain the motor housing 638 relative to the tool housing 630. The housing screw boss 698 is located at least partially outside a body of the motor housing 638 and at least partially within the body of the motor housing 638 axially in line with the stator assembly 642.

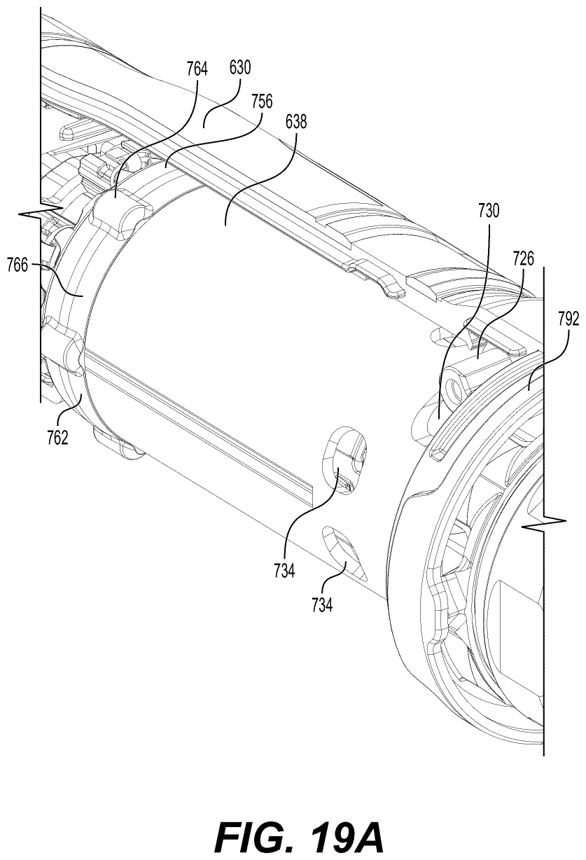

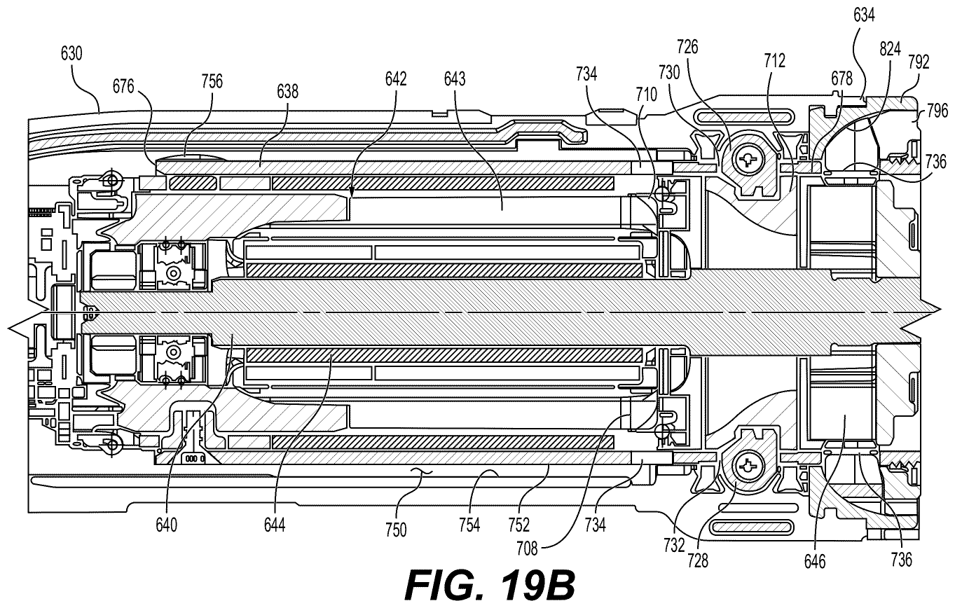

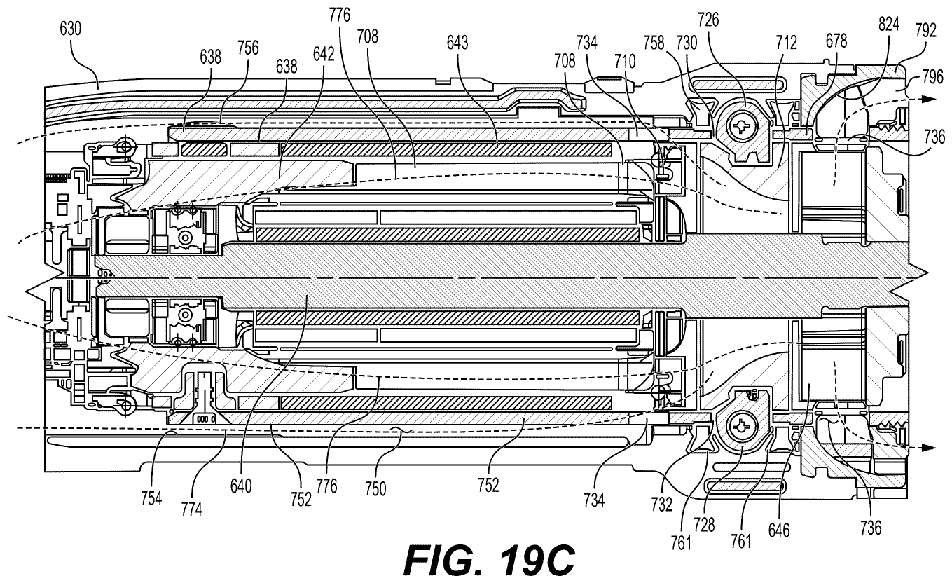

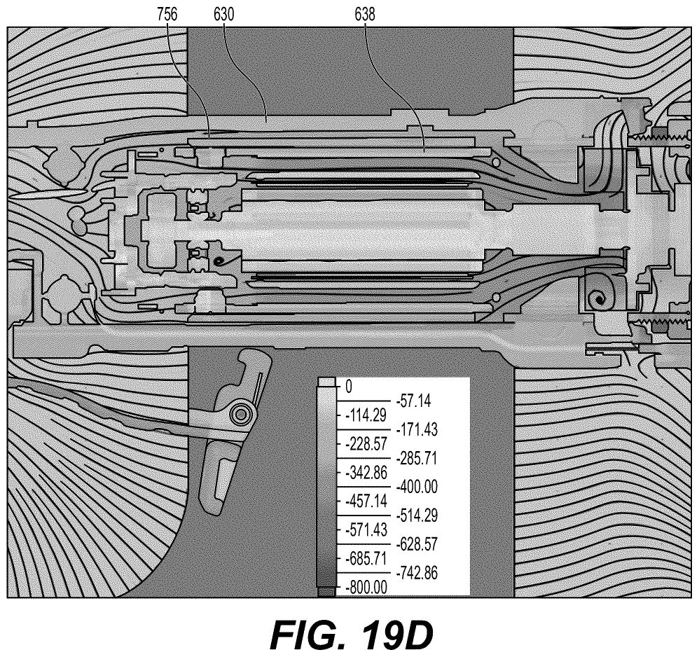

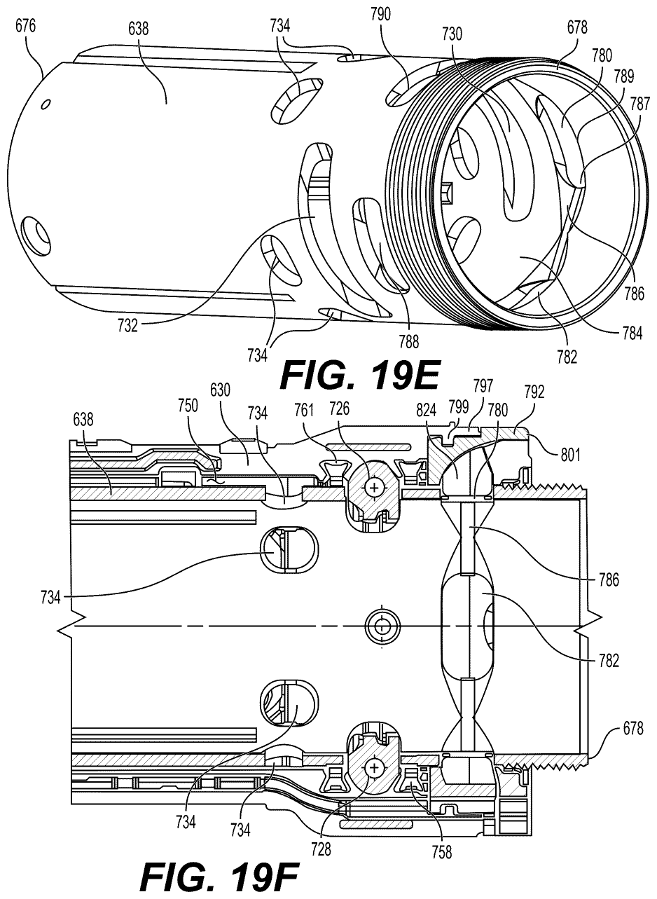

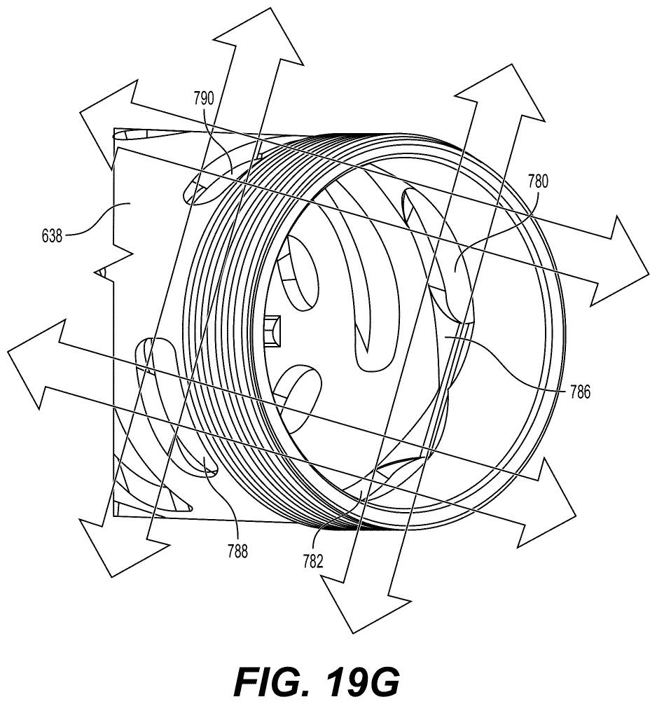

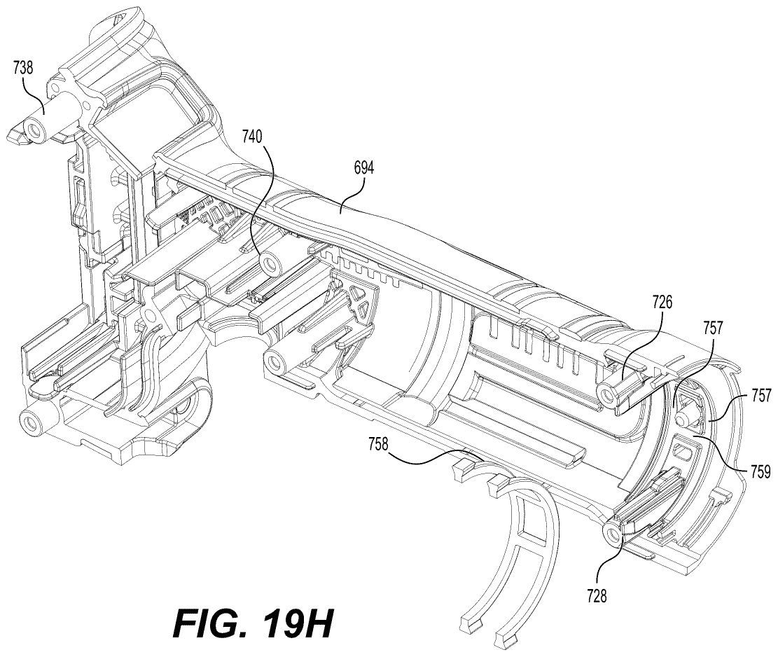

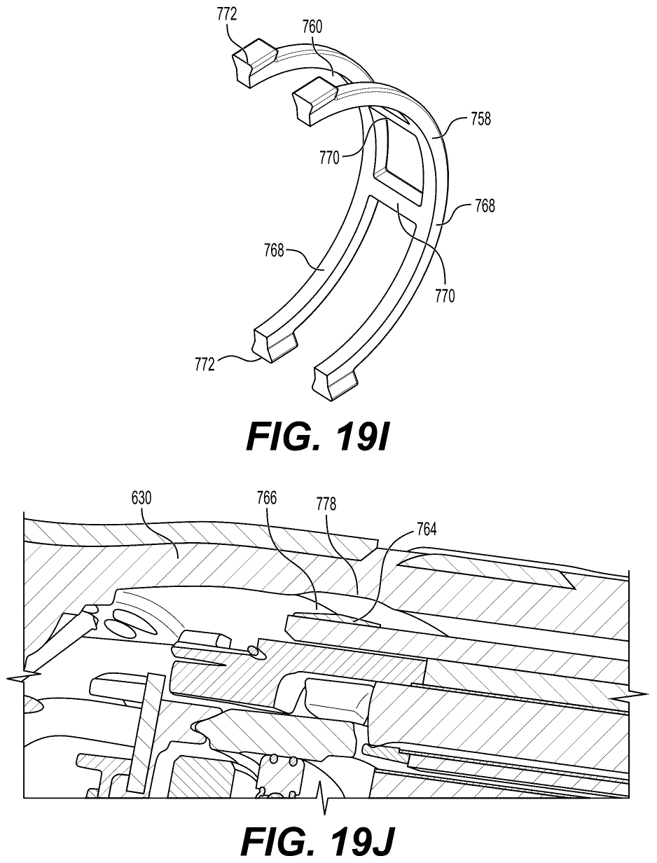

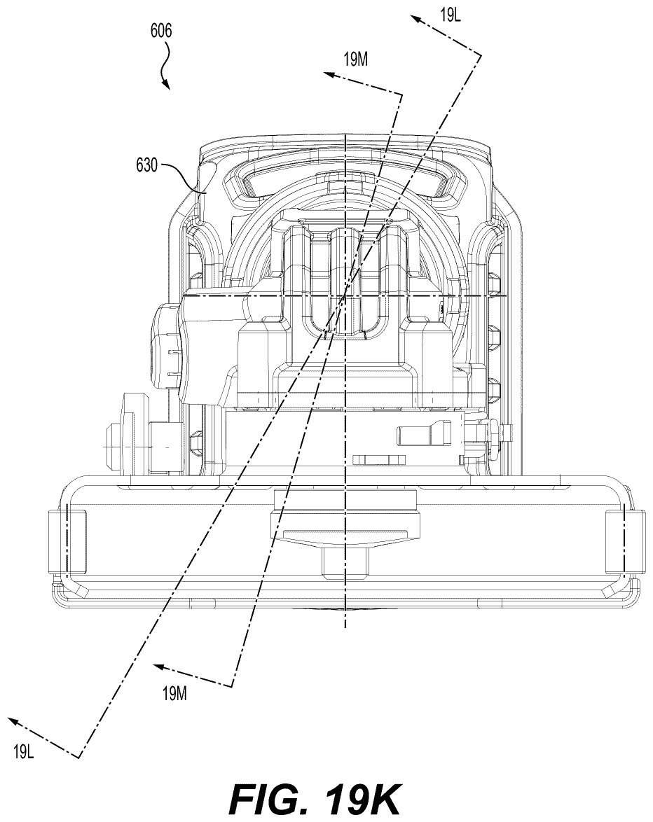

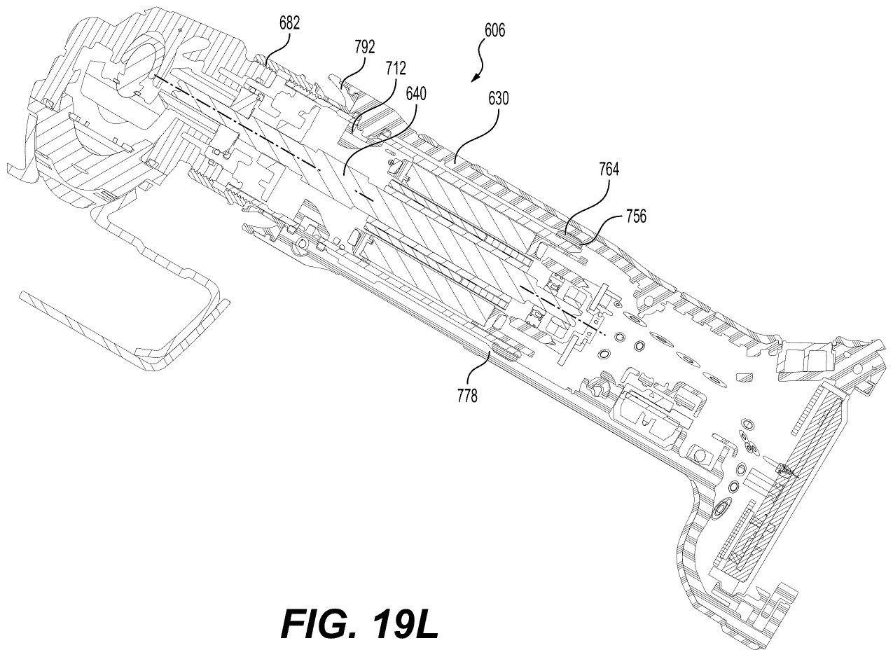

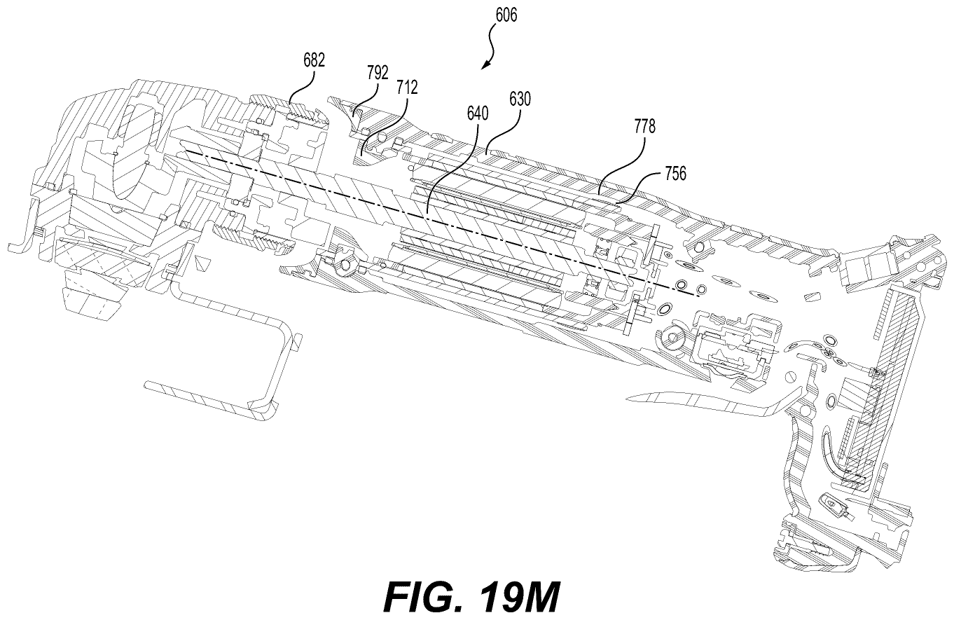

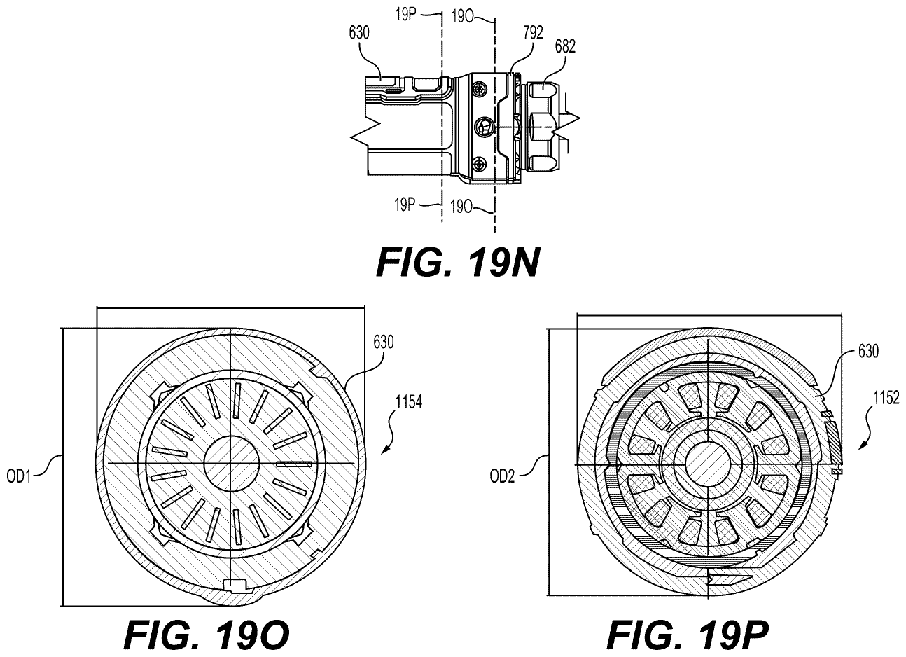

Referring to FIGS. 18F, 19B, and 19C, in an embodiment, an outer diameter of the motor fan 646 is equal to or less than an outer diameter of the fan baffle 712. In an embodiment, the motor fan 646 is sized to be received within the body 753 of the motor housing 638 near a front end thereof. The fan baffle 712 is axially spaced from the end 710 of the stator winding 708 and the motor fan 646. The fan baffle 712 includes a first side 746 and a second side 748 positioned opposite the first side 746, with the central opening 714 of the fan baffle 712 being larger at the first side 746 than the second side 748, although other suitable fan baffle arrangements may be utilized. In an embodiment, the motor housing 638, the fan baffle 712, and the motor fan 646 include substantially the same construction and geometry across the power tools 602, 606, 610, 614, 618, 622, 626.

In an embodiment, the above-described arrangement provides for a platforming approach to manufacturing and assembly of the power tools described herein, using the same components across the family of power tools 602, 606, 610, 614, 618, 622, 626 in the most cost-effective and reliable way possible. With this platforming approach, substantially all the back-end assembly features are the same across the family of power tools 602, 606, 610, 614, 618, 622, 626—except in some embodiments the peripheral switch 652, the winding pattern of the stator windings, the rotor magnet grades, and/or the output mechanism of the motor shaft 640 may vary from one power tool to the another. Further, while the motor control module 625 is structurally substantially the same across the family of power tools, it may include a programming structure where certain aspects of the motor control software may be custom programmed to operate the motor 636 in accordance the power tool output requirements. This allows the power tool designers to utilize many of the existing parts and assemblies to reduce design time, testing complexities, and manufacturing costs.

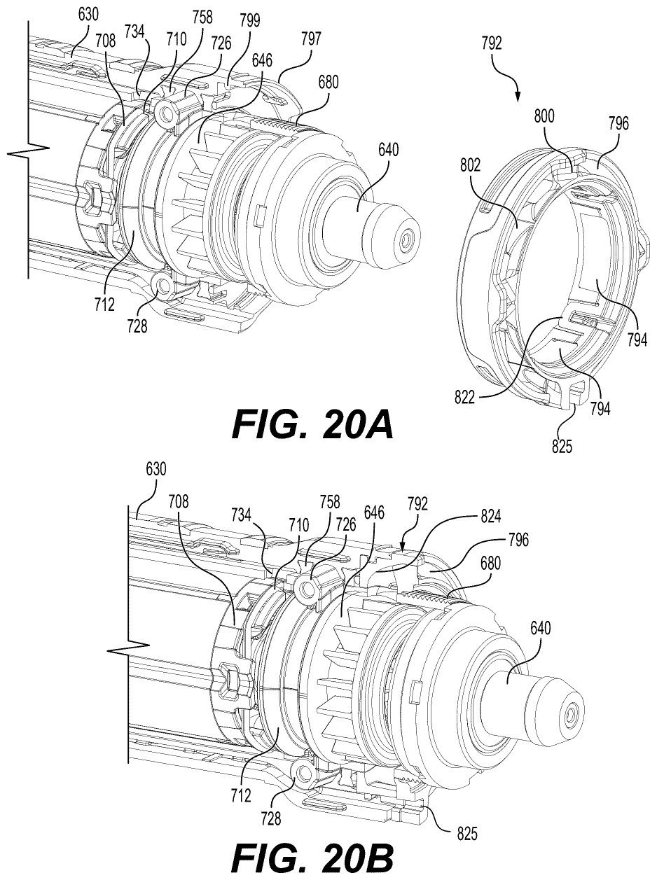

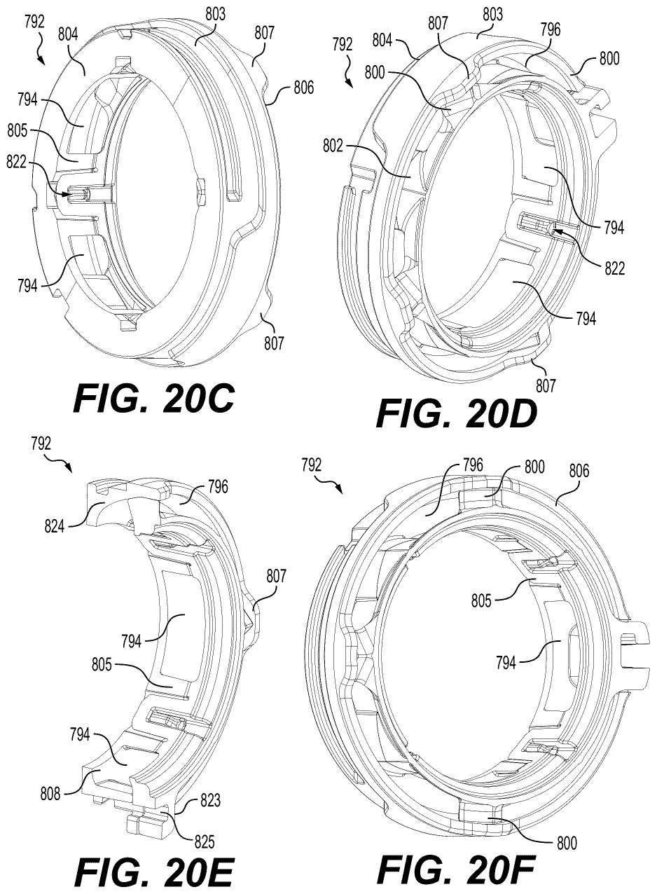

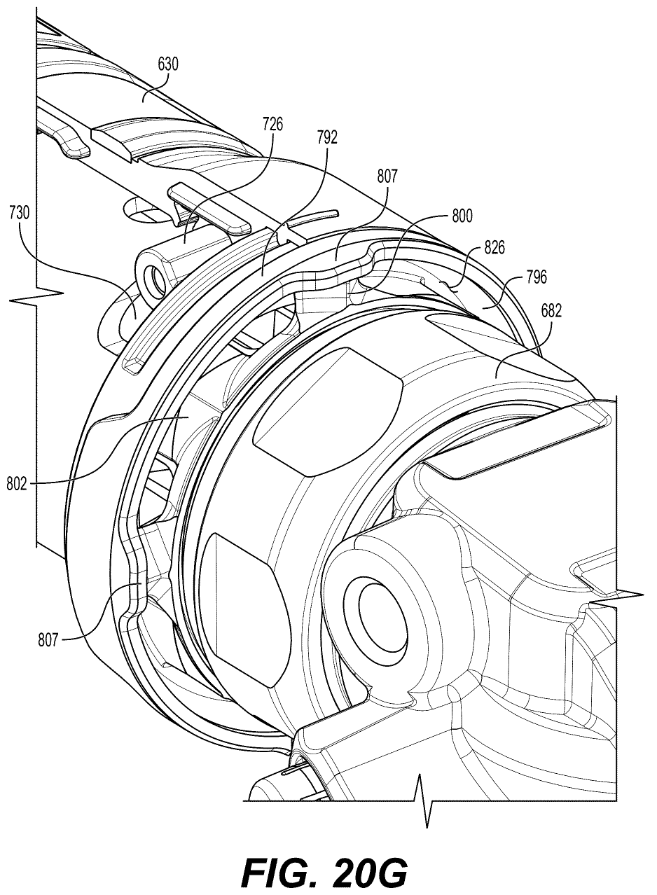

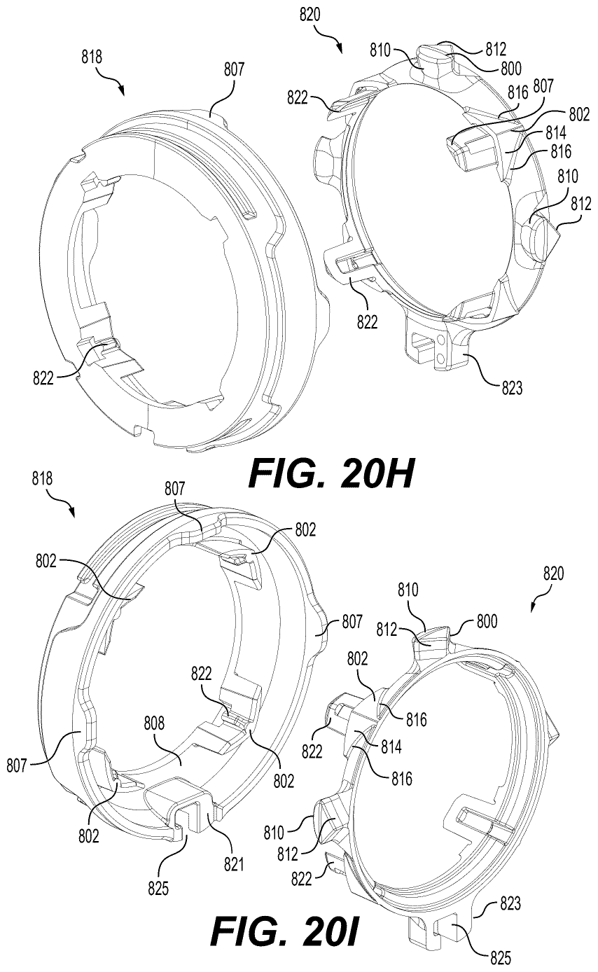

Various aspects of this disclosure are described herein with reference to FIGS. 18A-21B. These aspects relate to motor cooling features that provide optimal airflow through the power tools 602, 606, 610, 614, 618, 622, 626 to cool the motor 636 and its associated components to maintain the operating temperature of the motor 636 at or below an acceptable temperature threshold even while operating at high continuous power and/or high maximum power output levels.

Specifically, the electric motor 636 described herein has a small diameter (e.g., approximately less than or equal to 34 mm in stator diameter, or approximately less than or equal to 38 mm in the motor housing diameter). This leaves the stator without significant cross-sectional area to accommodate the stator windings (i.e., the number turns and/or the wire thickness) needed to deliver the amount of power required for metalworking applications, which subsequently greatly reduces the amount of room available for passage of airflow through the gaps between the stator windings.

Further, in many conventional power tools (particularly in metalworking applications), the motor fan has a larger diameter than the motor and is provided in a large diameter section of the tool housing to allow generation of significant amount of airflow through the motor and the tool housing. By contrast, the motor fan 646 according to embodiments of this disclosure is located within the motor housing 638 and has a diameter that is even smaller than the stator assembly 642. While this arrangement allows for more effective platforming of the motor components including the motor fan 646, as described above, it may adversely affect the motor thermal performance.

To compensate for these effects, the motor cooling and airflow features described herein provide optimal surface contact area of the cooling air with the motor 636, enhance air circulation, and provide an effective mechanism for the air to be exhausted out of the tool. These features, described below, individually or in combination with one another, and/or in combination with the motor control features previously described, provide a cooling mechanism that allow the motor temperature to be maintained at or below an acceptable temperature threshold even while operating at high continuous power and/or high maximum power output levels.

Referring to FIGS. 19A-19C, and 19H-19M, in an embodiment, an annular gap 750 is defined between an outer surface 752 of the motor housing 638 and an inner surface 754 of the tool housing 630 along at least a portion of a length of the motor housing 638. The annular gap 750 may be continuous or discontinuous, i.e., the annular gap 750, in an embodiment, may be formed from one or more arc-shaped gaps. The tool housing 630 of each power tool 602, 606, 610, 614, 618, 622, 626 may include a first compliant member 756 radially positioned between the motor housing 638 and the tool housing 630, with the first compliant member 756 having a first shape, and a second compliant member 758 radially positioned between the motor housing 638 and the tool housing 630, with the second compliant member 758 having a second shape different that the first shape of the first compliant member 756. The second compliant member 758 may define an opening 760 that receives at least a portion of the housing screw boss 698 or multiple openings 760 that receives each of the housing screw bosses 726, 728. The second compliant member 758 may be configured to at least partially seal a portion of the screw boss opening 702 or screw boss openings 730, 732 of the motor housing 638. The second compliant member 758 may be configured to provide a seal around the motor housing 638 to provide proper separation between high-pressure areas proximate the exhaust openings 736 and low-pressure areas upstream of the motor fan 646 and proximate the baffle 712. This prevents potential leakage and recirculation across pressure boundaries via the screw boss openings 702, 730, 732 of the motor housing 638, and ensures that the fan airflow is drawn across the length of the motor and through the baffle to optimize cooling efficiency.

In an embodiment, the first compliant member 756 includes an annular body 762 and a plurality of isolator bumpers 764 engaged with the inner surface 754 of the tool housing 630. The first compliant member 756 is configured to isolate vibration of the motor 636 from the tool housing 630. The first compliant member 756 may be made of resiliently deformable material such as rubber that deformably engages the inner surface of the tool housing 630, or hard plastic material such as nylon where the isolator bumps 764 are sized to be pressed-fit against the inner surface of the tool housing 630. The annular body 762 of the first compliant member 756 is engaged with the outer surface 752 of the motor housing 638 while the isolator bumps 762 engage the inner surface 754 of the tool housing 630. An air gap 766 is defined between the first compliant member 756 and the inner surface 754 of the tool housing 630 circumferentially between each of the plurality of isolator bumpers 764. The air gaps 766 lead to the annular gap 750, which extends around the periphery of the motor housing 638 up to the location of the second compliant member 758.

In an embodiment, the plurality of isolator bumps 764 are equally spaced around a circumference of the first compliant member 756. Each of the plurality of isolator bumps 764 may include a substantially semi-cylindrical outer profile extending along the longitudinal axis, with tapered portions at each end to guide air airflow into the air gap 766. In an embodiment, in addition to forming air gaps 766 for flow of air around the motor housing, the plurality of isolator bumps 764 are designed to reduce and/or dampen the transmission of vibration from the motor 636 to the tool housing 630. Furthermore, the isolator bumps 764 account for any radial tolerances associated with the manufacturing of the tool housing 630 and/or the motor housing 638.

In an embodiment, the second compliant member 758 may be made of resiliently deformable material such as rubber that deformably and is engaged with the tool housing 630 and the motor housing 638 to substantially seal the annular gap 750 from a front side of the tool housing 630 and force the airflow passing through the annular gap 750 into the motor housing 638 through the inlet openings 734. The second compliant member 758 is sized to compress between the outer surface 752 of the motor housing 638 and the inner surface 754 of the tool housing 630. This allows it to provide a full seal around the motor housing 638 while accounting for any radial tolerances associated with the manufacturing of the tool housing 630 and/or the motor housing 638. The second compliant member 758 includes first and second sealing ribs 768 connected to each other via at least one cross rib 770, although other suitable arrangements, such as one or more sealing ribs 768, may be utilized. In an embodiment, the inner surface 754 of the tool housing 694 includes annular grooves 757 within which the first and second sealing ribs 768 are partially nested, and one or more axial grooves 759 within the at least one cross rib 770 is partially nested. This is best shown in the first portion 694 of the tool housing 694 in FIG. 19H, where the annular grooves 757 are formed on two sides of the housing screw bosses 726, 728.

In an embodiment, the second compliant member 758 may further include lugs 772 extending from the first and second sealing ribs 768, with the lugs 772 connecting and locking the first and second sealing ribs 768 to the tool housing 630. The lugs 772 project outwardly from the second compliant member 758 to engage corresponding slots 761 in the tool housing 630. In an embodiment, this arrangement secures the first and second sealing ribs 768 adjacent two axial ends of the first and second screw boss openings 730, 732 of the motor housing 638 in order to prevent or minimize leakage of air in and out of the motor housing 638 through the first and second screw boss openings 730 and 732, and prevent or minimize recirculation of fan exhaust air from exhaust openings 736 back into screw boss openings 730, 732 and inlet openings 734. The second compliant member 758 may be axially positioned between the end 710 of the stator winding 708 and the motor fan 646. The second compliant member 758 is axially positioned between the inlet openings 734 and the exhaust openings 736 of the motor housing 638. The housing screw boss 698 or housing screw bosses 726, 728 may be positioned within the second compliant member 758 in a longitudinal direction of the tool housing 630.

In an embodiment, the first compliant member 756 and the second compliant member 758 cooperate to minimize or prevent contact between the motor housing 638 and the tool housing 630, and thus maintain the annular gap 750 around the outer surface of the motor housing 638.

Referring to FIGS. 19A-19G, in an embodiment, the exhaust openings 736 of the motor housing 638 are axially spaced from the inlet openings 734 of the motor housing 638. The inlet openings 734, which may be one or more inlet openings 734, are located at least partially forward of the stator assembly 642 and rearward of the motor fan 646, with an airflow generated by the motor fan 646 passing at least partially through the annular gap 750 and along the outer surface 752 of the motor housing 638 and enters the motor housing 638 through the inlet opening(s) 734.

The airflow generated by the motor fan 646 of each power tool may include a first airflow path 774 and a second airflow path 776, with the first airflow path 774 extending through the annular gap 750 around the outer surface 752 of the motor housing 638 through the inlet openings 734, and into the fan baffle 712, and with the second airflow path 776 extending through the inside of the motor housing 638 (i.e., through the stator and in contact with the stator windings 708) and merging with the first airflow path 774 at a location between the stator assembly 642 and the motor fan 646 proximate the fan baffle 712 . . . . The combined airflow passing through the fan baffle 712 is directed into the fan 646 and exhausted through the exhaust openings 736. The exhaust opening(s) 736 may be radially aligned with the motor fan 646, with the airflow exhausted from the motor fan 646 through the exhaust opening(s) 736. The motor fan 646 may be positioned closer to the second end 706 of the motor shaft 640 than the first end 704 of the motor shaft 640, with air configured to move through the first airflow path 774 and the second airflow path 776 in a direction extending from the first end 676 of the motor housing 638 to the second end 678 of the motor housing 638. At least a portion of the inlet openings 734 may be aligned with the end 710 of the stator winding 708 of the motor 636 in a radial direction. With this arrangement, the airflow generated by the fan 646 cools the motor assembly at two points of contact, i.e., at the outer surface of the motor housing 638 via the first airflow path 774 and through the stator via the second airflow path 776, maximizing the surface contact area between the airflow and the components of the motor assembly inside and outside the motor housing 638 for optimal thermal management of the motor. The alignment of the inlet openings 734 with the end 710 of the stator winding 708 of the motor 636 is configured to ensure that the first airflow path 774 bypasses the stator before entering into the motor housing 638. In addition, as the second airflow path 774 flows into the motor housing 638 through the inlet openings 734, it passes in contact with the end 710 of the stator winding 708 to further convey heat away from the stator winding 708 allowing for increased performance of the motor 636. The curved inner surface 716 of the fan baffle 712 is configured to merge the first airflow path 774 and the second airflow path 776 towards a center portion of the motor fan 646.

Referring to FIG. 18A, in an embodiment, the tool housing 630 defines intake openings 798 configured to receive air pulled from an exterior of the tool housing 630 by the motor fan 646 into the tool housing 630 and through the first and second airflow paths 774, 776 as discussed above. The intake openings 798 may include a filter or other suitable arrangement. In an embodiment, intake openings 798 may be located proximate the battery receptacle 629.

Referring to FIGS. 19J-19M, in an embodiment, a portion of the tool housing 630 defines a groove 778, with at least a portion of the groove 778 aligned with the first compliant member 756 in a radial direction. The groove 778 is configured to maximize a cross-sectional gap between the annular body 762 of the first compliant member 756 and the tool housing 630. Without the groove 778, the first compliant member 756 may restrict the airflow along the airflow path 774, and the sudden reduction in the cross-sectional gap around the first compliant member 756 may increased velocity and pressure drop. The arrangement of the groove 778 reduces air velocity within the airflow path 774 and minimizes pressure drop and restriction across compliant member 756 and tool housing 630. Groove 778 thereby contributes to ensuring sufficient airflow to maintain performance of each power tool 602, 606, 610, 614, 618, 622, 626. Each of the isolator bumpers 764 is engaged with the inner surface of groove 778 of the tool housing 630, with the air gap 766 defined between the annular band 762 of the first compliant member 756 and the inner surface 754 and groove 778 of the tool housing 630 between each of the plurality of isolator bumpers 764. The groove 778 ensures the cross-sectional free area between the first compliant member 756 and the tool housing 630 is not restricted relative portions of the motor housing 638 and the tool housing 630 where the first compliant member 756 is not present. In an embodiment, the groove 778 is formed around the first compliant member 756 and arranged to receive the plurality of isolator bumpers 764 therein, with the groove 778 having a depth that corresponds approximately to a thickness of the first compliant member 756 to allow passage of air between the first compliant member 756 and the tool housing 630 through air gaps 766 formed circumferentially between the isolator bumpers 764. In other words, the distance between the outer surface of the compliant member 756 and the inner surface of the groove 778 as measured within the air gaps 766 is approximately equal to the size of the annular gap 750 around the outer surface of the motor housing 638. This ensures that airflow along the first airflow path 774 into the annular gap 750 does not experience increased static pressure drop across the compliant member 756. The isolator bumps 764 are arranged to engage the inner surface of the tool housing 630 within the groove 778.

Referring to FIG. 19D, a computer aided fluid simulation model of each power tool 602, 606, 610, 614, 618, 622, 626 showing flow isolines and relative pressure color/shading gradient scale within the power tool 602, 606, 610, 614, 618, 622, 626, with multiple airflow paths 774, 776 is shown. A relative pressure gradient is shown extending from the first end 632 of the tool housing 630 through the first and second airflow paths 774, 776 until reaching the exhaust openings 736. As shown here, no significant static pressure drops are observed along the first airflow path 774 into the annular gap 750 as the air passes the first compliant member 756, which would be made evident by a drastic change in color/shading upstream versus downstream of compliant member 756.

Referring to FIGS. 19B-19G, in an embodiment, the exhaust opening 736 is radially aligned with the motor fan 646 to allow the airflow generated by the fan 646 to be expelled from the motor housing 638. In an embodiment, the inner surface 754 of the motor housing 638 may be contoured on circumferential sides of the exhaust openings 736 to provide a centrifugal effect for the airflow as it is expelled through the exhaust openings 736. This arrangement allows air to be exhausted through the exhaust openings 736 in a substantially radial-tangential direction. Further, in an embodiment, since the motor is designed to rotate in both direction in at least some of the power tools 602, 606, 610, 614, 618, 622, 626, the contoured surface in the motor housing 638 may be provided on both circumferential aides of the exhaust openings 736 to provide this centrifugal effect in both directions of rotation of the motor fan 646.

In an embodiment, in the motor housing 638 of each power tool 602, 606, 610, 614, 618, 622, 626, the exhaust openings 736 include a first exhaust opening 780 and a second exhaust opening 782 circumferentially spaced from the first exhaust opening 780, with an inner surface 784 of the motor housing 638 defining a recessed portion 786 extending from the first exhaust opening 780 to the second exhaust opening 782. The recessed portion 786 is aligned with the motor fan 646 to guide an airflow generated by the motor fan 646 in a substantially tangential direction through at least one of the first exhaust opening 780 or the second exhaust opening 782 in both clockwise and counterclockwise rotations of the motor shaft 640. As shown in FIGS. 19E and 19F, a depth of the recessed portion 786 varies along a circumferential direction such that the motor housing 638 has a smaller thickness alongside longitudinal edges 787 of the first exhaust opening 780 and the second exhaust opening 782 that extend along a longitudinal axis of the motor 636 than alongside lateral edges 789 of the first exhaust opening 780 and the second exhaust opening 782 that extend along a circumferential direction of the motor housing 638. The depth of the recessed portion 786 decreases as the recessed portion 786 extends away from each of the first exhaust opening 780 and the second exhaust opening 782. The depth of the recessed portion 786 is smallest at a midpoint between the first exhaust opening 780 and the second exhaust opening 782. A width of the recessed portion 786 also varies along a circumferential direction. The width of the recessed portion 786 decreases as the recessed portion 786 extends away from each of the first exhaust opening 780 and the second exhaust opening 782. The width of the recessed portion 786 is smallest at a midpoint between the first exhaust opening 780 and the second exhaust opening 782. The first and second exhaust openings 780, 782 are each elongate in a circumferential direction of the motor housing 638, although other suitable shapes may be utilized.

In an embodiment, the exhaust openings 736 of the motor housing 638 further includes a third exhaust opening 788 and a fourth exhaust opening 790, with the first exhaust opening 780, the second exhaust opening, 782, the third exhaust opening 788, and the fourth exhaust opening 790 equally spaced around a circumference of the motor housing 638. The motor housing 638 defines a second recessed portion 786 extending from the second exhaust opening 782 to the third exhaust opening 788, a third recessed portion 786 extending from the third exhaust opening 788 to the fourth exhaust opening 790, and a fourth recessed portion 786 extending from the fourth exhaust opening 790 to the first exhaust opening 780. Although each of the recessed portions 786 are not shown in FIG. 19E, each of the recessed portions 786 are identical to the recessed portion 786 shown in FIG. 19E. Other suitable size exhaust openings 780, 782, 788, 790 and number of exhaust openings 780, 782, 788, 790 may be utilized.

In an embodiment, the motor fan 646 is aligned with at least a portion of the first and second exhaust openings 780, 782 in a radial direction. The motor fan 646 is configured to pull air from the first end 632 of the tool housing 630 through the tool housing 630 and the motor housing 638 and fan baffle 712, and then to expel air through the exhaust openings 780, 782, 788, 790 of the motor housing 638. The exhaust openings 780, 782, 788, 790 and the corresponding recessed portions 786 of the motor housing 638 are configured to circulate the air driven by the motor fan 646 substantially centrifugally around the motor fan 646 and direct at least a portion of the air driven by the motor fan 646 in a substantially radial-tangential direction relative to the motor housing 638. Due to the contoured profile of the recessed portions 786 on both sides of each exhaust openings 780, 782, 788, 790, this effect may be realized in both direction of the rotation of the motor fan 646. In an embodiment, the exhaust openings 780, 782, 788, 790 and the corresponding recessed portions 786 of the motor housing 638 are configured to act as a volute, e.g., increasing cross-sectional area of an opening that directs air to the exhaust openings 780, 782, 788, 790.

The airflow arrangement described here provides an effective way of maintaining the temperature of the motor 636, particularly as measured at the motor windings 708, at an acceptable temperature level while providing a high continuous power output from the motor. In an embodiment, using this construction, the motor temperature can remain below approximately 150 degrees Celsius as measured at the motor windings while running the motor at the continuous power output of greater than 470 watts out for a long duration of time, e.g., through an entire discharge cycle of a battery pack from approximately full charge until the battery reaches the discharge voltage threshold. In an embodiment, to accomplish this, the fan generates an airflow in the range of approximately 4.2 SCFM to 6.6 SCFM, as measured through the exhaust opening 736, while operating at a rotational speed of approximately 24,000 RPM to 30,000 RPM.

In an embodiment, the motor 636 is configured to maintain an operating motor output speed in the range of approximately 26,000 to 32,000 Rotations-Per-Minute (RPM), and the motor fan 646 is configured to generate the airflow in the range of approximately 6.1 to 6.8 Standard Cubic Feet per Minute (SCFM) as measured out of the motor fan 646.

In an embodiment, the motor 636 is configured to maintain an operating motor output speed in the range of approximately 22,000 to 28,000 Rotations-Per-Minute (RPM), and the motor fan 646 is configured to generate the airflow in the range of approximately 4.1 to 4.8 Standard Cubic Feet per Minute (SCFM) as measured out of the motor fan 646.

Referring to FIGS. 6A-10D and 19N-19P, in an embodiment, the first section 1152 and the second section 1154 of tool housing 630 are shown, with the second section 1153 of the tool housing 630 positioned closer to the first end 632 of the tool housing 630 than the first section 1152 of the tool housing 630. The motor fan 646 of each power tool 602, 606, 610, 614, 618, 622, 626 is axially aligned with the second section 1154 of the tool housing In an embodiment, the maximum outer diameter OD2 of the first section 1152 of the tool housing 630 (i.e. the diameter of the tool housing around the motor) is in the range of approximately 44 mm to 49 mm, preferably approximately 45 mm to 47 mm. In an embodiment, the maximum outer diameter OD1 of the second section 1154 of the tool housing 630 (i.e., the diameter of the tool housing around the motor fan) is approximately 47 mm to 53 mm, preferably in the range of approximately 49 mm to 52 mm. Accordingly, in an embodiment, the diameter of the motor housing around the motor fan is only approximately 8% to 12% greater than the diameter of the tool housing around the motor. Despite this insignificant change in the tool diameter to accommodate the motor, the motor is capable of generating sufficient airflow through and around the motor housing 638 to sufficiently cool the motor, even at high operating power conditions. In an embodiment, as discussed later in detail, in tools such as power tool 602 (4.5-inch angle grinder) and power tool 606 (4-inch angle grinder), the fan generates airflow in the range of approximately 4.2 SCFM to 6.6 SCFM, as measured through the exhaust opening 736, while operating at a rotational speed of approximately 24,000 RPM to 30,000 RPM. This arrangement allows the motor 636 is configured to provide a continuous power output of at least approximately 520 watts while a temperature of the motor 636 as measured on stator windings supported by the stator assembly 642 is maintained at below approximately 150 degrees C. and/or a temperature of the motor 636 as measured at the stator lamination stack is maintained at or at below approximately 110 degrees C.

In an embodiment, the combination of the recited maximum outer diameter and the recited continuous power output beneficially provides each of the power tools 602, 606, 610, 614, 618, 622, 626 with a relatively compact tool and higher power output, i.e., the power tools 602, 606, 610, 614, 618, 622, 626 beneficially have a higher power density compared to conventional power tools. In an embodiment, the continuous power output can be sustained with the maximum outer dimeter values recited above while operating under the temperature values discussed above due to the airflow provided by the motor fan 646 and the related features discussed herein.

Referring to FIGS. 19A-21B, in an embodiment, each of the power tools 602, 606, 610, 614, 618, 622, 626 include a diffuser 792 having a plurality of inlets 794 and an outlet 796, with the inlet 794 in fluid communication with the exhaust opening 736 of the motor housing 638. The diffusor 792 is configured to collect the air that is expelled through the exhaust openings 736 in a substantially radial-tangential direction and direct it in a substantially forward-tangential direction extending from the first end 632 of the tool housing 630 to the second end 634 of the tool housing 630. The diffuser 792 ensures that the outgoing air does not interfere with the user's grip of the power tool around the handle section of the tool housing. Further, the outgoing air is guided around the outer surface of the front-end assembly 604, 608, 612, 616, 620, 624, 628, which helps cool the gear assembly and/or other components of the front-end assembly 604, 608, 612, 616, 620, 624, 628. In addition, by maintaining tangential direction of the outgoing air, the diffuser 792 ensures that the change in direction of the airflow does not hinder the flow of air out of the exhaust openings 736.

In an embodiment, the diffusor 792 includes a substantially annular (i.e., ring-shaped) body 803 including a first end 804 and a second end 806 positioned opposite the first end 804, with the plurality of inlets 794 facing a radially inward direction from an inner surface 805 of the annular body 803 that is located between the first end 804 and the second end 806. When the diffuser 792 is mounted around the outer surface 752 of the motor housing 638, the exhaust opening 736 and the inlets 794 of the diffuser 792 become respectively substantially aligned, providing fluid communication between the exhaust openings 736 of the motor housing 638 and the diffuser 792, and thus allowing entry of air into the annular body 803 of the diffuser 792. In an embodiment, as discussed above, the motor housing 638 defines four exhaust openings 780, 782, 788, 790 aligned with four respective inlets 794 of the diffuser 792, although one or more exhaust openings 780, 782, 788, 790 and inlets 794 may be provided. In an embodiment, the plurality of inlets 794 of the diffuser 792 extend to the outlet 796 of the diffuser 792 though air paths provided within the annular body 803. The outlet 796 is substantially annular in a forward-facing direction and positioned at the second end 806 of the diffusor 792, although other suitable arrangements may be utilized. Within the annular body 803, the diffuser 792 includes first and second air deflectors 800, 802 along the air paths, shaped to guide air to be expelled in a substantially forward-tangential direction through the outlet 796. This geometry is provided to expel air in the forward-tangential direction regardless of whether the motor fan 646 spins in a first rotational direction or a second rotational direction, with the first rotational direction opposite to the second rotational direction. In other words, the motor fan 646, the motor housing 638, and the diffuser 792 are bi-directional and configured to provide similar airflow when the motor 636 is run in a forward rotational direction or a reverse rotational direction.

In an embodiment, the diffusor 792 may be constructed using a two-piece assembly that includes a first piece 818 connected to a second piece 820 via locking tabs 822. The first piece 818 of the diffuser 792 forms the first end 804 of the diffuser 792, the outer circumferential surface of the annular body of the diffuser 792, and a first portion of the inner surface 805 of the annular body 803 of the diffuser 792. The second piece 820 is mounted into the first piece 818 and forms a second portion of the inner surface 805 of the annular body 803 of the diffuser 792. The first and second portions of the inner surface 805 of the annular body 803 cooperatively form the inlets 794. Further, the first and second portions of the inner surface 805 of the annular body include male and female locking tabs 822 that engage one another around the inlets 792 to secure the first and second pieces 818 and 829. The outlet 796 is formed by an annular gap located between the second piece 820 and the first piece 818 at the second end 806. This two-piece construction allows for molding of the air deflectors 800 and 802 within the diffuser 792, though in an embodiment, it is envisioned that the diffuser 792 may be formed via a single-piece construction and/or single step molding process. In an embodiment, the first piece 818 includes a recessed portion 821 and the second piece 820 includes a bridge 823 aligned with the recessed portion 821. Together, the recessed portion 821 of the first piece 818 and the bridge 823 of the second piece 820 cooperatively form a wire passage channel 825 at a lower end of the diffuser 792 for passage of a wiring from the front-end assembly (e.g., for power tools that includes a light mounted on the front-end assembly) to the tool housing 603.

In an embodiment, the second air deflectors 802 are positioned circumferentially around the inlets 794 and abut the wall 808 positioned at the first end 804 of the diffuser 792. The second air deflectors 802 are cooperatively formed by the first and second pieces 818 and 820. The second air deflectors 802 extend laterally from the locking tab 822 to the sides (i.e., short sides and/or axial sides) of the inlets 794, and thus are oriented substantially tangentially with respect to the inlets 794 a direction that leads towards the outer surface of the annular body. The tangential orientation of the second air deflectors 802 relative to the inlets 794 is configured to guide the air received through the inlets 794 in a centrifugal direction through the diffuser 792. Further, in an embodiment, each second air deflector 802 includes a tapered body 814 narrowing in a direction extending from the first end 804 of the diffuser 792 to the second end 806 of the diffuser 792. The tapered body 814 of the second air deflector 802 includes concave surfaces 816. Additionally, in an embodiment, the diffusor 792 includes a curved interior surface 824 extending from the rear sides (i.e., rear long sides and/or rear circumferential sides) of the inlets 794 to the outlet 796 of the diffuser 792, with the outlet 796 of the diffuser 792 aligned with a plane extending perpendicularly to a longitudinal axis of the tool housing 630. These features cooperate to centrifugally guide and sweep the air towards the second end 806 of the diffuser 792. In an embodiment, four second air deflectors 802 are provided equidistantly within the diffuser 702, each extending bidirectionally relative to a respective locking tab 822.

In an embodiment, the first air deflectors 800 are spaced from the second air deflectors 802 and are positioned at the outlet 796 of the diffuser 792. The first air deflectors 800 are formed by the second piece 820 and are aligned the plurality of inlets 794 of the diffuser 792. In an embodiment, each first air deflector 800 includes a rounded surface 810 facing the first end 804 of the diffuser 792 and a tapered portion 812, with the tapered portion 812 narrowing in a forward direction. The first air deflectors 800 intercept and tangentially deflect the air passing within the diffuser 792. In an embodiment, four first air deflectors 800 provided equidistantly and alternatingly with the second air deflectors 802.

Further, in an embodiment, the diffuser 792 includes a series of axial deflectors 807 projecting axially from the second end 806 of the diffuser 792. The axial deflectors 807 are located radially outwardly of the first air deflectors 800 and are configured to prevent flow of air out of the outlet 796 along a radial plane. In an embodiment, the first air deflectors 800 and the axial deflectors 807 cooperate to guide the air in a substantially forward-tangential direction out of the outlet 796.

Referring to FIG. 19F, in an embodiment, the motor housing 638 projects axially forward of a front end of the tool housing 630, and the diffuser 792 is mounted to the front end of the motor housing 638 in radial alignment with the exhaust opening(s) 780, 782, 788, 790. The front end of the tool housing 630 includes an annular lip 797 that circumferentially supports a portion of the diffuser 792, with the annular lip 797 radially aligned with the exhaust opening(s) 780, 782, 788, 790. The diffuser 792 includes a frontal portion 801 that is axially forward of the annular lip 797 and defines the outlet 796 circumferentially around the motor housing 638 axially forward of the exhaust opening(s) 780, 782, 788, 790. In one embodiment, the annular lip 799 is an inwardly-projecting rim 799 that engages and axially constrains the diffuser 792.

In an embodiment, the threaded portion 680 of the motor housing 638 is located forward of the exhaust openings 736 so that the collar 682, as engaged with the threaded portion 680 of the motor housing 638, is located proximate (and in some embodiments in contact with) the second end 806 of the diffuser 792. The outlet 796 of the diffuser 792 define an annular air gap 826 around the motor housing 638 that is bound circumferentially by the first end 632 of the tool housing 630 and is axially approximately aligned with a rear end of the collar 628. Thus, the air coming out of the diffuser 792 through the annular gap 826 has a first point of contact with the collar 628. From there, in tools such as the angle grinders, the air passes in contact with at least portions of the gear case to provide some cooling effect on the gear case components. The annular gap 826 may be continuous or discontinuous, i.e., the annular gap 826, in an embodiment, may be formed from one or more arc-shaped gaps. The annular air gap 826 is configured to allow a person to grip each of the power tools 602, 606, 610, 614, 618, 622, 626 at or toward the second end 634 of the tool housing 630 without interfering with the airflow through each power tool 602, 606, 610, 614, 618, 622, 626. This arrangement provides an advantage over some conventional power tools, where the motor fan exhaust commonly exits through opening in a side of the power tool, which can prevent a person from grasping the conventional power tool in that area or inhibiting airflow through the power tool by obstructing the airflow exit.

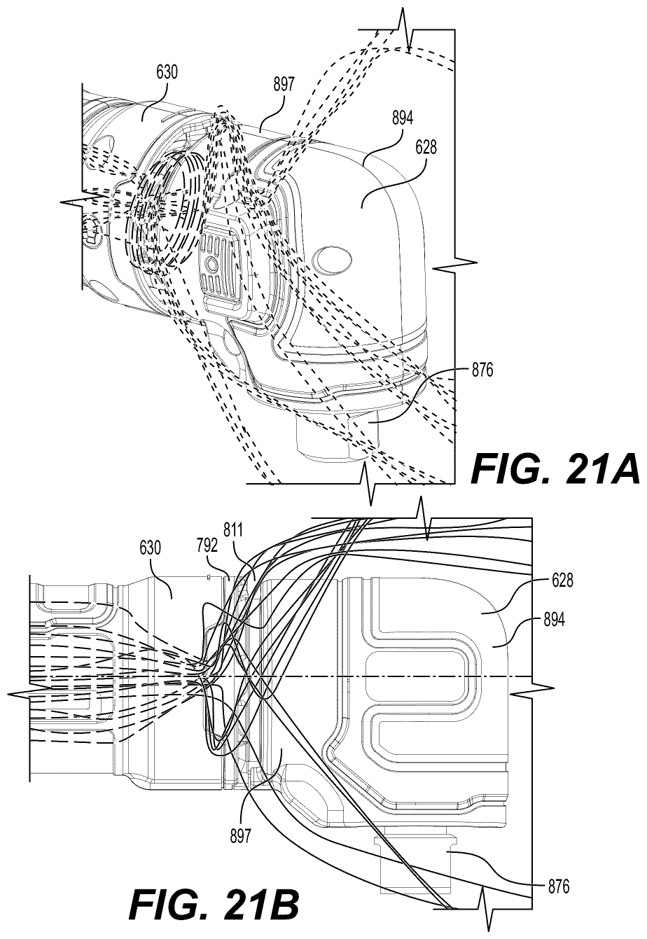

Referring to FIGS. 21A and 21B, in an embodiment, views of an exemplary power tool that is provided with a shroud 894 around the gear case or housing 872, in this example an angle die grinder 626, are shown. In an embodiment, the shroud 894 is mounted around the gear case 872 and a rear annular portion 897 of the shroud 894 is mounted at least partially around a front portion of the collar 628. The rear annular portion 897 of the shroud 894 includes approximately the same diameter as the tool housing 630 but is distanced from the front of the diffuser 792, forming a circumferential exhaust vent 811 therebetween around a part of the collar 628. The circumferential exhaust vent 811 is in fluid communication with the outlet 796 of the diffuser 792 to direct airflow in a direction extending from the first end 632 of the tool housing 630 to the second end 634 of the tool housing 630. Due to the structure of the diffuser 792 discussed above, which provides an air output projectile in a forward-tangential direction, the air passing though the circumferential exhaust vent 811 is directed in a substantially helical shape over the outer body of the shroud 894 and an output spindle 876 to provide a cooling effect on the gear case components. In an embodiment, the rear annular portion 897 of the shroud 894 is tapered to avoid interference with the forward-tangential direction of the airflow around the shroud 894.

Front-end assemblies 604, 608, 612, 616, 620, 624, 628 of each of the power tools 602, 606, 610, 614, 618, 622, 626 are described herein with reference to FIGS. 22A-28I, according to various embodiments.

Referring to FIGS. 3D-3J, 22A-22E, and 23A-23E, in an embodiment, the front-end tool assemblies 604, 608 of each of the power tools 602, 606, which may be a 4.5-inch angle grinder and a 4-inch angle grinder, respectively, include a gear housing 830 having the internal housing thread 190, a spindle 832 at least partially positioned within the gear housing 830, a spindle-mounted gear 834 positioned on the spindle 832 and drivable by the motor shaft 640. The spindle-mounted gear 834 may be the same or similar to the output bevel gear 174B discussed above and includes the spindle lock recess 168. The power tool 602 includes a retractable spindle lock 836, which is configured to move in a lateral direction with respect to the spindle 832 from a first position where the retractable spindle lock 836 is spaced from the spindle lock recess 168 to a second position where the retractable spindle lock 836 is configured to lock the spindle 832. The retractable spindle lock 836 may be the same as the retractable spindle lock 162, with the retractable spindle lock 836 including the pin 176, the pin shaft 178, and the pin head 180 having the pin head diameter 182D configured to be at least partially received within the spindle lock recess 168 when the retractable spindle lock 836 is in the second position. The retractable spindle lock 836 also includes the threaded insert 184 slidingly positioned on the pin shaft 178. The threaded insert 184 includes the threaded insert borehole 186 configured to be smaller than the pin head diameter 182D and the external insert thread 188 configured to engage the internal housing thread 190. The retractable spindle lock 836 may further include the spring 192 configured to bias the pin 176 toward the first position.

In an embodiment, the gear housing 830 further includes the first borehole 199A adjacent to the spindle lock recess 168, a second borehole 199B including the internal housing thread 190 spaced from the first borehole 199A, and the housing opening 199C spaced from the second borehole 199B, with the first borehole 199A having the first diameter 182A, the second borehole 199B having a second diameter 182B larger than the first diameter 182A of the first borehole 199A, and the housing opening 199C having the housing opening minimum width 182C that is larger than the second diameter 182B. The housing opening 199C is configured to allow a portion of the button member 194 coupled to the button end 196 of the pin shaft 178 to be received within the gear housing in the same manner as discussed above. In an embodiment, the housing opening 199C is configured to allow the button member 194 coupled to the button end 196 of the pin shaft 178 to be entirely received within the gear housing. As discussed above, the button member 194 may include the spring seat 198, with the spring 192 positioned between the spring seat 198 and the threaded insert 184.

In an embodiment, the power tool 602 includes a bevel gear 838 coupling the motor shaft 640 to the spindle 832, with the motor shaft 640 oriented perpendicular to the spindle 832. In particular, the spindle-mounted gear 834 may be a bevel gear engaged with the bevel gear 838 of the motor shaft 640. The retractable spindle lock 836 is configured to be connected to and/or assembled with the gear housing 830 from an exterior of the gear housing 830, as discussed above in connection with the retractable spindle lock 162.

In an embodiment, a portion of the gear housing 830 defining the housing opening 199C extends further laterally outward than the tool housing 630.

In an embodiment, the gear housing 830 includes an annular member, such as the collar 682, arranged to be securely coupled adjacent the second end 634 of the tool housing 630, with a lateral width of the annular member smaller than a lateral width of the tool housing 630.

In an embodiment, an outer dimeter of the tool housing 630 at the second end 634 of the tool housing 630 is larger than an outer diameter of the collar 682, with a top surface 840 of the gear housing 830 recessed relative to the collar 682. This reduction in size or stepped profile toward the end of the front-end assembly 604 is configured to allow the power tool 602 to be utilized in tight spaces. The top surface 840 of the gear housing 830 may slope radially inward in a direction extending from the first end 632 of the tool housing 630 to the second end 634 of the tool housing 630.

Referring to FIGS. 22D and 22E, in an embodiment, the front-end assembly 604 of power tool 602 further includes a guard assembly 842, a backing flange 844 and lock nut 846 for securing a tool to the power tool 602, a first bearing 848 at a first end 850 of the spindle 832, and a second bearing 852 positioned between the first end 850 of the spindle 832 and a second end 854 of the spindle 832. The first bearing 848 may be a needle bearing received within a bearing pocket 856 defined by the gear housing 830, although other suitable bearings may be utilized. The second bearing 852 may be a ball bearing, although other suitable bearings may be utilized. The second bearing 852 is secured within a lower gearcase 858, which may be similar to the lower gearcase 104B discussed above, with the lower gearcase 858 secured to the gear housing 830 via plurality of screws 860, which may be inserted into the gear housing 830 in a direction extending perpendicularly to a longitudinal axis of the tool housing 630. The second bearing 852 is retained within the lower gearcase 858 via retaining clip 862 at one end and a gearcase cover 864 at the other end, which may be threaded within the lower gearcase 858. A retainer 866 and retainer spring 868, such as a Belleville spring, are positioned between the second bearing 852 and the gearcase cover 864, with the retainer spring 868 engaging the retainer 866 and the gearcase cover 864 and the retainer 866 engaging the second bearing 852. The guard assembly 842 is configured to be removeable and rotatable relative to the gear housing 830. The spindle 832 varies in diameter along a length extending from the first end 850 to the second end 854 and define one or more stepped portions in a similar manner as the output spindle 572 discussed above. The spindle 832 extends through the first bearing 848, through the spindle-mounted gear 834, through the second bearing 852, through the retainer 866, through the retainer spring 868, through the lower gearcase 858 and the gearcase cover 864, and through the backing flange 844 and lock nut 846.

In an embodiment, the spindle-mounted gear 834 secured to the spindle 832 driveably engages the bevel gear or pinion 838 mounted on the motor shaft 640. The gear housing 830 includes a gear case 871 that houses the spindle-mounted gear 834 and forms the bearing pocket 856 for the first bearing 848, with the gear case 871 having a lateral width that is contained within a lateral boundary of the tool housing 630. The gear housing 830 further includes a peripheral wall 870 that projects from the gear case 871 and surrounds the housing opening 199C, with the peripheral wall 870 at least partially located outside the lateral boundary of the tool housing 630. The lower gearcase is configured to form a second bearing pocket 873 that supports the spindle 832 via the second bearing 852 and a gear case cover 875 that supports the guard assembly 842 relative to the gear housing 830. The spindle-mounted gear 834 is fully located within an extension of an axial envelope formed by the tool housing 630.

The above-described embodiments describe compact front-end tool assemblies 604, 608 capable of supporting the significant power output produced by the motor 636, and outputting significant torque and power output, per unit of weight and/or volume of the front-end tool assembly. In an embodiment, as shown in FIG. 23B, a lateral width of the gear housing 830, not including the handle coupling receptacle 204 and the spindle lock 836, is smaller than or approximately equal to a diameter of the collar 682, which itself is smaller than a diameter of the tool housing 630. Further, a threaded annular end 835 of the gear housing 830 is approximately the same diameter as the motor housing 638, and as discussed above, the top surface 840 of the gear housing 830 that extends from the threaded annular end 835 is recessed relative to the collar 682. Thus, the gear housing 830 has an overall lower profile than the tool housing 630. Further, the second bearing 852 is axially aligned with the lower surface of the tool housing 630, allowing the guard 842 to be located below the lower surface of the tool housing 830 by less than approximately 13 mm. These features provide compact gear assemblies attribute to angle grinder designs that have significantly high output performance to size ratio. Table 1 below summarizes some of the key dimensional attributes of the back-end assembly 601.

TABLE 1

| | Back-End |
|---|---|
| Dimensions | Assembly |
| Back-End Length (Rear of Foot Section to | 171 to 202 |
| Front of Diffuser) (mm) | |
| Back-End Diameter (OD1) (mm) | 43 to 48 |
| Back-End Diameter (OD2) (mm) | 49 to 54 |
| Back-End Assembly Volume* (cm3) | 266 to 322 |
| Back-End Assembly Weight* (g) with 19 | 707 to 829 |
| Turns of Stator Windings | |
| Back-End Assembly Weight* (g) with 15 | 712 to 835 |
| Turns of Stator Windings | |

*Includes collar

Table 2 below summarizes some of the key dimensional attributes of power tool 602 (4.5-inch angle grinder) and power tool 606 (4-inch angle grinder), by way of example.

TABLE 2

| Dimensions | 4″ Angle Grinder | 4.5″ Angle Grinder |
|---|---|---|
| Stator Turns | 15T | 15T |
| Front-End Assembly Weight** (g) | 285 to 335 | 316 to 372 |
| Total Tool Weight (g) | 997 to 1170 | 1028 to 1207 |
| Front-End Assembly Volume** (cm3) | 77 to 85 | 83 to 91 |
| Total Tool Volume (cm3) | 349 to 387 | 355 to 393 |
| Gear Case Height (mm) | 76 to 84 | 83 to 92 |
| Output Spindle Maximum Diameter (mm) | 9 to 15 | 15 to 16.7 |
| Gear Ratio | 2.42 to 2.67 | 2.94 to 3.24 |
| Pinion (Bevel Gear) Outer Diameter (mm) | 12.4 to 13.8 | 12.2 to 13.4 |
| Spindle Gear Outer Diameter (mm) | 24.6 to 27.8 | 30.6 to 33.8 |

**Does not include collar, guard, side handles, flanges, and accessories

In an embodiment, using the front-end assembly constructions 604, 608 described above, power tool 602 (4.5-inch angle grinder) and power tool 606 (4-inch angle grinder) offer significant maximum power output, continuous power output, maximum torque, and output speed, suitable for metalworking applications such as grinding of metal surfaces and cutting metal material. Importantly, while existing cordless grinding tools are capable of outputting similar performance parameters, they are significantly larger in terms of the weight and volume of the power tool housing, and the weight and volume of the gear case assembly. Given the size and volume of the power tools 602 and 606, these tools offer the highest ratio of maximum power output, continuous power output, and/or maximum torque to the weight and/or volume of the tool. Table 3 below summarizes some of the key performance attributes of power tool 602 (4.5-inch angle grinder) and power tool 606 (4-inch angle grinder), by way of example.

TABLE 3

| Performance | 4″ Angle Grinder | 4.5″ Angle Grinder |
|---|---|---|
| Max Power * (Watts) | 735 to 775 | 735 to 775 |
| Max Power ** (Watts) | 650 to 700 | 650 to 700 |
| Max Torque * (In-Oz) | 135 to 155 | 160 to 185 |
| Max Torque ** (In-Oz) | 115 to 135 | 140 to 160 |
| Continuous (Sustained) Power * (Watts) | 535 to 565 | 535 to 565 |
| Output Speed (RPM) | 10,200 to 12,570 | 8,400 to 10,350 |
| Motor Speed (RPM) | 26,000 to 32,000 | 26,000 to 32,000 |
| Max Power * to Tool Weight Ratio (Watts/g) | 0.59 to 0.82 | 0.58 to 0.79 |
| Max Power * to Front-End Weight Ratio (Watts/g) | 2.08 to 2.86 | 1.87 to 2.58 |
| Cont. Power * to Tool Weight Ratio (Watts/g) | 0.43 to 0.60 | 0.49 to 0.58 |
| Cont. Power * to Front-End Weight Ratio (Watts/g) | 1.51 to 2.08 | 1.60 to 1.88 |
| Max Power * to Tool Volume Ratio (Watts/cm3) | 1.75 to 2.41 | 1.73 to 2.38 |
| Max Power * to Front-End Vol Ratio (Watts/cm3) | 7.96 to 10.96 | 7.44 to 10.24 |
| Cont. Power * to Tool Volume Ratio (Watts/cm3) | 1.28 to 1.76 | 1.47 to 1.73 |
| Cont. Power * to Front-End Vol Ratio (Watts/cm3) | 5.79 to 7.99 | 6.36 to 7.46 |

* 20 Second Ramp Test
** Step Test
All Tests Performed Using a 20 V Max 49 mOhm 3.5 Ah Battery Pack

These results were obtained using a power tool battery pack including a series of five lithium-based cells, with a maximum voltage of 20V and a nominal impedance in the range of 45 to 54 mOhms, preferably approximately 49 mOhms. In an example, this battery pack includes a pouch-cell construction with a capacity in the range of approximately 3.3 Amp-hours to 3.7 Amp-hours, preferably approximately 3.5 Ah. However, other types of power tool battery packs, including those constructed using cylindrical and/or tables cells, may be alternatively used. It should be understood that the power output parameters may be higher than the test results when using a lower impedance battery pack, and lower than the test results when using a higher impedance battery pack. However, it is envisioned that a power tool capable of reproducing similar parameters using a battery pack of similar voltage and impedance level would be encompassed by the teachings of this disclosure.

As shown in Table 3, in an embodiment, power tools 602 and 604 are capable of producing a maximum power output that greater than or equal to approximately 735 maximum-watts-out (MWO), preferably in the range of approximately 735 to 775 MWO, when conducting a 20 second ramp test; and greater than or equal to approximately 640 MWO, preferably in the range of approximately 650 to 700 MWO, when conducting a step test.

In an embodiment, a ratio of the maximum power output to an overall weight of the power tool 602 is at least 0.59 watts/g, preferably in the range of 0.59 to 0.82 watts/g. A ratio of the maximum power output to an overall weight of the power tool 604 is at least 0.58 watts/g, preferably in the range of 0.58 to 0.79 watts/g.

In an embodiment, a ratio of the maximum power output to a weight of the front-end assembly of the power tool 602 is at least 2.08 watts/g, preferably in the range of 2.08 to 2.86 watts/g. A ratio of the maximum power output to a weight of the front-end assembly of the power tool 604 is at least 1.87 watts/g, preferably in the range of 1.87 to 2.58 watts/g.

In an embodiment, a ratio of the maximum power output to an overall volume of the power tool 602 is at least 1.75 w/cm3, preferably in the range of 1.75 to 2.41 w/cm3. A ratio of the maximum power output to an overall volume of the power tool 604 is at least 1.73 w/cm3, preferably in the range of 1.73 to 2.38 w/cm3.

In an embodiment, a ratio of the maximum power output to a volume of the front-end assembly of the power tool 602 is at least 7.96 w/cm3, preferably in the range of 7.96 to 10.96 w/cm3. A ratio of the maximum power output to a volume of the front-end assembly of the power tool 604 is at least 7.44 w/cm3, preferably in the range of 7.44 to 10.24 w/cm3.

Other ratios of output performance parameters of Table 3 to size parameters of Table 1 are within the scope of this disclosure. For example, ratios such as maximum torque to tool weight, maximum torque to tool volume, maximum power to gear case height, etc. may be obtained and are within the scope of this disclosure.

Table 4 below summarizes some of the key performance attributes of power tool 602 (4.5-inch angle grinder) and power tool 604 (4-inch angle grinder), by way of example, when using a battery pack having a greater impedance than the battery pack associated with Table 2 Specifically, in this table, a battery pack including a series of five lithium-based cells, with a maximum voltage of 20V and a nominal impedance in the range of 67 to 75 mOhms, preferably approximately 71 mOhms, was utilized. An example of such a battery pack is the DeWalt® DCBP034 Powerstack™ compact battery pack, which includes a pouch-cell construction with a capacity of 1.7 Ah. However, other types of power tool battery packs, including those constructed using cylindrical and/or tables cells, may be alternatively used. This table illustrates that by using a higher impedance battery pack, the power and torque output parameters of the power tool may be reduced.

TABLE 4

| Performance | 4″ Angle Grinder | 4.5″ Angle Grinder |
|---|---|---|
| Max Power * (Watts) | 603 to 689 | 603 to 689 |
| Max Power ** (Watts) | 513 to 583 | 513 to 583 |
| Max Torque * (In-Oz) | 143 to 162 | 173 to 197 |
| Max Torque ** (In-Oz) | 130 to 147 | 158 to 179 |
| Continuous (Sustained) Power * (Watts) | 494 to 562 | 494 to 562 |
| Output Speed (RPM) | 10,200 to 12,570 | 8,400 to 10,350 |
| Motor Speed (RPM) | 26,000 to 32,000 | 26,000 to 32,000 |
| Max Power * to Tool Weight Ratio (Watts/g) | 0.52 to 0.69 | 0.50 to 0.67 |
| Max Power * to Front-End Weight Ratio (Watts/g) | 1.80 to 2.40 | 1.62 to 2.17 |
| Cont. Power * to Tool Weight Ratio (Watts/g) | 0.42 to 0.56 | 0.41 to 0.55 |
| Cont. Power * to Front-End Weight Ratio (Watts/g) | 1.48 to 1.97 | 1.33 to 1.77 |
| Max Power * to Tool Volume Ratio (Watts/cm3) | 1.52 to 2.03 | 1.50 to 2.00 |
| Max Power * to Front-End Vol Ratio (Watts/cm3) | 6.91 to 9.22 | 6.46 to 8.62 |
| Cont. Power * to Tool Volume Ratio (Watts/cm3) | 1.25 to 1.66 | 1.23 to 1.64 |
| Cont. Power * to Front-End Vol Ratio (Watts/cm3) | 5.66 to 7.55 | 5.29 to 7.06 |

* 20 Second Ramp Test
** Step Test
All Tests Performed Using a 20 V Max 71 mOhm 1.7 Ah Battery Pack

As shown in Table 4, using this battery pack, in an embodiment, power tools 602 and 604 are capable of producing a maximum power output that is greater than or equal to approximately 603 maximum-watts-out (MWO), preferably in the range of approximately 603 to 689 MWO, when conducting a 20 second ramp test; and greater than or equal to approximately 513 MWO, preferably in the range of approximately 513 to 583 MWO, when conducting a step test. In an embodiment, a max torque output of power tool 602 may be greater than or equal to approximately 143 inch-ounces, preferably in the range of approximately 142 to 162 inch-ounces, while the max torque output of power tool 604 (due to its lower output rotational speed and higher gear ratio), may be greater than or equal to approximately 173 inch-ounces, preferably in the range of approximately 173 to 197 inch-ounces, using the 20 second ramp test.

In an embodiment, a ratio of the maximum power output to an overall weight of the power tool 602 is at least 0.52 watts/g, preferably in the range of 0.52 to 0.69 watts/g. A ratio of the maximum power output to an overall weight of the power tool 604 is at least 0.50 watts/g, preferably in the range of 0.50 to 0.67 watts/g.

In an embodiment, a ratio of the maximum power output to a weight of the front-end assembly of the power tool 602 is at least 1.8 watts/g, preferably in the range of 1.8 to 2.4 watts/g. A ratio of the maximum power output to a weight of the front-end assembly of the power tool 604 is at least 1.62 watts/g, preferably in the range of 1.62 to 2.17 watts/g.

In an embodiment, a ratio of the maximum power output to an overall volume of the power tool 602 is at least 1.52 w/cm3, preferably in the range of 1.52 to 2.03 w/cm3. A ratio of the maximum power output to an overall volume of the power tool 604 is at least 1.50 w/cm3, preferably in the range of 1.2 to 2.0 w/cm3.

In an embodiment, a ratio of the maximum power output to a volume of the front-end assembly of the power tool 602 is at least 6.91 w/cm3, preferably in the range of 6.91 to 9.22 w/cm3. A ratio of the maximum power output to a volume of the front-end assembly of the power tool 604 is at least 6.46 w/cm3, preferably in the range of 6.46 to 8.62 w/cm3.

Other ratios of output performance parameters of Table 4 to size parameters of Table 1 are within the scope of this disclosure. For example, ratios such as maximum torque to tool weight, maximum torque to tool volume, maximum power to gear case height, etc. may be obtained and are within the scope of this disclosure.

Referring to FIGS. 5A-5P and 24A-24I, in an embodiment, the front-end tool assembly 628 of the power tool 626, which may be a right angle die grinder, includes a gear housing 872 having a retainer thread 874, a spindle 876 received by the gear housing 872, a spindle-mounted gear 878 positioned on the spindle 876, a first bearing 880 received by the gear housing 872 and engaged with the spindle 876, a second bearing 882 received by the gear housing 872 and engaged with the spindle 876, with the first bearing 880 spaced from the second bearing 882 along the spindle 876, and a bearing retainer 884 having a housing thread 886 engaged with the retainer thread 874 of the gear housing 872. The housing thread 886 of the bearing retainer 884 is aligned with at least a portion of the second bearing 882 along a radial plane that is perpendicular to the spindle 876. This arrangement positions the second bearing 882 substantially at the lower end of the gear housing 872. In an embodiment, this allows the second bearing 882 to be positioned at a distance of greater than or equal to approximately 33 mm, preferably approximately 34 mm to 35 mm, from the first bearing 880 (as measured from center of the first bearing 880 to a center of the second bearing 882). The spindle 876 has a first end 888 and a second end 890 positioned opposite the first end 888, with the second end 890 of the spindle 876 positioned outside of the gear housing 872.

In an embodiment, the second bearing 882 is a ball bearing, with the bearing retainer 884 engaged with an outer race of the second bearing 882, although other suitable bearings and arrangements may be utilized.

In an embodiment, the first bearing 880 is a needle bearing positioned at the first end 888 of the spindle 876, although other suitable bearings and arrangements may be utilized. The first bearing 880 is positioned within a bearing opening 892 defined by the gear housing 872.

In an embodiment, the housing thread 886 of the bearing retainer 884 is positioned radially outward from the second bearing 882.

In an embodiment, the first bearing 880 is securely supported within the bearing opening or pocket 892 formed within the gear housing 872 proximate a first end 883 thereof, with the retainer thread 874 positioned proximate a second end 885 of the gear housing 872 opposite the first end 883 and the second bearing 882 substantially aligned with the retainer thread 874. The second bearing 882 projects out from a front face 887 of the second end 885 of the gear housing 872 such that the bearing retainer 884, when engaging the outer race of the second bearing 882, forms an air gap with the front face 887 of the second end 885 of the gear housing 872. The gear housing 872 forms a second bearing pocket or opening 889 at the second end 885 thereof for supporting the second bearing 882, with the second bearing 882 axially constrained within the second bearing pocket 889 in the direction of the first end 883 of the gear housing 872 via a shoulder formed in the gear housing 872, and is axially constrained within the second bearing pocket 889 in the direction of the second end 885 of the gear housing 872 via the bearing retainer 884.

In an embodiment, the spindle 876 is oriented perpendicularly to the motor shaft 640, and the first and second bearings 880, 882 are axially contained within a boundary profile of the tool housing 630.

In an embodiment, the power tool 626 includes a shroud 894, with the gear housing 872 at least partially received within the shroud 894. The collar 682 may be at least partially received within the shroud 894. As shown in FIG. 24E and described previously with reference to FIGS. 21A and 21B, a circumferential exhaust vent 896 (similar to circumferential exhaust vent 811 previously described) is defined between the diffuser 792 and the shroud 894, with air configured to flow from the outlet 796 of the diffuser 792 and through the circumferential exhaust vent 896 between the diffuser 792 and the shroud 894 in a substantially helical shape over the outer body of the shroud 894. In an embodiment, the rear annular end of the shroud 894 is tapered to avoid interference with the forward-tangential direction of the airflow around the shroud 894. In an embodiment, the bridge 823 of the diffuser 792 is located in a lower end of the circumferential exhaust vent 896 to align the wire passage channel 825 for passage of wiring 914, as discussed below. The shroud 894 has a clamshell construction and includes a first half 898 connected to a second half 900 via a plurality of screws 902 extending through the second half 900 into screw bosses 906, 908 of the first half 898 of the shroud 894. The first half 898 may include a plurality of alignment features 904, such as ribs or pins, which are received by corresponding features of the second half 900 of the shroud 894, such as recesses or slots, to further secure or align the first half 898 to the second half 900 of the shroud 894. In an embodiment, the first half 898 of the shroud 894 includes a first screw boss 906 aligned in an axial direction with the first bearing 880, a second screw boss 908 aligned in an axial direction with the second bearing 882, and a third screw boss 910 aligned in an axial direction with the motor shaft 640. In an embodiment, the spindle-mounted gear 878 engages a bevel gear or pinion 899 positioned on the motor shaft 640, with the spindle 876 extending in a perpendicular direction relative to the motor shaft 640.

In an embodiment, the gear housing 872 is substantially housed within the shroud 894. The gear housing 872 may include a tiered or stepped structure to support the spindle 876, the first bearing 880, and the second bearing 882 therein. This tiered structure may include some similarities to the structure described with reference to FIGS. 5L and 5M. In an embodiment, the gear housing 872 further includes a retaining wall 891 that extends from its outer surface and comes in contact with an inner surface of the shroud 894. The retaining wall 891 may be oriented along a horizontal plane that passes through the motor shaft and the spindle 876.

In an embodiment, the power tool 626 includes a light 912 connected to the shroud 894. In an embodiment, a lower end of the shroud 894 extends below a lower end of the gear housing 872 and forms an annular groove 893 for retention of the light 912 directly below (e.g., at a short distance of approximately less than 2 mm) from the lower surface of the bearing retainer 884. Wiring 914 for the light 912 may extend between the shroud 894 and the gear housing 872. The wiring 914 may be routed through a channel defined by the shroud 894 and/or the tool housing 630. The wire 914 passes from the channel, through the wire passage channel 825 of the diffuser 792, to the tool housing 630, where it is routed through a gap formed between the motor housing 638 and the tool housing 630 to the motor control module 625. The light 912 may be annular, with the spindle 876 extending through the light 912. The light 912 may include a light emitting diode (LED) or include a plurality of LEDs. One of the alignment features 904, such as a pin, is aligned in an axial direction with the light 912 and is positioned radially below the third screw boss 910.

In an embodiment, the shroud 894 includes an output end 895 that extends beyond the second end 885 of the gear housing 872 and supports the light 912 proximate the second end 885 of the gear housing 872 adjacent the bearing retainer 884.

Referring to FIG. 24G, in an embodiment, the spindle 876 has a minimum diameter SD1 of 6.0-8.0 mm, with the spindle 876 having a maximum operating speed of at least approximately 21,000 RPM. In an embodiment, the motor 636 has an output speed of at least approximately 25,000 RPM, which is reduced to the spindle output speed via a 1.09 gear reduction ratio. In an embodiment, the spindle 876 provides a maximum torque of greater than or equal to approximately 38 in-oz, and a maximum power output that is greater than or equal to approximately 425 MWO. In an embodiment, the minimum diameter SD1 of the spindle 876 is 6.5-7.5 mm. In an embodiment, the minimum diameter SD1 of the spindle 876 is approximately 6.5 mm to 7.5 mm, preferably approximately 7.0 mm. In an embodiment, the spindle 876 has a maximum diameter SD2 of approximately 14.0-16.0 mm. In an embodiment, the maximum diameter SD2 of the spindle 876 is approximately 14.5-15.5 mm. In an embodiment, the maximum diameter SD2 of the spindle 876 is approximately 15.0 mm. By contrast, the gear housing 872 has a lateral width in the range of approximately 27 to 33 mm. In an embodiment, the front-end assembly therefore includes a larger diameter spindle 876 for the given size of the gear housing 872.

As discussed above, the gear housing 872 design enables locating the second bearing 882 substantially at the lower end of the gear housing 872, at a distance of greater than or equal to approximately 33 mm from the first bearing 880 (as measured from center of the first bearing 880 to a center of the second bearing 882). This arrangement allows the two bearings to be as distanced from one another as possible. In an embodiment, the overall height of the gear housing 872 if approximately 44 mm in this example, so a ratio of the distance between the two bearings to the height of the gear housing 872 is greater than or equal to approximately 75%, preferably greater than or equal to 77%.

Furthermore, in an embodiment, since the alignment features 904 and/or the screw boss 908 are located adjacent the bearing retainer 884 and/or the light 912, rather than between the lower end of the gear housing 872 and the light 912, they do not increase the overall height of the shroud 894, and allow the shroud 894 to be designed in a low-profile body. In an embodiment, the overall height of the shroud 894 is approximately 62 mm, so a ratio of the distance between the two bearings to the height of the shroud 872 is greater than or equal to approximately 53%, preferably greater than or equal to 56%. Further, in an embodiment, the overall height of the spindle 876 (not including a coupling) is approximately 67 mm, so a ratio of the distance between the two bearings 880, 882 to the height of the spindle 876 is greater than or equal to approximately 50%, preferably greater than or equal to 53%.

In an embodiment, the two bearings 880, 882 being as far spaced apart as possible given the size of the gear housing 872 and the shroud 894, combined with the large diameter of the spindle 876 for the given size of the gear housing 872, significantly reduce vibration in the spindle 876 at high rotational speeds. It was found by the inventors that absent these features, due to the small size of the spindle 876 and the associated components, the spindle 876 would produce a high level of vibration at die grinder operating speeds of greater than 21,000 RPM.

Referring to FIGS. 24A-24I, in an embodiment, the pinion 899 includes the spindle lock recess 568, which is discussed above in more detail. The power tool 626 further includes a retractable spindle lock 916 including the button 594 and the pin shaft 594P, with the pin shaft 594P configured to move along a lateral axis with respect to the pinion 899 from a first position where the pin shaft 594P does not rotationally lock the pinion 899 (and therefore the spindle 876) to a second position where the pin shaft 594P is configured to engage into the spindle lock recess 568 and rotationally lock the pinion 899 (and therefore the spindle 876). The shroud 894, which at least partially covers the gear housing 872, defines a button opening 918, with the button 594 positioned within the button opening 918 and with the shroud 894 extending around an entire circumference of the button 594 to constrain a movement of the retractable spindle lock 916 away from the gear housing 872 along the lateral axis. The button opening 918 of the shroud 894 is defined by a side portion of the shroud 894. The pin shaft 594P of the retractable spindle lock 916 extends through the aperture 504B defined by the gear housing 872. The collar 682 may be at least partially received within the shroud 894.

In an embodiment, the power tool 626 includes the spring 595 located between the button 594 and the gear housing 872 to bias the retractable spindle lock 916 away from the gear housing 872.

In an embodiment, the spindle 876 is oriented perpendicularly to the motor shaft 640. The spindle mounted gear 878 is positioned on the spindle 876 and the bevel gear or pinion 899 is mounted on the motor shaft 640 and driveably engages the spindle mounted gear 878.

In an embodiment, the output spindle may be axially aligned with the motor shaft 640 in an inline die grinder configuration and coupled to the motor shaft 640 via a shaft-side coupling and a spindle-side coupling in engagement with another, with at least one of the shaft-side coupling or the spindle-side coupling including a spindle lock recess engageable with the spindle lock. Examples of inline die grinder including these features are discussed in additional detail below.

Referring to FIGS. 25A-25G, in an embodiment, the front-end tool assembly 620 of the power tool 618, which may be an extended right angle cut-off tool, includes a gear housing 1000 defining a first counterbore 1002 and a second counterbore 1004 coaxial to the first counterbore 1002, with the second counterbore 1004 having a shaft threaded portion 1006, the first counterbore 1002 defining a first gear end face 1008, and the second counterbore 1004 defining a second gear end face 1010. The power tool 618 further includes a spindle 1012 received by the gear housing 1000, with the spindle 1012 having a first end 1014 and a second end 1016 positioned opposite the first end 1014, the second end 1016 of the spindle 1012 positioned outside of the gear housing 1000, and an extension shaft housing 1018 extending between the tool housing 630 and the gear housing 1000. The extension shaft housing 1018 has a gear housing threaded portion 1020 engaged with the shaft threaded portion 1006 of the gear housing 1000. The extension shaft housing 1018 defines a bearing pocket 1022, a first recessed portion 1024, and a second recessed portion 1026, with the extension shaft housing 1018 defining a first housing end face 1028 positioned radially between the bearing pocket 1022 and the first recessed portion 1024 and a second housing end face 1030 positioned radially between the first recessed portion 1024 and the second recessed portion 1026. The power tool 618 further includes an extension shaft 1032 extending between the motor shaft 640 and the spindle 1012, a first shaft bearing 1034 positioned between the extension shaft 1032 and the extension shaft housing 1018 and received within the bearing pocket 1022 of the extension shaft housing 1018, and a second shaft bearing 1036 positioned between the extension shaft 1032 and the extension shaft housing 1018. The first shaft bearing 1034 is spaced from the second shaft bearing 1036 along the extension shaft 1032. The first gear end face 1008 is engaged with the first shaft bearing 1034. A first annular gap 1038 is positioned between the first gear end face 1008 and the first housing end face 1028 and a second annular gap 1040 is positioned between the second gear end face 1010 and the second housing end face 1030.

The first annular gap 1038 and the second annular gap 1040 are configured to ensure engagement between the gear housing 1000 and the first shaft bearing 1034 when the gear housing threaded portion 1020 is engaged with the shaft threaded portion 1006 of the gear housing 1000. Due to tolerance stack-up, the gear housing 1000 could engage the extension shaft housing 1018 prior to full engagement of the gear housing 1000 with the first shaft bearing 1034 or prior to a predetermined clamping force being achieved. By providing the first annular gap 1038 and the second annular gap 1040, engagement of the gear housing 1000 with the first shaft bearing 1034 to ensure the first shaft bearing 1034 is secured relative to the gear housing 1000 and the extension shaft housing 1018 can be achieved regardless of the effect of tolerance stack-up.

In an embodiment, the gear housing 1000 defines a third gear end face 1042 positioned radially outward from the second gear end face 1010, and the extension shaft housing 1018 defines a third housing end face 1044 positioned radially outward from second housing end face 1030, with a third annular gap 1046 positioned between the third gear end face 1042 and the third housing end face 1044. The first annular gap 1038, the second annular gap 1040, and the third annular gap 1046 are each axially spaced from each other.

In an embodiment, the extension shaft 1032 defines a first bearing shoulder 1048, with the first shaft bearing 1034 engaged with the first bearing shoulder 1048.

In an embodiment, the power tool 618 further includes a spindle-mounted gear 1050 positioned on the spindle 1012, and a bevel gear 1052 coupling the extension shaft 1032 to the spindle 1012, with the extension shaft 1032 oriented perpendicular to the spindle 1012. A shaft connection member 1054 is connected to the extension shaft 1032 and a motor connection member 1056 is connected to the motor shaft 640, with the shaft connection member 1054 engaged with the motor connection member 1056.

In an embodiment, the extension shaft housing 1018 includes a collar threaded portion 1058, with the collar 682 engaged with the threaded portion 680 of the motor housing 638 and the collar threaded portion 1058 of the extension shaft housing 1018.

In an embodiment, the power tool 618 further includes a first bearing 1060 engaged with the spindle 1012, and a second bearing 1062 engaged with the spindle 1012, with the first bearing 1060 spaced from the second bearing 1062 along the spindle 1012 and the second bearing 1062 positioned closer to the second end 1016 of the spindle 1012 than the first bearing 1060.

In an embodiment, the power tool 618 includes a guard 1064 rotatable relative to the gear housing 1000, and a guard stop 1066 configured to limit rotation of the guard 1064 relative to the gear housing 1000, with the guard stop 1066 aligned with the second bearing 1062 in a direction extending from the first end 632 of the tool housing 630 to the second end 634 of the tool housing 630. A gap 1068 is positioned between the guard 1064 and the extension shaft housing 1018. The gap 1068 may be configured to allow a finger or portion of a hand of an operator of the power tool 618 to be positioned within the gap 1068 for improved control of the power tool 618.

In an embodiment, a distance BD1 between the first shaft bearing 1034 and the second shaft bearing 1036 is 120-130 mm. In an emblement, the distance BD1 between the first shaft bearing 1034 and the second shaft bearing 1036 is 122-128 mm. In an emblement, the distance BD1 between the first shaft bearing 1034 and the second shaft bearing 1036 is 123-127 mm. In an emblement, the distance BD1 between the first shaft bearing 1034 and the second shaft bearing 1036 is 125 mm. In an embodiment, an outer diameter BD2 of the extension shaft housing 1018 is 26-32 mm. In an embodiment, the outer diameter BD2 of the extension shaft housing 1018 is 27-31 mm. In an embodiment, the outer diameter BD2 of the extension shaft housing 1018 is 30 mm.

Referring again to FIGS. 25D-25G, in an embodiment, the gear housing 1000 includes a lower gearcase 1070 that receives the second bearing 1062, with the lower gearcase 1070 secured to the gear housing 1000 via a plurality of screws 1072. The guard stop 1066 is positioned between a flange 1074 of the lower gearcase 1070 and a top surface 1076 of the guard 1064. The power tool 618 includes a tool retention assembly 1078 configured to secure a tool, such as a cut-off wheel, to the power tool 618. In an embodiment, the extension shaft 1032 defines a notch 1080 configured to be engaged to during assembly of the power tool 618, such as during pressing of the bearings 1034, 1036 or other components onto the extension shaft 1032 to reduce the likelihood of bending the extension shaft 1032 during such assembly.

The term “volume” as used herein refers to a water displacement volume, although other measurement techniques such as geometric calculations, laser or acoustic volumeter, etc. may be alternatively utilized.

A number of embodiments have been described. Nevertheless, it will be understood that various modifications may be made without departing from the spirit and scope of the specification.

In addition, any logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A power tool comprising:
a tool housing including a substantially cylindrical body and a foot portion defining a battery receptacle for receiving a battery pack, wherein the tool housing defines a peripheral switch opening at or proximate the foot portion; a motor at least partially received within the tool housing; and
a peripheral switch at least partially received within the peripheral switch opening, the peripheral switch comprising a curved display surface including a curvature that substantially matches a curvature of the tool housing along at least one edge of the peripheral switch opening, and a printed circuit board (PCB), wherein the PCB comprises a switch and a plurality of indicator lights positioned on a planer body portion of the PCB.

2. The power tool of claim 1, wherein the plurality of indicator lights each comprise a light emitting diode (LED).

3. The power tool of claim 1, wherein the peripheral switch further comprises a barrier member positioned between the curved display surface and the PCB, the barrier member comprising a plurality of walls positioned between each of the plurality of indicator lights, wherein the plurality of walls has variable heights in an ascending order towards a middle portion of the PCB, and wherein the curved display surface is defined by a flexible display member supported by the barrier member.

4. The power tool of claim 3, wherein one of the plurality of walls is positioned between the switch and one of the plurality of indicator lights.

5. The power tool of claim 3, wherein the barrier member comprises a first curved wall and a second curved wall spaced from the first curved wall, and wherein each of the plurality of walls extends from the first curved wall to the second curved wall.

6. The power tool of claim 1, wherein the peripheral switch comprises a connection interface extending from the planer body portion, the connection interface engaged with the tool housing to secure the peripheral switch to the tool housing.

7. The power tool of claim 1, wherein the switch comprises a mode select switch configured to change an operation of the motor, and wherein the peripheral switch comprises a computer readable memory and a connection port.

8. The power tool of claim 1, wherein the tool housing defines a central axis extending through a mid-point of a grip portion of the tool housing, and wherein the peripheral switch extends radially inward from the peripheral switch opening to a position between the peripheral switch opening and the central axis.

9. A system of tools comprising:
a first power tool comprising:
a first tool housing having a first end and a second end positioned opposite the first end;
a first motor at least partially received within the first tool housing;
a first front-end tool assembly; and
a first peripheral switch comprising a display surface with first indicia, a printed circuit board (PCB), a switch, and a plurality of indicator lights; and
a second power tool comprising:
a second tool housing having a first end and a second end positioned opposite the first end, the first tool housing is identical in size and shape to the second tool housing;
a second motor at least partially received within the second tool housing;
a second front-end tool assembly, the first front-end tool assembly different than the second front-end tool assembly; and
a second peripheral switch comprising a display surface with second indicia, a printed circuit board (PCB), a switch, and a plurality of indicator lights,
wherein the display surface and the PCB of the first peripheral switch are identical in size and shape to the display surface and the PCB of the second peripheral switch, and wherein the first indicia of the first peripheral switch are different than the second indicia of the second peripheral switch.

10. The system of tools of claim 9, wherein the first tool housing defines a first peripheral switch opening and the second tool housing defines a second peripheral switch opening, the first peripheral switch received by the first peripheral switch opening and the second peripheral switch received by the second peripheral switch opening.

11. The system of tools of claim 10, wherein the first indicia of the first peripheral switch comprise an operating speed indicator, wherein the second indicia of the second peripheral switch comprise a rotation direction indicator, wherein the first power tool comprises a peripheral switch controller configured to output a signal associated with execution of a first type of operation designated for the first front-end tool assembly when the switch of the first peripheral switch is actuated, wherein the second power tool comprises a peripheral switch controller configured to output the signal associated with execution of a second type of operation designated for the second front-end tool assembly when the switch of the second peripheral switch is actuated, and wherein the second type of operation is different than the first type of operation.

12. The system of tools of claim 11, wherein the first type of operation is a speed select operation, and wherein the second mode selection operation is a rotation direction operation.

13. The system of tools of claim 9, wherein the first peripheral switch and the second peripheral switch each comprise a connection interface engaged with the respective first tool housing or second tool housing to secure the respective first peripheral switch and second peripheral switch to the respective first tool housing and second tool housing, and wherein the connection interface of the first peripheral switch is identical in size and shape to the connection interface of the second peripheral switch.

14. A power tool comprising:
a tool housing having a first end and a second end positioned opposite the first end;
a motor at least partially received within the tool housing; and
a peripheral switch comprising a display surface and a printed circuit board (PCB), wherein the PCB comprises a switch, a plurality of indicator lights, a peripheral switch controller, and a wireless communication device.

15. The power tool of claim 14, further comprising a motor controller in electronic communication with the peripheral switch controller, wherein the wireless communication device is configured to send data from the motor controller to a remote device.

16. The power tool of claim 15, further comprising a secondary power source configured to provide backup power to the motor controller and the peripheral switch controller, wherein the secondary power source comprises a cell housing secured to the tool housing via a cell connection interface, wherein the cell housing is spaced from the peripheral switch, and wherein the peripheral switch is positioned closer to the first end of the tool housing than the cell housing.

17. The power tool of claim 16, wherein the secondary power source is connected to the peripheral switch via wiring.

18. The power tool of claim 14, wherein the wireless communication device is formed integrally with the peripheral switch controller.

19. The power tool of claim 14, wherein the peripheral switch comprises a connection interface engaged with the tool housing to secure the peripheral switch to the tool housing.

20. The power tool of claim 14, wherein the switch comprises a mode select switch configured to change an operation of the motor.

21. The power tool of claim 16, wherein the tool housing comprises a foot portion and a grip portion extending from the foot portion, and wherein the secondary power source comprises a cell housing received within a pocket defined by the foot portion of the tool housing.

22. The power tool of claim 21, wherein the cell housing is configured to be removed from an exterior of the tool housing.

23. The power tool of claim 22, wherein the secondary power source comprises a coin cell, and wherein the pocket is spaced from the peripheral switch, the pocket comprising an electrical contact engaged with the coin cell when the cell housing is positioned within the pocket, with wiring extending between the electrical contact and the peripheral switch.

24. The power tool of claim 23, wherein the electrical contact comprises a printed circuit board (PCB) having a first L-shaped contact engaged with a first conductor of the coin cell and a second contact engaged with a second conductor of the coin cell.

25. The power tool of claim 24, wherein the cell housing comprise a biasing member engaged with a protrusion positioned within the pocket, the biasing member biasing the coin cell toward the second contact.
